(19) United States
(12) Patent Application Publication
(10) Pub. No.: US 2008/0255938 A1
(43) Pub. Date: Oct. 16, 2008

(54) Package Assembly for Multi-Modality Sensation Chewing Gum Compositions

(75) Inventors: Bharat Jani, East Brunswick, NJ (US); Kishor Kabse, Morris Plains, NJ (US); Navroz Boghani, Flanders, NJ (US); Petros Gebreselassie, Piscataway, NJ (US); R. Steve Grant, Chester, NJ (US); Jesse Kiefer, Columbia, NJ (US); Thomas Kuncewitch, Long Valley, NJ (US); Colleen Kramer, Ho-Ho-Kus, NJ (US); Mary K. Robinson, Sparta, NJ (US); Kristen Schmitz, Jersey City, NJ (US); Scott Allison, Stamford, CT (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 11/913,189

(22) PCT Filed: May 22, 2006
(86) PCT No.: PCT/US2006/019667

§ 371 Date: Jun. 4, 2008

Related U.S. Application Data
(63) Continuation of application No. 11/210,954, filed on Aug. 24, 2005.
Application No. 11/210,954 is a continuation-in-part of application No. 10/925,822, filed on Aug. 25, 2004.
(60) Provisional application No. 60/683,634, filed on May 23, 2005.
(60) Provisional application No. 60/650,758, filed on Feb. 7, 2005.
(60) Provisional application No. 60/776,699, filed on Feb. 24, 2006.

(51) Int. Cl. A23G 4/20; G06Q 30/00

(52) U.S. Cl. 705/14; 426/5

(57) ABSTRACT

A package assembly for a multi-layer center-filled chewing gum is disclosed. The package assembly supports individual gum pieces that have a center surrounded by a gum region. The gum region may include a gum base. Optionally, the individual gum pieces may be further coated with an external coating layer. Components of the individual gum pieces create a duality, such as a dual sensation perception, that are identified by indicia on the package.

### CROSS-REFERENCE TO RELATED APPLICATIONS

This application claims the benefit of U.S. Provisional Application No. 60/776,699, filed Feb. 24, 2006 and U.S. Provisional Application No. 60/683,634, filed May 23, 2005, and is a continuation-in-part of U.S. patent application Ser. No. 11/210,954, filed on Aug. 24, 2005, which is a continuation-in-part of U.S. patent application Ser. No. 10/925,822, filed Aug. 25, 2004, the contents all of which are incorporated herein by reference.

### FIELD

The present invention relates to a package assembly for a multi-layer center-filled chewing gum. The package assembly supports individual gum pieces that have a center surrounded by a gum region. Optionally, the individual gum pieces may be further coated with an external coating layer. Components of the individual gum pieces create a duality, such as a dual sensation perception, that are identified by indicia on the package.

### BACKGROUND

Liquid or center-filled gum and other confectionery products are in popular demand today. Typically, these products have a solid exterior portion and a soft or liquid-type center. The outer portion can be chewing gum or bubble gum of some type, while the liquid center portion can be a flavored material typically having a syrup-like consistency.

There are also products having a chewing gum or bubble gum core with a hard sugar or sugarless shell on the exterior. These products include, for example well-known pellet gum products sold under the brand names Chiclets®, Clorets®, and Dentyne-Ice®. Both liquid filled and coated gum products are in popular demand.

Also in popular demand are products that provide a dual flavor perception upon consumption. In particular, products that include a distinct flavor combination, such as strawberry and banana, may satisfy a consumer preference for a dual perception during consumption of the product. Traditional chewing gums, however, merely provide a single gum flavor, such as peppermint gum or wintergreen gum. Single-flavor gums cannot satisfy the consumer preference for more complex, flavored confectionery products.

Furthermore, consumers are always searching for newer and more interesting chewing gum products. Products that can provide different types of dualities, including dual flavor combinations, however, are not met by the currently available chewing gums. Distinct tastes, sensations and functional benefits, for instance, also may be desirable new dualities.

A variety of package assemblies already exist for confectionary products that may have varying forms, such as gum balls, gum slabs, lollipops, tablets, pellets, candy bottles, etcetera. For example, gum slabs have been arranged in package assemblies in both a side-by-side manner and a face-to-face manner. Slabs and pellet gum products have also been arranged in foil packages, such as blister trays, that are slidably insertable into a housing for storage of the same.

Although such product packaging is popular and achieves satisfactory results, product assemblies that may be used to market different types of dualities, including dual flavor combinations, are not met by the currently available packaging. For example, chewing gums that can provide distinct tastes, sensations and functional benefits are not adequately discernible from current packaging assemblies

There is a need, therefore, for an improved package assembly that can be used to market new chewing gum compositions, particularly center-fill gum compositions, that provide different types of dual perceptions upon consumption.

### SUMMARY

Some embodiments provide a multi-modality chewing gum composition including: a center-fill region; a gum region surrounding the center-fill region, the gum region including a gum base; and optionally a third region surrounding at least a portion of the gum region, wherein one of the regions includes at least one first sensate and at least a second of the regions includes at least one second sensate which is distinct from the at least one first sensate.

In some embodiments there is provided a multi-modality chewing gum composition including: a center-fill region; a gum region surrounding the center-fill region, the gum region including a gum base; and optionally a third region surrounding at least a portion of the gum region, wherein one of the regions includes a first amount of at least one sensate and at least a second of the regions includes a second amount of the at least one sensate, the second amount of the at least one sensate being greater than the first amount of the at least one sensate.

In some embodiments there is provided a multi-modality chewing gum composition including: a center-fill region including greater than zero up to about 10% by weight of the chewing gum composition; a gum region including from about 55% to about 65% by weight of the chewing gum composition; and a third region including a coating, the coating including from about 25% to about 35% by weight of the chewing gum composition, wherein one of the regions includes at least one first sensate and at least a second of the regions includes at least one second sensate which is distinct from the at least one first sensate, and wherein the gum composition further includes a gum piece of about three grams or less.

In some embodiments there is provided a multi-modality chewing gum composition including: a center-fill region including greater than zero up to about 10% by weight of the chewing gum composition; a gum region including from about 55% to about 65% by weight of the chewing gum composition; and a third region including a coating, the coating including from about 25% to about 35% by weight of the chewing gum composition, wherein one of the regions includes a first amount of at least one sensate and at least a second of the regions includes a second amount of the at least one sensate, the second amount of the at least one sensate being greater than the first amount of the at least one sensate, and wherein the gum composition further includes a gum piece of about three grams or less.

Some embodiments provide a multi-modality chewing gum composition including: a center-fill region; a gum region surrounding the center-fill region, the gum region including a gum base; and optionally a third region surrounding at least a portion of the gum region, wherein one of the regions includes at least one first component and at least a second of the regions includes at least one second component which is complementary to the at least one first component.

Some embodiments provide a method of developing a chewing gum product providing a consumer-preferred duality, which includes the steps of: (a) identifying a consumer preference for a dual sensate combination, wherein the dual sensate combination includes at least one first sensate and at least one second sensate which is distinct from the at least one first sensate; (b) preparing a multi-modality chewing gum product including: (i) a center-fill region; (ii) a gum region surrounding the center-fill region, the gum region including a gum base; and (iii) optionally a third region surrounding at least a portion of the gum region, wherein one of the regions includes the at least one first sensate and at least a second of the regions includes the at least one second sensate; and (c) marketing the multi-modality chewing gum product to consumers.

Some embodiments provide a method of preparing a multi-modality chewing gum product, which includes the steps of: (a) providing a chewing gum composition including: (i) a center-fill region; (ii) a gum region surrounding the center-fill region, the gum region including a gum base; and (iii) optionally a third region surrounding at least a portion of the gum region, wherein one of the regions includes at least one first sensate and at least a second of the regions includes at least one second sensate which is distinct from the at least one first sensate; and (b) forming individual pieces of chewing gum from the chewing gum composition.

In some embodiments there is provided a method of imparting a dual sensate perception to an individual, which includes the steps of: (a) providing a chewing gum product including: (i) a center-fill region; (ii) a gum region surrounding the center-fill region, the gum region including a gum base; and (iii) optionally a third region surrounding at least a portion of the gum region, wherein one of the regions includes at least one first sensate and at least a second of the regions includes at least one second sensate which is distinct from the at least one first sensate; and (b) applying the chewing gum product into the oral cavity of the individual, thereby releasing the at least one first sensate and the at least one second sensate therefrom to impart a dual sensate perception.

Some embodiments provide a multi-modality chewing gum composition including: a center-fill region; a gum region surrounding the center-fill region, the gum region including a gum base; and optionally a third region surrounding at least a portion of the gum region, wherein one of the regions includes at least one first sensate and at least a second of the regions includes at least one second sensate which is distinct from the at least one first sensate, and wherein one of the regions includes at least one first tastant and at least a second of the regions includes at least one second tastant which is distinct from the at least one first tastant.

Some embodiments provide a multi-modality chewing gum composition including: a center-fill region; a gum region surrounding the center-fill region, the gum region including a gum base; and optionally a third region surrounding at least a portion of the gum region, wherein one of the regions includes at least one first sensate and at least a second of the regions includes at least one second sensate which is distinct from the at least one first sensate, and wherein one of the regions includes at least one first functional agent and at least a second of the regions includes at least one second functional agent which is distinct from the at least one first functional agent.

Furthermore, in some embodiments, there is provided a packaged gum product that includes a plurality of individual pieces of gum, wherein each piece of gum includes: a center-fill region; a gum region surrounding said center-fill region, said gum region comprising a gum base; optionally a third region surrounding at least a portion of said gum region, wherein one of said regions comprises at least one first sensate and at least a second of said regions comprises at least one second sensate which is distinct from said at least one first sensate; and a package that contains said plurality of individual pieces of gum, said package having indicia placed on an outer surface, said indicia being indicative of said first sensate and said second sensate.

In some embodiments there is provided a packaged gum product that includes a plurality of individual pieces of gum, wherein each piece of gum includes: a center-filled region; and a gum region surrounding said center-fill region, said gum region comprising at least one first sensate and said gum region comprising at least one second sensate which is distinct from said at least one first sensate; and a package that contains said plurality of individual pieces of gum, said package having indicia placed on an outer surface, said indicia being indicative of said first sensate and said second sensate.

In some embodiments there is provided a packaged gum product that includes a plurality of individual pieces of gum, wherein each piece of gum includes: a center-filled region; and a gum region surrounding said center-fill region, said gum region comprising at least one first sensate and said gum region comprising at least one second sensate which is distinct from said at least one first sensate; and a package that contains said plurality of individual pieces of gum, said package having indicia placed on an outer surface thereof to inform consumers of said first sensate and said second sensate.

In some embodiments there is provided a packaged gum product that includes a plurality of individual pieces of gum, wherein each piece of gum includes: a center-fill region; a gum region surrounding said center-fill region, said gum region comprising a gum base; optionally a third region surrounding at least a portion of said gum region, wherein one of said regions comprises at least one first sensate and at least a second of said regions comprises at least one second sensate which is distinct from said at least one first sensate; and a package assembly comprising an overwrap portion that contains said plurality of individual pieces of gum, said overwrap portion having indicia being indicative of said first sensate and said second sensate.

In some embodiments there is provided a packaged gum product that includes a plurality of individual pieces of gum, wherein each piece of gum includes: a center-fill region; a gum region surrounding said center-fill region, said gum region comprising a gum base; optionally a third region surrounding at least a portion of said gum region, wherein one of said regions comprises at least one first sensate and at least a second of said regions comprises at least one second sensate which is distinct from said at least one first sensate; and a package assembly comprising a plurality of wrappers for each of the plurality of individual pieces of gum, at least one of the plurality of wrappers having indicia being indicative of said first sensate and said second sensate.

Some embodiments provide a method of marketing a gum product to a consumer, which includes the steps of: providing a plurality of individual pieces of gum, wherein each piece of gum includes a center-fill region; a gum region surrounding the center-fill region, the gum region comprising a gum base; optionally a third region surrounding at least a portion of the gum region, wherein one of the regions comprises at least one first sensate and at least a second of the regions comprises at least one second sensate which is distinct from the at least one first sensate; and providing a package that contains said plurality of individual pieces of gum, said package having indicia placed on an outer surface thereof to inform a consumer of said first sensate and said second sensate.

Some embodiments provide a method of marketing a gum product to a consumer, which includes the steps of: providing a plurality of individual pieces of gum, wherein each piece of gum includes: a center-fill region; a gum region surrounding the center-fill region, the gum region comprising a gum base; optionally a third region surrounding at least a portion of the gum region, wherein one of the regions comprises at least one first sensate and at least a second of the regions comprises at least one second sensate which is distinct from the at least one first sensate; and providing a package assembly comprising an overwrap portion that contains said plurality of individual pieces of gum, said overwrap portion having indicia being indicative of said first sensate and said second sensate.

Some embodiments provide a method of marketing a gum product to a consumer, which includes the steps of:providing a plurality of individual pieces of gum, wherein each piece of gum includes: a center-fill region; a gum region surrounding the center-fill region, the gum region comprising a gum base; optionally a third region surrounding at least a portion of the gum region, wherein one of the regions comprises at least one first sensate and at least a second of the regions comprises at least one second sensate which is distinct from the at least one first sensate; and providing a package assembly comprising a plurality of wrappers for each of the plurality of individual pieces of gum, at least one of the plurality of wrappers having indicia being indicative of said first sensate and said second sensate.

### BRIEF DESCRIPTION OF THE DRAWINGS

FIG. 1 is a perspective view of a first embodiment of the packaging assembly of the present invention.

FIG. 2 is a perspective view of a second embodiment of the packaging assembly of the present invention.

FIG. 3 is a perspective view of a third embodiment of a package assembly of the present invention.

Like reference symbols in the various drawings indicate like elements.

### DETAILED DESCRIPTION

Embodiments described herein provide a multi-component composition that includes at least one center-fill region and a gum region including a gum base. The individual gum piece also may include an outer gum coating or shell, which can provide a crunchiness to the piece when initially chewed. At least two components that create a duality upon consumption may be included in different regions of the gum piece. The individual gum pieces may form a variety of shapes including pellet, tablet, ball, pillow, chunk, stick and slab, among others.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

As used herein the term “indicia,” is descriptive matter synonymous with “information related to,” “information representative of,” and “information indicative of” and is open-ended and can include any words, phrases, slogans, pictures, symbols, contests, marketing campaigns, textures, colors, intensities, or other characteristics or features relating to the gum product.

As used herein, the terms “first region” and “center-fill” are used interchangeably to refer to the innermost region of the compositions. The term “center-fill” does not imply symmetry of a gum piece, only that the “center-fill” is within another region of the gum piece. In some embodiments, more than one center-fill may be present.

As used herein, the terms “second region” and “gum region” are used interchangeably to refer to a region of the compositions that may be adjacent to or at least partially surrounding the center-fill, or innermost, region. In some embodiments, the gum region is an intermediate region.

As used herein, the terms “third region” and “coating” are used interchangeably to refer to the outermost region of the compositions.

As used herein, the terms “surround,” “surrounding,” and the like are not limited to encircling. These terms may refer to enclosing or confining on all sides, encircling or enveloping, and are not limited to symmetrical or identical thicknesses for a region in the gum product.

In some embodiments, the components of the center-fill composition may be in different configurations depending on the desired shape of the total gum composition. The center-fill area or areas may be in either a concentric configuration with respect to the gum region or in a layered configuration. A concentric configuration may be acceptable for a ball, pillow or pellet shape, while a layered configuration may be more suitable for a slab or a stick shape. For example, if the total gum composition is in a ball shape, a hollow, circular shell may be formed in the innermost region of the gum piece. The shell may be filled with a center-fill composition, and the other regions or layers of the gum piece may encircle the center-filled area. However, if the total gum composition is in a slab shape, a hollow shell formed in the innermost region may be of a rectangular shape. The rectangular-shaped shell may be filled with a center-fill composition, and the other regions or layers of the gum piece may enclose or confine the rectangular center-filled area on all sides of the rectangle. Other examples include a pillow shaped gum piece where the hollow shell follows the contours of the gum piece and also is pillow shaped. The shape of the gum piece does not necessarily dictate the shape of the hollow shell, which houses the center-fill, but in many cases they are similarly shaped.

As used herein, the term “liquid” includes compositions that can transfer moisture from the center-fill region to the gum region. The term includes, but is not limited to, compositions which will readily flow or maintain fluid properties at room temperature and pressure. The term “liquid” may include solutions, suspensions, emulsions, semi-solids, cremes, gels, etc. that may not be completely liquid, but that can still lose liquidity because of a transfer of moisture from the center-fill region to the gum region. The “liquid” may be aqueous or non-aqueous. Also, the “liquid” may include non-liquid components, such as solid particles or gasses.

As used herein, the term “ingredient” and the term “component” are used interchangeably to describe any additive, fixing, substance, material, agent, active, element, or part that may be included in the gum compositions of some embodiments.

As used herein, the term “duality” refers to the presence of two characteristics that are complementary to each other, opposed to each other, i.e., distinct, or different in intensity from each other. The dual characteristics may be flavors, sensations, tastes, functionalities, or other characteristics or benefits. Flavors, sensates, tastants and functional agents also may include compounds that potentiate each of these types of components. The dual characteristics also may be colors or textures. In some embodiments, the duality may be a dual perception, which refers to the perception by an individual of two characteristics that are complementary to each other, opposed to each other, i.e., distinct, or different in intensity from each other.

The term “multi-modality” refers to the presence of at least two characteristics that are complementary, opposed, i.e., distinct, or different in intensity from one another. The multi-modal characteristics may be flavors, sensations, tastes, functionalities or combinations thereof. Flavors, sensates, tastants and functional agents also may include compounds that potentiate each of these types of components. The multi-modal characteristics also could be colors or textures. The term “multi-modality” is broader than and encompasses the term “duality” in that it includes embodiments that have a single duality, as well as embodiments that have more than one duality. For example, multi-modality may encompass two different dualities in one center-fill gum composition, such as dual flavors and dual tastes.

The term “complementary” refers to components that are in the same or similar flavor family, for example, the mint family or the fruit family; or components that are in the same or similar sensation family, for example, the cooling family, the warming family or the tingling family; or components that are in the same or similar taste family, for example, the sweetener family, the sour family, the bitter/astringent family, the salty family, the umami family or the kokumi family; or components that are in the same or similar functional family, for example, the breath freshening family or other functional families provided in Table 2 herein. The terms “family” and “type” are used interchangeably herein when referring to multi-modality components.

The term “opposed” means distinctly different components, for example, components that are from different families, such as a component in the flavor family and a component in the taste family.

The term “different in intensity” means that the at least two components that form the duality or multi-modality may be the same component but create the duality or multi-modality by being present in different amounts or by being encapsulated thereby providing a different intensity from one another. This different intensity is formed by the component being in different amounts from one region of the gum to another, or from being released at one rate in one region versus being released at another rate in another region.

### Dualities and Multi-Modalities

As mentioned above, at least two components may be included in the center-fill gum to create a duality or multi-modality. In some embodiments, the at least two components may be opposed to each other, i.e., distinctly different components. For example, two opposed flavors, such as strawberry and kiwi, may be employed. In some embodiments, the at least two components may be complementary to one another. For example, two mint oils that complement each other, such as peppermint and spearmint, may be employed. In some embodiments, the at least two components may differ in intensity from one another. For example, a single mint oil may be used, but in different amounts such that an intensity difference exists between the two portions of the mint oil.

The components that create the duality, or multi-modality, may be included in different regions of the center-fill gum. For instance, in some embodiments, a first component may be present in the center-fill and a second component, which is distinct from, complementary to or different in intensity from the first component, may be present in the gum region. Some embodiments may include a first component in the center-fill and a second component, which is distinct from, complementary to or different in intensity from the first component, in the coating. Some other embodiments may include a first component in the gum region and a second component, which is distinct from, complementary to or different in intensity from the first component, in the coating.

A variety of other combinations of the first and second components also may be employed. In some embodiments, for instance, a first component may be included in one region of the center-fill gum and a second component, which may be divided into two portions, may be included in the other two regions of the center-fill gum. The second component may be distinct from, complementary to or different in intensity from the first component. For example, the first component may be included in the gum region. A first portion of the second component may be included in the center-fill and a second portion of the second component may be included in the coating of the center-fill gum. The first and second portions of the second component may be the same or different in amount.

Non-limiting examples of some of the possible physical combinations for providing a duality in a center-fill gum are indicated in Table 1 below. In particular, Table 1 identifies a number of different physical combinations of components that may be employed involving dualities among: (1) distinct components; (2) complementary components; and (3) intensity differences between a single component. In addition, the chart also depicts possible multiple duality combinations in category (4).

As referred to in Table 1 and as defined above, the coating composition refers to the outermost region of the gum, the gum region composition refers to the intermediate region and the center-fill composition refers to the innermost region. As used in Table 1, A represents a first component and B represents a second component, which is distinct from the first component. A′ represents a second component that is complementary to the first component. 1/n is used to indicate a fractional portion of component A. 1/m is used to indicate a fractional portion of component A that is different from fractional portion 1/n. n*A is used to indicate a multiplicative portion of component A, and m*A indicates a multiplicative portion of component A that is different from multiplicative portion n*A. In some embodiments and examples, n may be equal to m. In other embodiments and examples, n may be different from m. In some embodiments and examples, n and/or m may be 0, 1 or other values.

TABLE 1

| | | |
|---|---|---|
| Coating | Gum Region | Center-Fill |
| Composition | Composition | Composition |

(1) Dualities based on differences between separate and
distinct components:

| | | |
|---|---|---|
| A | B | |
| A | | B |
| | A | B |
| B | A | |
| B | | A |
| | B | A |
| A | A | B |
| A | B | A |
| B | A | A |
| 1/n A | B | 1/n A |
| 1/n A | 1/n A | B |
| B | 1/n A | 1/n A |
| 1/n A | B | 1/m A |
| 1/n A | 1/m A | B |
| B | 1/n A | 1/m A |

(2) Dualities based on complementary components:

| | | |
|---|---|---|
| A | A′ | |
| A | | A′ |
| | A | A′ |
| A′ | A | |
| A′ | | A |
| | A′ | A |
| A′ | A | A |
| A | A′ | A |
| A | A | A′ |
| 1/n A | A′ | 1/n A |
| 1/n A | 1/n A | A′ |
| A′ | 1/n A | 1/n A |
| 1/n A | A′ | 1/m A |
| 1/n A | 1/m A | A′ |
| A′ | 1/n A | 1/m A |

(3) Dualities based on intensity differences of a single component:

| | | |
|---|---|---|
| n * A | A | |
| n * A | | A |
| | n * A | A |
| A | n * A | |
| A | | n * A |
| | A | n * A |
| A | A | n * A |
| A | n * A | A |
| n * A | A | A |
| n * A | A | n * A |
| n * A | n * A | A |
| A | n * A | n * A |
| n * A | A | m * A |
| n * A | m * A | A |
| A | n * A | m * A |

(4) Multiple dualities:

| | | |
|---|---|---|
| A | A′ | B |
| A | B | A′ |
| B | A | A′ |
| A | nA | B |
| A | B | nA |
| B | A | nA |
| A | AB | |
| | AB | A |
| A | | AB |
| | A | AB |
| AB | A | |
| AB | | A |
| A | A′B | |
| | A′B | A |
| A | | A′B |
| | A | A′B |
| A′B | A | |
| A′B | | A |
| AB | A′B′ | |
| | A′B′ | AB |
| AB | | A′B′ |
| | AB | A′B′ |
| AB | A′B′ | |
| | A′B′ | AB |
| A | A′B′ | B |
| A′B′ | A | B |
| A | B | A′B′ |
| A | AB | B |
| AB | A | B |
| A | B | AB |
| A | A′B | B |
| A′B′ | A | B |
| A | B | A′B′ |
| AB | A | AB |
| A | AB | AB |
| AB | AB | A |
| AB | nA | AB |
| nA | AB | AB |
| AB | AB | nA |
| AB | nA | mAB |
| nA | mAB | AB |
| mAB | AB | nA |
| A | nAB | |
| | nAB | A |
| A | | nAB |
| | A | nAB |
| nAB | A | |
| nAB | | A |
| nA | AB | |
| | AB | nA |
| nA | | AB |
| | nA | AB |
| AB | nA | |
| AB | | nA |

Table 1, above, provides a variety of different physical combinations of two components used to impart a duality to a center-fill gum. Other possibilities and combinations also exist and different examples may be combined.

Some embodiments provided herein may extend to combinations that include more than two components to create a duality, or multi-modality. In some embodiments, for instance, three components may be employed, one component in each separate region of the center-fill gum. For example, a first flavor may be present in the center-fill, a second flavor in the gum region and a third flavor in the coating. The three flavors may be distinct from one another, complementary to one another or different in intensities from one another. For instance, mint oil may be present in the center-fill and the coating and cinnamon oil may be present in the gum region. A duality based on distinct flavors thereby is provided. By way of another example, a first functional agent may be present in the center-fill, a second functional agent in the gum region and a third functional agent in the coating. The three functional agents may be distinct from one another, complementary to one another or different in intensities from one another. For instance, menthol may be present in the center-fill and the coating and chlorophyll may be contained in the gum region. Menthol and chlorophyll are different breath fresheners. Accordingly, a duality based on complementary functional agents is provided.

In some embodiments, three components may be used to impart a duality, or multi-modality, with a first component in one region of the center-fill gum and the second and third components together in another region of the center-fill gum. For example, strawberry flavor could be included in the gum region. A combination of lemon flavor and kiwi flavor could be included in the center-fill. A duality based on three distinct flavors therefore is provided by the gum.

In embodiments containing three or more components, the components may provide multiple dualities. For instance, in a three component embodiment, two of the components may be distinct from each other, whereas two of the components are complementary or different in intensity from each other. A center-fill gum may, for example, include peppermint flavor in the center-fill region and a different level of peppermint flavor in the coating, thereby imparting a first duality, which is an intensity differential. Cinnamon may be included in the gum region, which is distinct from the peppermint flavors. A second duality based on the cinnamon-peppermint flavor distinction also is present in the center-fill gum. Accordingly, a multi-modality gum may be provided having two different dualities.

A number of different combinations including two, three, four or even more components in any region of the center-fill gum may be prepared providing additional dualities or combinations of dualities.

Alternatively, in some embodiments, the at least two components that create the duality, or multi-modality, may be present in the same region of the center-fill gum. For instance, two distinct flavors, such as strawberry and kiwi, both may be present in the center-fill region of the gum composition. Some embodiments may include multiple dualities, such as dual flavors and dual sensations, all in the same region of the center-fill gum. In some other embodiments, a single duality may be present in one region, and a second duality may be present in another region of the center-fill gum. In still further embodiments, a first duality may be present via two different layers (e.g., a first component in the coating and a second component in the center-fill) and a second duality may be present via a different set of layers (e.g., a third component in the gum layer and a fourth component in the coating).

As noted above, there are several different types of dualities that may be present in a center-fill gum. The components that create the dualities may be used in any of the physical combinations discussed above. In particular, dualities may exist among flavors, sensations, tastes and functionalities. Additionally, dualities among colors may exist. Combinations of these different dualities also may be employed.

### Flavor Dualities

More specifically, some center-fill gums may include a flavor duality. In some embodiments, one of the regions of the center-fill gum may include a first flavor and at least a second of the regions may include at least a second flavor. The second flavor may be distinct from, complementary to or different in intensity from the first flavor. For instance, the center-fill region may include the first flavor and the gum region may include the second flavor. The center-fill region may include the first flavor and the coating may include the second flavor. The gum region may include the first flavor and the coating may include the second flavor.

In some embodiments, the center-fill region may include the first flavor, the gum region the second flavor and the coating may include a third flavor. The coating flavor may be the same as the gum region flavor. In such embodiments, the center-fill flavor may be distinct from, complementary to or different in intensity from both the coating and gum region flavors. In other embodiments, the coating flavor may be complementary to the gum region flavor, but distinct from the center-fill flavor. For example, the gum region and coating flavors may be two different mint flavors, such as, peppermint and spearmint. The center-fill flavor may be distinct from the mint flavors, such as, for example, cinnamon. Alternatively, the coating flavor may be the same as the center-fill flavor. In such embodiments, the gum region flavor may be distinct from, complementary to or different in intensity from both the coating and center-fill flavors. In other embodiments, the coating flavor may be complementary to the center-fill flavor, but distinct from the gum region flavor.

A variety of flavors may be used in any of these or other combinations to impart different dualities. More specifically, in some embodiments, at least two flavors that are distinct may be employed. Dualities based on distinct flavors may include, but are not limited to, the following combinations: a mint flavor and a fruit flavor; a mint flavor and a spicy flavor; a mint flavor and a savory flavor; a mint flavor and an indulgent flavor; a fruit flavor and a spicy flavor; a fruit flavor and a savory flavor; a fruit flavor and an indulgent flavor; a spicy flavor and a savory flavor; a spicy flavor and an indulgent flavor; and a savory flavor and an indulgent flavor.

Some of the duality combinations set forth above include an indulgent flavor. As used herein, “indulgent” refers to a type of flavor associated with a creamy or decadent taste. Sometimes these flavors are referred to as “sweet/brown” in the art. Examples of suitable indulgent flavors include, but are not limited to, maple, cola, chocolate, dulce de leche, raisin, vanilla, caramel, dairy flavors, such as cream, butter, milk and yogurt, butterscotch, peanut butter, fruit cream flavors, such as strawberry cream, and combinations thereof.

In some embodiments, at least two flavors that are complementary may be employed. In some embodiments, the complementary flavors may be the same type of flavor, e.g., two different mint flavors. In some other embodiments, a first flavor, e.g., a fruit flavor, may be provided, and the second flavor may be complementary by enhancing the first flavor, e.g., a fruit potentiator. More specifically, dualities based on complementary flavors may include, but are not limited to, the following combinations: a mint flavor and a mint potentiator; a fruit flavor and a fruit potentiator; a spicy flavor and a spice potentiator; a savory flavor and a savory potentiator; a mint flavor and a different mint flavor; a fruit flavor and a different fruit flavor; a spicy flavor and a different spicy flavor; a savory flavor and a different savory flavor; and an indulgent flavor and a different indulgent flavor.

In some embodiments, the duality may be based on at least two portions of a flavor that differ in intensity. For instance, any of the following types of flavors may be used in at least two portions, each of which contains a different amount of the flavor: mint flavor; fruit flavor; spicy flavor; savory flavor; and indulgent flavor. For example, one of the regions of the chewing gum may include a first amount of a flavor and a separate region may include a second amount of the same flavor. The second amount may be greater than the first amount of the flavor, thereby creating an intensity differential in the flavor impact. It further may be desirable, in some embodiments, to include a third portion of the same flavor in the remaining region of the chewing gum, which is different in amount than the first and/or second portion.

A variety of exemplary flavors, such as mint, fruit, spicy, savory and indulgent flavors are provided in Table 2 herein. Specific flavors may be selected from Table 2 and combined in various manners as set forth above and in other combinations or embodiments.

Further, in some embodiments, at least one of the flavors may have a modified release profile. As described in more detail below, components may be at least partially encapsulated to provide a modified release profile. Suitable encapsulating materials and methods of encapsulation are provided in more detail below in the section entitled “Additional Components.” One or all of the flavors used in the chewing gums may be at least partially encapsulated. Further, in some embodiments, at least one of the flavors may include a mixture of the flavor in its encapsulated and unencapsulated (sometimes referred to as “free”) forms. Encapsulated and unencapsulated forms of a flavor may be included in any of the regions of the chewing gum in the same or different amounts.

Some embodiments described herein extend to methods of preparing multi-modality chewing gum products, which include at least one flavor duality. In particular, a chewing gum composition including any of the flavor dualities described above may first be provided. The chewing gum composition may include a center-fill region, a gum region surrounding or adjacent to the center-fill region and optionally a third region, which may be a coating or shell. One of the center-fill gum regions may include at least one first flavor and at least a second of the center-fill gum regions may include at least one second flavor. The second flavor may be distinct from, complementary to or different in intensity from the first flavor. Individual chewing gum pieces then may be formed from the chewing gum composition. Methods of forming individual gum pieces from chewing gum compositions are described in more detail below in the section entitled “Center-Fill Chewing Gum Compositions.” As described below, U.S. Pat. No. 6,280,780 to Degady et al. (“Degady”), which is herein incorporated by reference in its entirety, describes a suitable apparatus and method for forming center-filled gum pellets.

In some embodiments, methods of imparting a dual flavor perception are provided. In accordance therewith, a chewing gum product prepared as described above may be provided. The chewing gum product may include a center-fill region, a gum region surrounding or adjacent to the center-fill region and optionally a third region, which may be a coating. One of the center-fill gum regions may include at least one first flavor and at least a second of the center-fill gum regions may include at least one second flavor. The second flavor may be distinct from, complementary to or different in intensity from the first flavor. The chewing gum product may be applied into the oral cavity of an individual. As the individual chews the product and saliva mixes therewith, the at least one first flavor and the at least one second flavor may be released from the gum. The individual may experience a dual flavor perception as the first and second flavors are released and combine in the oral cavity. The different flavors may interact with different portions of the oral cavity, different receptors in the individual's mouth, and the like.

Additional embodiments described herein relate to methods of developing chewing gum products, which provide a consumer-preferred duality, particularly a flavor duality. In accordance therewith, a consumer preference for a dual flavor combination may first be identified. The dual flavor combination may include at least one first flavor and at least one second flavor, which is distinct from, complementary to or different intensity from the first flavor. A variety of methods may be used to identify a consumer preference for a specific flavor duality, such as, market research, including consumer surveys, taste panels, and the like. Once a consumer preference for a dual flavor combination, such as, for example, kiwi and banana, is identified, a chewing gum product tailored to satisfy that preference may be provided. In particular, any of the center-fill chewing gum products described above may be prepared. The first flavor of the consumer-preferred duality may be added to one region of the gum and the second flavor of the consumer-preferred duality may be added to another region of the gum. The chewing gum product may be marketed to consumers based on the consumer-preferred duality.

The consumer-preferred duality provided by the gum product may be marketed to consumers in a variety of manners. Suitable marketing strategies, include, for example, print, radio, satellite radio, television, movie theater and online advertising campaigns, point-of-purchase advertisements, billboard advertisements, public transportation and telephone booth advertisements, indicia on the product packaging (e.g., slogans, trademarks, terms and colors), instant messaging, ringtones, and the like.

The package assembly of the present invention may be used to market and reinforce the multi-modality gum product to consumers. In one preferred embodiment, the package assembly of the present invention includes indicia e.g., descriptive matter such as words, phrases, slogans, pictures, symbols, contests, marketing campaigns, textures, colors, intensities, or other characteristics or features, that are be used to relate information to consumers concerning the gum product.

Several advantages may be derived by providing indicia on the package assembly. For example, a package assembly having indicia may provide notice to consumers that a specific product of known quality, aroma and taste, is available. The indicia also may provide consumers with a latent image of the product and reinforce consumer image of the product.

In one preferred embodiment, the indicia extends over a portion of an outer surface of the package assembly. By providing the indicia on the package, the package assembly of the present invention may be utilized as a marketing tool. For example, a consumer viewing the product package may be immediately informed of the multi-modality of the product, such as a first sensate and second sensate, contained in the product.

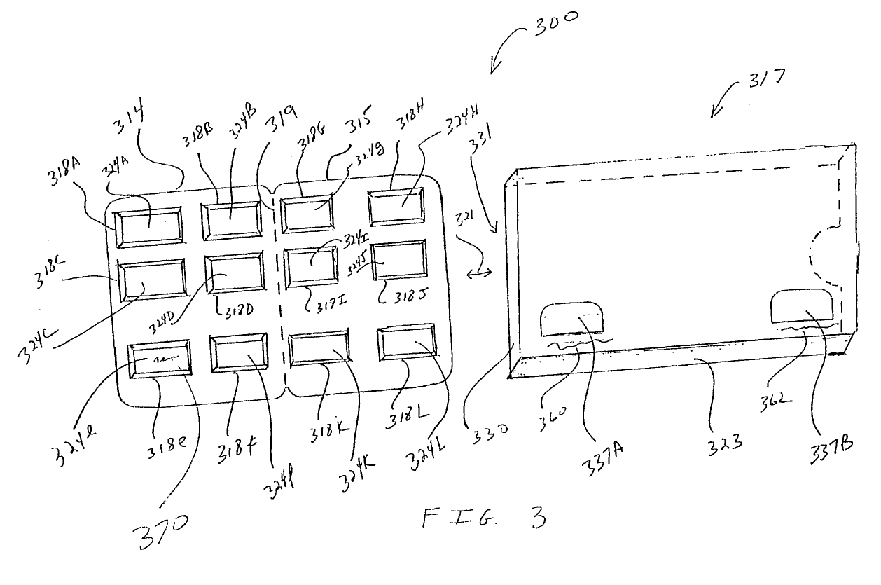

The present invention, however, is not limited to the indicia being included on the outer surface of the assembly. For example, indicia also may be included on an overwrap for a package (as opposed to or in addition to the package assembly itself) as discussed in connection with FIG. 2, as well as printed on the product itself, discussed in connection with FIG. 3. In one preferred embodiment, as shown and discussed in connection with FIG. 2, indicia also may be provided on the surfaces of one or more wrappers used to protect and store the gum product in the assembly. Although the wrapper is provided with indicia of which at least some may be substantially the same as that on the outer surface of the assembly, the wrapper indicia also may include further information relating to, say, a contest or promotion of the product contained in the assembly. The contest or promotion may include a sweepstake, prize, token or redeemable voucher.

The communication of the indicia to consumers can be done through a number of media outlets and includes such things as printed indicia on product packages, printed messages in magazines, newspapers, newsletters and the like, audio and visual outlets such as radio and television as well as other outlets, such as the Internet, that are suitable for use in delivering the message to a targeted demographic.

Various marketing techniques also may be developed using the indicia of the present invention. For example, an advertisement for the product may be provided that utilizes at least a portion of the indicia included on the package. In one preferred embodiment, for example, the advertisement takes the form of an audio message that is played upon the user removing the product from the packaging.

In another embodiment, a display device, is configured to support the package assembly and thereby, show at least a portion of the indicia indicating the multi-modality of the product contained therein. For example, in one preferred embodiment, a display stand is provided for displaying and supporting the package assembly. The display stand may be used in a retail establishment at the point of purchase such as the cash register. The display stand may be formed from transparent plastic to allow clear viewing of the indicia included on the package assembly.

Other marketing techniques also may be developed to generate sales of the product. For example, in some preferred embodiments, audio messages are created that recite indicia (e.g., slogans, jingles) included on the product package. This may include a method of publishing audio files to the Internet, and allowing consumers to subscribe to a feed to receive the audio files containing the indicia. Visual images of the product also may be prepared that include at least a portion of the indicia included on the product package. For example live or delayed sound or video broadcasts of the indicia may be provided to consumers using web technologies over the Internet. Radio and television commercials also may be used to market the product to consumers using at least a portion of the indicia, and thereby increase revenue.

Of course, it is to be understood that the invention is not limited to the above referenced techniques and that various changes and modifications to the techniques may be affected herein by one skilled in the art without departing from the scope or spirit of the invention. It is also to be understood and that it is intended to claim all such changes and modifications that fall within the scope of the invention.

Various packaging assemblies known in the art may be adapted to incorporate features of the present invention. For example, as disclosed in U.S. Pat. No. 2,279,471 to Wilson, which is incorporated herein in its entirety, a box is disclosed that may support chocolate and other confectionary products that may be adapted to support the gum compositions and provide the indicia of the present invention. U.S. Design Pat. Nos. D398,520 and D392,885, which are incorporated herein in their entirety, also disclose a box-type packaging that can be adapted to support and provide the gum compositions and the indicia of the present invention, respectively.

Gum stick packaging known in the art also may be adapted to incorporate the above described indicia and support the multi-modality chewing gum product of the present invention. For example, in U.S. Pat. No. 6,926,951 to Huffer et. al., which is incorporated herein in its entirety, a laminate for gum packaging is disclosed that may include the indicia of the present invention. In addition, U.S. Pat. No. 5,029,712 to O'Brien et. al., which is incorporated herein in its entirety, discloses a reclosable package for holding items having an adhesive front label applied to the front portion of the container. The reclosable package may be used to support the gum compositions of the present invention. Indicia of the present invention also may be provided by the reclosable package. Chewing gum packages, such as those disclosed in U.S. Pat. No. 2,192,472 and U.S. Pat. No. 2,192,473, which are incorporated herein in their entirety, also may be adapted to provide the indicia and support the gum product of the present invention.

The present invention may be applied to packaging tins used for supporting confectionary products. For example, in U.S. Design Pat. No. D480,561 to Simon et. al., which is incorporated herein in its entirety, a case for a chewing gum packet is disclosed that can be adapted to support the gum compositions and provide the indicia of the present invention. U.S. Design Pat. No. D471,804 to Staples, which is incorporated herein in its entirety, discloses a chewing gum tin that also may be used to support the gum compositions and provide the indicia of the present invention. In addition, U.S. Design Pat. No. D457,427 to Diaz, which is incorporated herein in its entirety, discloses a combined chewing gum box and clip that may be used to support the gum compositions and provide the indicia of the present invention. Other tin packaging assemblies that may be adapted to support the multi-modality chewing gum product and include indicia of the present invention include U.S. Design Pat. D412,279, U.S. Design Pat. No. D406,496, U.S. Design Pat. No. D351,789 and U.S. Design Pat. No. D449,782, all of which are incorporated herein in their entirety.

Dispensors also may be used to support the multi-modality chewing gum product and provide the indicia of the present invention. For example, U.S. Pat. No. 5,540,353 to Coleman et. al., which is incorporated herein in its entirety, discloses a candy container and dispenser that includes a housing having a top enclosure with an aperture, wherein pieces of candy having a size smaller than the aperture may be dispensed by shaking. The candy container and dispenser may be adapted to house the gum product and provide the indicia of the present invention. U.S. Pat. No. 5,370,219 to Violett, which is incorporated herein in its entirety, discloses containers for the storage and transportation of sticks of gum, that may be adapted to support the chewing gum and provide the indicia of the present invention. U.S. Pat. No. 5,056,683 to O'Brien et. al., which is incorporated herein in its entirety, discloses a cardboard stick gum dispenser that may be adapted to support the multi-modality chewing gum and indicia of the present invention. Similarly, other dispensor packages may be used with the present invention. For example, U.S. Pat. No. 4,465,208 to Buban et al., which is incorporated herein in its entirety, discloses a chewing gum dispenser having an upper cover whose central region is cut away to afford access to a stick product. The chewing gum dispenser of Buban et. al. may be adapted to provide the indicia and support the chewing gum product of the present invention. Similarly, the dispensers disclosed in U.S. Pat. Nos. 4.170,914 and 3,591,043, the contents of which are incorporated herein in their entirety, also may be adapted to support the multi-modality chewing gum and to provide the indicia of the present invention.

Of course, the present invention is not limited to the above identified package assemblies and various other types of package assemblies may also be used to support the multi-modality chewing gum of the present invention. For example, tablet packs, as disclosed in U.S. Design Pat. No. D344,018 to Kelsey et. al., which is incorporated herein in its entirety, may be adapted to provide the indicia and support the product of the present invention. The stacked articles disclosed in U.S. Pat. No. 3,591,043 to Murphy also may be adapted to support the gum product and provide the indicia of the present invention.

Sealed packets also may be used to support the multi-modality gum product and provide the indicia of the present invention. For example, as disclosed in U.S. Pat. No. 4,874,096 to Tessera-Chiesa, which is incorporated herein in its entirety, a sealed packet containing food products in pieces, particularly sweets and the like, is disclosed that can be adapted to provide the gum product and indicia of the present invention. Furthermore, combination packages, such as the apparatus for carrying gum and mints disclosed in U.S. Pat. No. 6,655,488, which is incorporated herein in its entirety, may be used to support the gum product and provide the indicia of the present invention and overwrapping packages, such as those disclosed in U.S. Pat. No. 2,571,516 and U.S. Design Pat. No. D383,973, which are incorporated herein in their entirety, may be adapted to support the multi-modality gum product and provide the indicia of the present invention.

Reference will now be made to the accompanying drawings, which further assist in illustrating the various pertinent features of the packaging assembly of the present invention. Although the invention will now be described primarily in conjunction with gum packaging, it should be expressly understood that the invention may be applicable to other applications where multiple separable compartments, each for one or more removable objects, is required/desired. In this regard, the following description of a gum packaging assembly is presented for purposes of illustration and description. Furthermore, the descriptions are not intended to limit the invention to the forms disclosed herein. Consequently, variations and modifications commensurate with the following teachings, and skill and knowledge of the relevant art, are within the scope of the packaging assemblies.

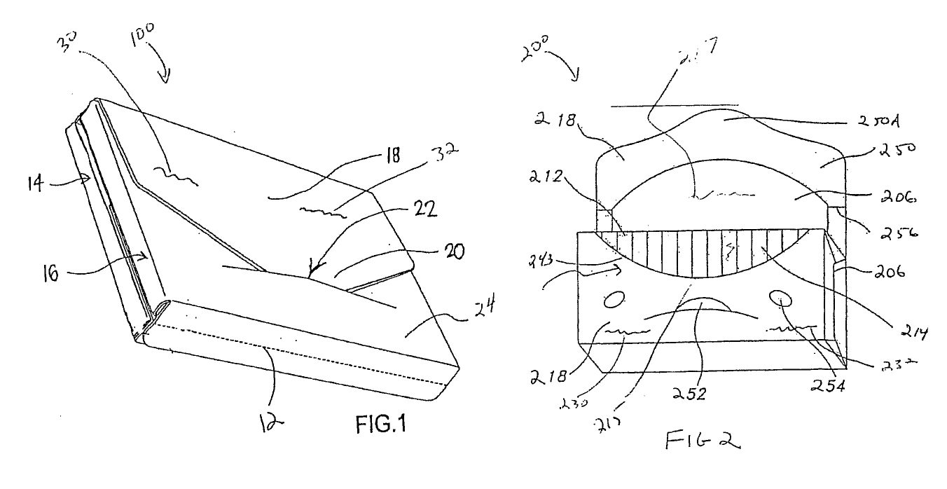

Referring now to FIG. 1, a first embodiment of a package assembly 100 according to the present invention is disclosed. The package assembly 100 includes an upper compartment 14 and a lower compartment 16 that are used to support multi-modality chewing gum compositions. The upper and lower compartments 14, 16 may be easily separated from one another along a perforation 12. As shown in FIG. 1, the compartments 14 and 16 are typically provided in an attached manner and are folded together to place one facing the other. A cover flap 18 is provided from the upper compartment 14 having an end 20 laid over a receiving slot 22 in a back panel 24 of the lower compartment 16 to close the assembly 100. The consumer can tuck the end 20 into the slot 22 to form a compact package 26. Details of forming the package assembly 100 of FIG. 1 are described in U.S. patent application Ser. No 10/883,468, filed on Jul. 1, 2004, which is incorporated herein in its entirety.

As shown in FIG. 1, each of the compartments includes indicia 30, 32 that are indicative of the duality provided by the product contained therein. The location of the indicia 30, 32 may vary based on design considerations as well as functional considerations decided upon to effectively market the product. For example, in one preferred embodiment, one of the indicia 30 is included on one of upper compartment 14 and the other indicia 32 is included on the lower compartment 16. The indicia 30, 32 may be indicative of the flavors, sensations, tastes, functionalities, or other characteristics or benefits provided by the gum compositions contained in the compartments that are complementary to each other, opposed to each other, i.e., distinct, or different in intensity from each other. For example, in one preferred embodiment, one indicia 30 may indicate a sweet flavor gum composition accessible from the upper compartment 14 and another indicia 32 indicate a sour flavor gum composition accessible from the lower compartment 16. Of course, as mentioned previously, the indicia may be any words, phrases, slogans, pictures, symbols, contests, marketing campaigns, textures, colors, intensities, or other characteristics or features relating to the gum product.

Referring now to FIG. 2, a second embodiment of a package assembly 200 according to the present invention is disclosed. As shown in FIG. 2, when the consumer opens the assembly 200 by pulling up the tab 250a of a flap 250, a foil portion of a packet 206, e.g., an overwrap, supporting the multi-modality chewing gum compositions of the present invention tears along a scoring 243 leaving an array 212 of filled-wrappers of gum 214. The wrappers 214 protect and store the gum product in the assembly 200. As shown in FIG. 2, in one preferred embodiment, for example, one or more of the gum wrappers 214 include indicia 215 that may be used to provide further information relating to the product, or a contest or promotion relating to the product. Once the foil portion of the packet 206 tears, the consumer may pull out as many gum slabs 214 as needed. In some preferred embodiments, as shown in FIG. 2, the foil portion of the packet 206 also may contain indicia 217 relating to the product, such as a freshness data, as well as contest or promotional information relating to the gum product. Finally, the consumer may simply pull the flap 250 downward and tuck the tab 250a into a slot 252 to close the package assembly 200. Details of forming the package assembly 200 of FIG. 2 are described in U.S. patent application Ser. No. 10/001,352, filed on Oct. 31, 2001, which is incorporated herein in its entirety.

As shown in FIG. 2, a front wall 218 of the packet also may include indicia 230, 232 that are indicative of the duality provided by the gum composition included therein. Similar to the indicia 30, 32 described previously in connection with FIG. 1, the indicia 230, 232 may be indicative of the flavors, sensations, tastes, functionalities, or other characteristics or benefits provided by the gum compositions. The location and number of indicia 230, 232 included in the package assembly 200 also may vary depending upon the marketing strategy chosen. For example, in some preferred embodiments, indicia are also included on the flap 250 of the assembly and are visible when the assembly 200 is opened.

A third embodiment of a product package assembly 300 of the present invention is shown in FIG. 3. The package assembly includes a sleeve 317 having a uniform shape. The assembly 300 also includes one or more package or blister trays 314, 315 that are removable from and reinsertable into the sleeve 317. For example, as shown by the arrow 321 in FIG. 3, a consumer may slidably remove blister trays 314, 315 from the sleeve 317 and slidably reinsert the blister trays 314,315 into the sleeve 317 as desired. In a preferred embodiment, for example, each blister tray 314,315 includes indicia 371a, 371b that provides information to consumers relating to the packaging date of the assembly. Of course, as mentioned previously, other indicia relating to the product may be provided thereto.

Preferably, the blister trays 314, 315 of the present invention are made primarily from plastic and/or plastic or metal foils. As shown in FIG. 3, each tray 314, 315 may be attached to each other via a perforated line 319 that allows the trays 314,315 to be separated from each other. For example, the blister trays 314, 315 may be easily separated from each other by tearing along the perforated line 319.

As shown in FIG. 3, each of the trays 314, 315 includes a plurality of compartments 318a-f, 318e-l, respectively, that extend outwardly from each tray 314, 315. The compartments 318a-l support the multi-modality chewing gum compositions of the present invention. For example, one blister tray 314 may include a sweet flavor gum composition 324a-f, and one blister tray 315 may include a sour flavor gum composition 324g-l.

The front wall 328 of the sleeve 317 includes indicia 360, 362 that are indicative of the multi-modality of the gum product supported therein. The indicia 360, 362 may indicate the flavors, sensations, tastes, functionalities, or other characteristics or benefits provided by the gum compositions included in the blister trays 314, 315. As shown in FIG. 3, in one preferred embodiment, the top wall 328 of the sleeve 317 includes openings 337a, 337b that allow for displaying the multi-modality chewing gum compositions when one or more trays 314, 315 are inserted into the sleeve 317. For example, in one preferred embodiment, a sweet flavor gum composition 324e is displayed through opening 337a and a sour flavor gum composition 324L is displayed through opening 337b. Indicia 360, 362 indicating “Sweet” and “Sour” flavors, respectively, are located adjacent to the openings 337a, 337b and thereby, are indicative of the flavors. Of course, the indicia 360, 362 also inform the consumer of the multi-modality of the gum compositions.

As shown in FIG. 3, one or more of the gum product may have included therein indicia 370 that may be pre-printed, stamped or etched onto the product. The indicia 370 may include a name, such as a brand name, or other images, symbols, or other descriptive matter that is related to the product or marketing of the product.

### Sensate Dualities

Some center-fill gums may include a duality based on sensations, such as coolness, warmth and tingling sensations. Such sensations may be provided by sensates, such as cooling agents, warming agents and tingling agents, respectively. In some embodiments, one of the regions of the center-fill gum may include a first sensate and at least a second of the regions may include at least a second sensate. The second sensate may be distinct from, complementary to or different in intensity from the first sensate. For instance, the center-fill region may include the first sensate and the gum region may include the second sensate. The center-fill region may include the first sensate and the coating may include the second sensate. The gum region may include the first sensate and the coating may include the second sensate.

In some embodiments, the center-fill region may include the first sensate, the gum region the second sensate and the coating may include a third sensate. The coating sensate may be the same as the gum region sensate. In such embodiments, the center-fill sensate may be distinct from, complementary to or different in intensity from both the coating and gum region sensates. In other embodiments, the coating sensate may be complementary to the gum region sensate, but distinct from the center-fill sensate. For example, the gum region and coating sensates may be two different cooling agents, such as, menthol and menthyl succinate. The center-fill sensate may be distinct from the cooling agents, such as, for example, a tingling agent. Alternatively, the coating sensate may be the same as the center-fill sensate. In such embodiments, the gum region sensate may be distinct from, complementary to or different in intensity from both the coating and center-fill sensates. In other embodiments, the coating sensate may be complementary to the center-fill sensate, but distinct from the gum region sensate.

A variety of sensates may be used in any of these or other combinations to impart different dualities. More specifically, in some embodiments, at least two sensates that are distinct may be employed. Dualities based on distinct sensates may include, but are not limited to, the following combinations: a cooling agent and a warming agent; a cooling agent and a tingling agent; and a warming agent and a tingling agent.

In some embodiments, at least two sensates that are complementary may be employed. In particular, the complementary sensates may be the same type of sensate, such as, two different cooling agents, two different warming agents or two different tingling agents.

In some embodiments, the duality may be based on at least two portions of a sensate that differ in intensity. Any of the following types of sensates may be used in at least two portions, each of which contains a different amount of the sensate: cooling agents, warming agents or tingling agents. For example, one of the regions of the chewing gum may include a first amount of a sensate and a separate region may include a second amount of the same sensate. The second amount may be greater than the first amount of the sensate, thereby creating an intensity differential in the sensation. It further may be desirable, in some embodiments, to include a third portion of the same sensate in the remaining region of the chewing gum, which is different in amount than the first and/or second portion of the sensate.

A variety of exemplary sensates, such as cooling, warming and tingling agents are provided in Table 2 herein. Specific sensates may be selected from Table 2 and combined in various manners as set forth above and in other potential combinations or embodiments.

Further, in some embodiments, at least one of the sensates may have a modified release profile. As described in more detail below, components may be at least partially encapsulated to provide a modified release profile. Suitable encapsulating materials and methods of encapsulation are provided in more detail below in the section entitled “Additional Components.” One or all of the sensates used in the chewing gums may be at least partially encapsulated. Further, in some embodiments, at least one of the sensates may include a mixture of the sensate in its encapsulated and unencapsulated (sometimes referred to as “free”) forms. Encapsulated and unencapsulated forms of a sensate may be included in any of the regions of the chewing gum in the same or different amounts.

Some embodiments described herein extend to methods of preparing multi-modality chewing gum products, which include at least one sensation duality. In particular, a chewing gum composition including any of the sensation dualities described above may first be provided. The chewing gum composition may include a center-fill region, a gum region surrounding or adjacent to the center-fill region and optionally a third region, which may be a coating. One of the center-fill gum regions may include at least one first sensate and at least a second of the center-fill gum regions may include at least one second sensate. The second sensate may be distinct from, complementary to or different in intensity from the first sensate. Individual chewing gum pieces then may be formed from the chewing gum composition. Methods of forming individual gum pieces from chewing gum compositions are described in more detail below in the section entitled “Center-Fill Chewing Gum Compositions.” As described below, Degady, which is referred to above, describes a suitable apparatus and method for forming center-filled gum pellets.

In some embodiments, methods of imparting a dual sensation perception are provided. In accordance therewith, a chewing gum product prepared as described above may be provided. The chewing gum product may include a center-fill region, a gum region surrounding or adjacent to the center-fill region and optionally a third region, which may be a coating. One of the center-fill gum regions may include at least one first sensate and at least a second of the center-fill gum regions may include at least one second sensate. The second sensate may be distinct from, complementary to or different in intensity from the first sensate. The chewing gum product may be applied into the oral cavity of an individual. As the individual chews the product and saliva mixes therewith, the at least one first sensate and the at least one second sensate may be released from the gum. The individual may experience a dual sensation perception as the first and second sensates are released and combine in the oral cavity.

Additional embodiments described herein relate to methods of developing chewing gum products, which provide a consumer-preferred duality, particularly a sensation duality. In accordance therewith, a consumer preference for a dual sensation combination may first be identified. The dual sensation combination may include at least one first sensate and at least one second sensate, which is distinct from, complementary to or different intensity from the first sensate. A variety of methods may be used to identify a consumer preference for a specific sensation duality, such as, market research, including consumer surveys, taste panels, and the like. Once a consumer preference for a dual sensation combination, such as, for example, cooling and tingling, is identified, a chewing gum product tailored to satisfy that preference may be provided. In particular, any of the center-fill chewing gum products described above may be prepared. The first sensate of the consumer-preferred duality may be added to one region of the gum and the second sensate of the consumer-preferred duality may be added to another region of the gum. The chewing gum product may be marketed to consumers based on the consumer-preferred duality. The product may be marketed in a variety of manners, as described above with respect to the marketing of flavor dualities.

### Taste Dualities

Some center-fill gums may include a duality based on tastes, such as, bitter, salty, sweet, sour, umami and kokumi tastes. Tastants are agents that may provide such tastes. In some embodiments, one of the regions of the center-fill gum may include a first tastant and at least a second of the regions may include at least a second tastant. The second tastant may be distinct from, complementary to or different in intensity from the first tastant. For instance, the center-fill region may include the first tastant and the gum region may include the second tastant. The center-fill region may include the first tastant and the coating may include the second tastant. The gum region may include the first tastant and the coating may include the second tastant.

In some embodiments, the center-fill region may include the first tastant, the gum region the second tastant and the coating may include a third tastant. The coating tastant may be the same as the gum region tastant. In such embodiments, the center-fill tastant may be distinct from, complementary to or different in intensity from both the coating and gum region tastants. In other embodiments, the coating tastant may be complementary to the gum region tastant, but distinct from the center-fill tastant. For example, the gum region and coating tastant may be two different sweeteners, such as, sucralose and sorbitol. The center-fill tastant may be distinct from the sweeteners, such as, for example, a citric acid, which is a sour agent. Alternatively, the coating tastant may be the same as the center-fill tastant. In such embodiments, the gum region tastant may be distinct from, complementary to or different in intensity from both the coating and center-fill tastants. In other embodiments, the coating tastant may be complementary to the center-fill tastant, but distinct from the gum region tastant.

A variety of tastants may be used in any of these or other combinations to impart different dualities. More specifically, in some embodiments, at least two tastants that are distinct may be employed. Dualities based on distinct tastes may include, but are not limited to, the following combinations: a sweet tastant and a sour tastant; a sweet tastant and a salty tastant; a sweet tastant and a bitter tastant; a sweet tastant and an astringent tastant; a sweet tastant and an umami tastant; a sweet tastant and a kokumi tastant; a sour tastant and a salty tastant; a sour tastant and a bitter tastant; a sour tastant and an astringent tastant; a sour tastant and an umami tastant; a sour tastant and a kokumi tastant; a salty tastant and a bitter tastant; a salty tastant and an astringent tastant; a salty tastant and an umami tastant; a salty tastant and a kokumi tastant; a bitter tastant and an astringent tastant; a bitter tastant and an umami tastant; and a bitter tastant and a kokumi tastant.

In some embodiments, at least two tastants that are complementary may be employed. In particular, the complementary tastants may be the same type of tastant, such as, two different bitter agents; two different sour agents, two different sweeteners; two different salts; two different umami agents; or two different kokumi agents.

In some embodiments, the duality may be based on at least two portions of a tastant that differ in intensity. Any of the following types of tastants may be used in at least two portions, each of which contains a different amount of the tastant: bitter agents; sour agents, sweeteners; salts; umami agents; or kokumi agents. For example, one of the regions of the chewing gum may include a first amount of a tastant and a separate region may include a second amount of the same tastant. The second amount may be greater than the first amount of the tastant, thereby creating an intensity differential in the taste. It further may be desirable, in some embodiments, to include a third portion of the same tastant in the remaining region of the chewing gum, which is different in amount than the first and/or second portion of the tastant.

Some of the duality combinations set forth above include an umami tastant. “Umami” refers to a taste that is savory, or the taste of glutamate.

Some of the duality combinations set forth above include a kokami tastant. “Kokumi” refers to materials that impart “mouthfulness” and “good body,” as disclosed in U.S. Pat. No. 5,679,397 to Kuroda et al., which is incorporated in its entirety herein by reference.

A variety of exemplary tastants, such as bitter, salty, sweet, sour, umami and kokumi tastants are provided in Table 2 herein. Specific tastants may be selected from Table 2 and combined in various manners as set forth above and in other combinations or embodiments.

Further, in some embodiments, at least one of the tastants may have a modified release profile. As described in more detail below, components may be at least partially encapsulated to provide a modified release profile. Suitable encapsulating materials and methods of encapsulation are provided in more detail below in the section entitled “Additional Components.” One or all of the tastants used in the chewing gums may be at least partially encapsulated. Further, in some embodiments, at least one of the tastants may include a mixture of the tastant in its encapsulated and unencapsulated (sometimes referred to as “free”) forms. Encapsulated and unencapsulated forms of a tastant may be included in any of the regions of the chewing gum in the same or different amounts.

Some embodiments described herein extend to methods of preparing multi-modality chewing gum products, which include at least one taste duality. In particular, a chewing gum composition including any of the taste dualities described above may first be provided. The chewing gum composition may include a center-fill region, a gum region surrounding or adjacent to the center-fill region and optionally a third region, which may be a coating. One of the center-fill gum regions may include at least one first tastant and at least a second of the center-fill gum regions may include at least one second tastant. The second tastant may be distinct from, complementary to or different in intensity from the first tastant. Individual chewing gum pieces then may be formed from the chewing gum composition. Methods of forming individual gum pieces from chewing gum compositions are described in more detail below in the section entitled “Center-Fill Chewing Gum Compositions.” As described below, Degady, which is referred to above, describes a suitable apparatus and method for forming center-filled gum pellets.

In some embodiments, methods of imparting a dual taste perception are provided. In accordance therewith, a chewing gum product prepared as described above may be provided. The chewing gum product may include a center-fill region, a gum region surrounding or adjacent to the center-fill region and optionally a third region, which may be a coating. One of the center-fill gum regions may include at least one first tastant and at least a second of the center-fill gum regions may include at least one second tastant. The second tastant may be distinct from, complementary to or different in intensity from the first tastant. The chewing gum product may be applied into the oral cavity of an individual. As the individual chews the product and saliva mixes therewith, the at least one first tastant and the at least one second tastant may be released from the gum. The individual may experience a dual taste perception as the first and second tastants are released and combine in the oral cavity.

Additional embodiments described herein relate to methods of developing chewing gum products, which provide a consumer-preferred duality, particularly a taste duality. In accordance therewith, a consumer preference for a dual taste combination may first be identified. The dual taste combination may include at least one first tastant and at least one second tastant, which is distinct from, complementary to or different intensity from the first tastant. A variety of methods may be used to identify a consumer preference for a specific taste duality, such as, market research, including consumer surveys, taste panels, and the like. Once a consumer preference for a dual taste combination, such as, for example, bitter and astringent, is identified, a chewing gum product tailored to satisfy that preference may be provided. In particular, any of the center-fill chewing gum products described above may be prepared. The first tastant of the consumer-preferred duality may be added to one region of the gum and the second tastant of the consumer-preferred duality may be added to another region of the gum. The chewing gum product may be marketed to consumers based on the consumer-preferred duality. The product may be marketed in a variety of manners, as described above with respect to the marketing of flavor dualities.

### Functional Dualities

Some center-fill gums may include a duality based on functionalities. Functionalities include, for example, teeth whitening and breath freshening, among others, and may be provided by various functional agents. In some embodiments, one of the regions of the center-fill gum may include a first functional agent and at least a second of the regions may include at least a second functional agent. The second functional agent may be distinct from, complementary to or different in intensity from the first functional agent. For instance, the center-fill region may include the first functional agent and the gum region may include the second functional agent. The center-fill region may include the first functional agent and the coating may include the second functional agent. The gum region may include the first functional agent and the coating may include the second functional agent.

In some embodiments, the center-fill region may include the first functional agent, the gum region the second functional agent and the coating may include a third functional agent. The coating functional agent, in some embodiments, may be the same as the gum region functional agent. In such embodiments, the center-fill functional agent may be distinct from, complementary to or different in intensity from both the coating and gum region functional agents. In other embodiments, the coating functional agent may be complementary to the gum region functional agent, but distinct from the center-fill functional agent. For example, the gum region and coating functional agents may be two different anti-plaque agents, such as, chlorhexidine and triclosan. The center-fill functional agent may be distinct from the anti-plaque agents, such as, for example, a remineralization agent. Alternatively, the coating functional agent may be the same as the center-fill functional agent. In such embodiments, the gum region functional agent may be distinct from, complementary to or different in intensity from both the coating and center-fill functional agents. In other embodiments, the coating functional agent may be complementary to the center-fill functional agent, but distinct from the gum region functional agent.

A variety of functional agents may be used in any of these or other combinations to impart different dualities. More specifically, in some embodiments, at least two functional agents that are distinct may be employed. Dualities based on distinct functional agents may include, but are not limited to, the following combinations: a vitamin and a mineral; a breath freshening agent and a tooth whitening agent; a breath freshening agent and a remineralization agent; a breath freshening agent and an antimicrobial agent; a tooth whitening agent and a stain prevention agent; a remineralization agent and a demineralization agent; an appetite suppressant and a stress relieving agent; an energy boosting agent and a stress relieving agent; and a concentration enhancing agent and a focus enhancing agent.

In some embodiments, at least two functional agents that are complementary may be employed. In particular, the complementary functional agents may be the same type of functional agent, such as, two different surfactants, two different breath freshening agents, two different anti-microbial agents, two different antibacterial agents, two different anti-calculus agents, two different anti-plaque agents, two different fluoride compounds, two different quaternary ammonium compounds, two different remineralization agents, two different demineralization agents, two different pharmaceutical actives, two different micronutrients, two different throat care actives, two different tooth whitening agents, two different stain removing agents, two different energy boosting agents, two different concentration boosting agents, two different focus enhancing agents and two different appetite suppressants.

In some embodiments, the duality may be based on at least two portions of a functional agent that differ in intensity. Any of the types of functional agents set forth above in the description of complementary functional agents may be used in at least two portions, each of which contains a different amount of the functional agent. For example, one of the regions of the chewing gum may include a first amount of a functional agent and a separate region may include a second amount of the same functional agent. The second amount may be greater than the first amount of the functional agent, thereby creating an intensity differential in the functionality. It further may be desirable, in some embodiments, to include a third portion of the same functional agent in the remaining region of the chewing gum, which is different in amount than the first and/or second portion of the functional agent.

A variety of exemplary functional agents are provided in Table 2 herein. Specific functional agents may be selected from Table 2 and combined in various manners as set forth above and in other combinations or embodiments.

Further, in some embodiments, at least one of the functional agents may have a modified release profile. As described in more detail below, components may be at least partially encapsulated to provide a modified release profile. Suitable encapsulating materials and methods of encapsulation are provided in more detail below in the section entitled “Additional Components.” One or all of the functional agents used in the chewing gums may be at least partially encapsulated. Further, in some embodiments, at least one of the functional agents may include a mixture of the functional agent in its encapsulated and unencapsulated (sometimes referred to as “free”) forms. Encapsulated and unencapsulated forms of a functional agent may be included in any of the regions of the chewing gum in the same or different amounts.

Some embodiments described herein extend to methods of preparing multi-modality chewing gum products, which include at least one functional duality. In particular, a chewing gum composition including any of the functional dualities described above may first be provided. The chewing gum composition may include a center-fill region, a gum region surrounding or adjacent to the center-fill region and optionally a third region, which may be a coating. One of the center-fill gum regions may include at least one first functional agent and at least a second of the center-fill gum regions may include at least one second functional agent. The second functional agent may be distinct from, complementary to or different in intensity from the first functional agent. Individual chewing gum pieces then may be formed from the chewing gum composition. Methods of forming individual gum pieces from chewing gum compositions are described in more detail below in the section entitled “Center-Fill Chewing Gum Compositions.” As described below, Degady, which is referred to above, describes a suitable apparatus and method for forming center-filled gum pellets.

In some embodiments, methods of imparting a dual functional perception are provided. In accordance therewith, a chewing gum product prepared as described above may be provided. The chewing gum product may include a center-fill region, a gum region surrounding or adjacent to the center-fill region and optionally a third region, which may be a coating. One of the center-fill gum regions may include at least one first functional agent and at least a second of the center-fill gum regions may include at least one second functional agent. The second functional agent may be distinct from, complementary to or different in intensity from the first functional agent. The chewing gum product may be applied into the oral cavity of an individual. As the individual chews the product and saliva mixes therewith, the at least one first functional agent and the at least one second functional agent may be released from the gum. The individual may experience a dual functional perception as the first and second functional agents are released and combine in the oral cavity.

Additional embodiments described herein relate to methods of developing chewing gum products, which provide a consumer-preferred duality, particularly a functional duality. In accordance therewith, a consumer preference for a dual functional combination may first be identified. The dual functional combination may include at least one first functional agent and at least one second functional agent, which is distinct from, complementary to or different intensity from the first functional agent. A variety of methods may be used to identify a consumer preference for a specific functional duality, such as, market research, including consumer surveys, taste panels, and the like. Once a consumer preference for a dual functional combination, such as, for example, breath freshening and stain removing, is identified, a chewing gum product tailored to satisfy that preference may be provided. In particular, any of the center-fill chewing gum products described above may be prepared. The first functional agent of the consumer-preferred duality may be added to one region of the gum and the second functional agent of the consumer-preferred duality may be added to another region of the gum. The chewing gum product may be marketed to consumers based on the consumer-preferred duality. The product may be marketed in a variety of manners, as described above with respect to the marketing of flavor dualities.

As mentioned above, specific flavors, sensates, tastants and functional agents may be selected from the exemplary listing of multi-modality components provided in Table 2 below and combined to create any of the different dualities described above. In particular, Table 2 is divided into the three separate regions of a center-fill gum, i.e., coating, center-fill and gum region. Suitable amounts for a multi-modality component when it is selected for use in any of the three regions are set forth in Table 2. Table 2 also provides a listing of basic components typically included in each of the three regions of a center-fill gum. Suitable amounts for the basic components also are set forth in Table 2. The amounts provided for the basic and multi-modality components are based on the specified region in which the component is contained.

Further, the amounts provided for the multi-modality components in Table 2 generally apply to a component as it may be added to the specified region of the gum composition in a free form, i.e., unencapsulated. In some embodiments, where the selected multi-modality component is provided in an encapsulated form, an amount greater than those amounts as set forth in Table 2 may be used due to the modified release profile of the component. Also, because a multi-modality component is selected in a specific embodiment to create a specific duality, the amounts provided in Table 2 represent amounts used only when the component is selected for inclusion in the composition. In other words, the lower limit of 0% is not included even though the multi-modality component may not be present.

Any of the multi-modality components listed in Table 2, below, which are selected to create a specific duality or multi-modality in a center-fill gum composition may be added to any region of the center-fill gum in their encapsulated and/or unencapsulated forms.

For instance, a center-fill gum having a flavor duality may be provided by selecting two complementary fruit flavors from Table 2 and incorporating the flavors into different regions of the gum. A peach flavor, for example, may be incorporated into the center-fill region and a raspberry flavor may be incorporated into the gum region. As provided in the table, the peach flavor may be added to the center-fill region in an amount of about 0.01% to about 10% by weight of the center-fill region. The center-fill region, for example, also may include the basic components for the center-fill region in the amounts provided in the table. One or more optional additives also may be included in the center-fill region, such as intense sweeteners, as described in more detail below in the section entitled “Additional Components.” The raspberry flavor, which is complementary to the peach flavor, may be added to the gum region in an amount of about 0.5% to about 30% by weight of the gum region, as provided in the table. The gum region also may include the basic components in the amounts provided in the table. One ore more optional components also may be included in the gum region, such as bulking agents, fillers, plasticizers, softening agents, mineral adjuvants, waxes, emulsifiers, thickeners and other additives, such as those referred to for the center-fill region. The center-fill gum further may be coated with a coating composition. The coating composition may include the basic components in the amounts provided in the table, i.e., sugar and/or polyols, as well as optional additives, as referred to for the center-fill region.

In another example, a center-fill gum having a functional duality may be provided by selecting two distinct functional agents from Table 2 and incorporating the functional agents into different regions of the gum. Vitamin C, which is a micronutrient, may be incorporated into the gum region and coating of the gum. Aloe vera, which is a throat care agent, may be incorporated into the center-fill region. As provided in the table, the vitamin C may be added to the gum region in an amount of about 0.0001% to about 10% by weight of the gum region. Vitamin C may be added to the coating in an amount of about 0.0001% to about 10% by weight of the coating. As described in the previous example, the gum region also may include basic and optional components. The aloe vera, which provides a distinct throat soothing function from the nutrient function of vitamin C, may be added to the center-fill region in an amount of about 0.1% to about 10% by weight of the center-fill region, as provided in the table. The center-fill region also may include basic and optional components as described in the previous example.

As described above, Table 2 provides a list of multi-modality components that optionally may be present in one or more regions of the gum product. Suitable amounts that may be present in the coating, center-fill or gum region are provided in the table. The amounts in Table 2 are provided as ppm or weight % in a region or layer of the gum product. Table 2 is only representative and is not to be construed to limit the ingredients that can be included in the gum regions in any way.

TABLE 2

| Components | Coating | Center-fill | Gum Region |
|---|---|---|---|
| Basic Components | | | |
| Sugar | 0-100% | | 30-80% |
| Polyol | 0-100% | 0-95% | 30-80% |
| Glycerin | | 1-70% | |
| Natural or synthetic gum | | 0-1% | |
| Gum base | | | 20-50% |
| Bulking agent/Filler | | | 0-12% |
| Plasticizer/Softening agent | | | 0-2.5% |
| Mineral adjuvants | | | 0-12% |
| Wax | | | 0-3.0% |
| Emulsifier/Thickener | | | 0-1% |
| Multi-Modality Components | | | |
| I. Sensates | | | |
| A. Cooling agents | | | |
| Menthol | 10-500 ppm | 10-500 ppm | 500-20,000 ppm |
| Xylitol | 5-80% | 5-95% | 5-80% |
| Erythritol | 5-80% | 5-95% | 5-80% |
| Menthane | 10-500 ppm | 10-500 ppm | 500-20,000 ppm |
| Menthone | 10-500 ppm | 10-500 ppm | 500-20,000 ppm |
| Menthyl acetate | 10-500 ppm | 10-500 ppm | 500-20,000 ppm |
| Menthyl salicylate | 10-500 ppm | 10-500 ppm | 500-20,000 ppm |
| WS-23 | 10-500 ppm | 10-500 ppm | 500-20,000 ppm |
| WS-3 | 10-500 ppm | 10-500 ppm | 500-20,000 ppm |
| Menthyl succinate (and its alkaline | 10-500 ppm | 10-500 ppm | 500-20,000 ppm |
| earth metal salts) | | | |
| 3,1-menthoxypropane 1,2-diol | 10-500 ppm | 10-500 ppm | 500-20,000 ppm |
| Glutarate esters | 10-500 ppm | 10-500 ppm | 500-20,000 ppm |
| dextrose | 10-500 ppm | 10-500 ppm | 500-20,000 ppm |
| sorbitol | 10-500 ppm | 10-500 ppm | 500-20,000 ppm |
| ketals | 10-500 ppm | 10-500 ppm | 500-20,000 ppm |
| menthone ketals | 10-500 ppm | 10-500 ppm | 500-20,000 ppm |
| menthone glycerol ketals | 10-500 ppm | 10-500 ppm | 500-20,000 ppm |
| substituted p-menthanes | 10-500 ppm | 10-500 ppm | 500-20,000 ppm |
| acyclic carboxamides | 10-500 ppm | 10-500 ppm | 500-20,000 ppm |
| mono menthyl glutarate | 10-500 ppm | 10-500 ppm | 500-20,000 ppm |
| substituted cyclohexanamides | 10-500 ppm | 10-500 ppm | 500-20,000 ppm |
| substituted cyclohexane | 10-500 ppm | 10-500 ppm | 500-20,000 ppm |
| carboxamides | | | |
| substituted ureas and sulfonamides | 10-500 ppm | 10-500 ppm | 500-20,000 ppm |
| substituted menthanols | 10-500 ppm | 10-500 ppm | 500-20,000 ppm |
| hydroxymethyl | 10-500 ppm | 10-500 ppm | 500-20,000 ppm |
| hydroxymethyl derivatives of | 10-500 ppm | 10-500 ppm | 500-20,000 ppm |
| p-menthane | | | |
| 2-mercapto-cyclo-decanone | 10-500 ppm | 10-500 ppm | 500-20,000 ppm |
| hydroxycarboxylic acids with 2-6 | 10-500 ppm | 10-500 ppm | 500-20,000 ppm |
| carbon atoms | | | |
| cyclohexanamides | 10-500 ppm | 10-500 ppm | 500-20,000 ppm |
| 1-isopulegol | 10-500 ppm | 10-500 ppm | 500-20,000 ppm |
| 3-(1-menthoxy)-2-methylpropane- | 10-500 ppm | 10-500 ppm | 500-20,000 ppm |
| 1,2-diol | | | |
| p-menthane-2,3-diol | 10-500 ppm | 10-500 ppm | 500-20,000 ppm |
| p-menthane-3,8-diol | 10-500 ppm | 10-500 ppm | 500-20,000 ppm |
| 6-isopropyl-9-methyl-1,4- | 10-500 ppm | 10-500 ppm | 500-20,000 ppm |
| dioxaspiro[4,5]decane-2-methanol | | | |
| trimethylcyclohexanol | 10-500 ppm | 10-500 ppm | 500-20,000 ppm |
| N-ethyl-2-isopropyl-5- | 10-500 ppm | 10-500 ppm | 500-20,000 ppm |
| methylcyclohexanecarboxamide | | | |
| Japanese mint oil | 10-500 ppm | 10-500 ppm | 500-20,000 ppm |
| peppermint oil | 10-500 ppm | 10-500 ppm | 500-20,000 ppm |
| 3-(1-menthoxy)ethan-1-ol | 10-500 ppm | 10-500 ppm | 500-20,000 ppm |
| 3-(1-menthoxy)propan-1-ol | 10-500 ppm | 10-500 ppm | 500-20,000 ppm |
| 3-(1-menthoxy)butan-1-ol | 10-500 ppm | 10-500 ppm | 500-20,000 ppm |
| 1-menthylacetic acid N-ethylamide | 10-500 ppm | 10-500 ppm | 500-20,000 ppm |
| 1-menthyl-4-hydroxypentanoate | 10-500 ppm | 10-500 ppm | 500-20,000 ppm |
| 1-menthyl-3-hydroxybutyrate | 10-500 ppm | 10-500 ppm | 500-20,000 ppm |
| N,2,3-trimethyl-2-(1-methylethyl)- | 10-500 ppm | 10-500 ppm | 500-20,000 ppm |
| butanamide | | | |
| n-ethyl-t-2-c-6 nonadienamide | 10-500 ppm | 10-500 ppm | 500-20,000 ppm |
| N,N-dimethyl menthyl | 10-500 ppm | 10-500 ppm | 500-20,000 ppm |
| succinamide | | | |
| substituted p-menthane- | 10-500 ppm | 10-500 ppm | 500-20,000 ppm |
| carboxamides | | | |
| 2-isopropanyl-5- | 10-500 ppm | 10-500 ppm | 500-20,000 ppm |
| methylcyclohexanol | | | |
| menthyl lactate | 10-500 ppm | 10-500 ppm | 500-20,000 ppm |
| WS-30 | 10-500 ppm | 10-500 ppm | 500-20,000 ppm |
| WS-14 | 10-500 ppm | 10-500 ppm | 500-20,000 ppm |
| Eucalyptus extract | 10-500 ppm | 10-500 ppm | 500-20,000 ppm |
| Menthol PG carbonate | 10-500 ppm | 10-500 ppm | 500-20,000 ppm |
| Menthol EG carbonate | 10-500 ppm | 10-500 ppm | 500-20,000 ppm |
| Menthol glyceryl ether | 10-500 ppm | 10-500 ppm | 500-20,000 ppm |
| N-tertbutyl-p-menthane-3- | 10-500 ppm | 10-500 ppm | 500-20,000 ppm |
| carboxamide | | | |
| P-menthane-3-carboxylic acid | 10-500 ppm | 10-500 ppm | 500-20,000 ppm |
| glycerol ester | | | |
| Methyl-2-isopryl-bicyclo (2.2.1) | 10-500 ppm | 10-500 ppm | 500-20,000 ppm |
| Heptane-2-carboxamide | 10-500 ppm | 10-500 ppm | 500-20,000 ppm |
| Menthol methyl ether | 10-500 ppm | 10-500 ppm | 500-20,000 ppm |
| Methyl glutarate | 10-500 ppm | 10-500 ppm | 500-20,000 ppm |
| menthyl pyrrolidone carboxylate | 10-500 ppm | 10-500 ppm | 500-20,000 ppm |
| WS-5 | 10-500 ppm | 10-500 ppm | 500-20,000 ppm |
| WS-15 | 10-500 ppm | 10-500 ppm | 500-20,000 ppm |
| B. Warming agents | | | |
| vanillyl alcohol n-butylether | 1-1000 ppm | 1-1500 ppm | 10-8000 ppm |
| vanillyl alcohol n-propylether | 1-1000 ppm | 1-1500 ppm | 10-8000 ppm |
| vanillyl alcohol isopropylether | 1-1000 ppm | 1-1500 ppm | 10-8000 ppm |
| vanillyl alcohol isobutylether | 1-1000 ppm | 1-1500 ppm | 10-8000 ppm |
| vanillyl alcohol n-aminoether | 1-1000 ppm | 1-1500 ppm | 10-8000 ppm |
| vanillyl alcohol isoamylether | 1-1000 ppm | 1-1500 ppm | 10-8000 ppm |
| vanillyl alcohol n-hexylether | 1-1000 ppm | 1-1500 ppm | 10-8000 ppm |
| vanillyl alcohol methylether | 1-1000 ppm | 1-1500 ppm | 10-8000 ppm |
| vanillyl alcohol ethylether | 1-1000 ppm | 1-1500 ppm | 10-8000 ppm |
| gingerol | 1-1000 ppm | 1-1500 ppm | 10-8000 ppm |
| shogaol | 1-1000 ppm | 1-1500 ppm | 10-8000 ppm |
| paradol | 1-1000 ppm | 1-1500 ppm | 10-8000 ppm |
| zingerone | 1-1000 ppm | 1-1500 ppm | 10-8000 ppm |
| capsaicin | 1-1000 ppm | 1-1500 ppm | 10-8000 ppm |
| dihydrocapsaicin | 1-1000 ppm | 1-1500 ppm | 10-8000 ppm |
| nordihydrocapsaicin | 1-1000 ppm | 1-1500 ppm | 10-8000 ppm |
| homocapsaicin | 1-1000 ppm | 1-1500 ppm | 10-8000 ppm |
| homodihydrocapsaicin | 1-1000 ppm | 1-1500 ppm | 10-8000 ppm |
| ethanol | 1-1000 ppm | 1-1500 ppm | 10-8000 ppm |
| isopropyl alcohol | 1-1000 ppm | 1-1500 ppm | 10-8000 ppm |
| iso-amylalcohol | 1-1000 ppm | 1-1500 ppm | 10-8000 ppm |
| benzyl alcohol | 1-1000 ppm | 1-1500 ppm | 10-8000 ppm |
| glycerine | 1-1000 ppm | 1-1500 ppm | 10-8000 ppm |
| chloroform | 1-1000 ppm | 1-1500 ppm | 10-8000 ppm |
| eugenol | 1-1000 ppm | 1-1500 ppm | 10-8000 ppm |
| cinnamon oil | 1-1000 ppm | 1-1500 ppm | 10-8000 ppm |
| cinnamic aldehyde | 1-1000 ppm | 1-1500 ppm | 10-8000 ppm |
| C. Tingling agents | | | |
| Jambu Oleoresin or para cress | 5-500 ppm | 5-500 ppm | 50-5000 ppm |
| Japanese pepper extract | 5-500 ppm | 5-500 ppm | 50-5000 ppm |
| black pepper extract | 5-500 ppm | 5-500 ppm | 50-5000 ppm |
| Echinacea extract | 5-500 ppm | 5-500 ppm | 50-5000 ppm |
| Northern Prickly Ash extract | 5-500 ppm | 5-500 ppm | 50-5000 ppm |
| red pepper oleoresin | 5-500 ppm | 5-500 ppm | 50-5000 ppm |
| effervescing agents | 5-500 ppm | 5-500 ppm | 50-5000 ppm |
| Spilanthol | 5-500 ppm | 5-500 ppm | 50-5000 ppm |
| Sanshool | 5-500 ppm | 5-500 ppm | 50-5000 ppm |
| II. Flavors | | | |
| spearmint oil | 0.01-10.0% | 0.01-10.0% | 0.5-30.0% |
| cinnamon oil | 0.01-10.0% | 0.01-10.0% | 0.5-30.0% |
| oil of wintergreen | 0.01-10.0% | 0.01-10.0% | 0.5-30.0% |
| peppermint oil | 0.01-10.0% | 0.01-10.0% | 0.5-30.0% |
| clove oil | 0.01-10.0% | 0.01-10.0% | 0.5-30.0% |
| bay oil | 0.01-10.0% | 0.01-10.0% | 0.5-30.0% |
| anise oil | 0.01-10.0% | 0.01-10.0% | 0.5-30.0% |
| eucalyptus oil | 0.01-10.0% | 0.01-10.0% | 0.5-30.0% |
| thyme oil | 0.01-10.0% | 0.01-10.0% | 0.5-30.0% |
| cedar leaf oil | 0.01-10.0% | 0.01-10.0% | 0.5-30.0% |
| oil of nutmeg | 0.01-10.0% | 0.01-10.0% | 0.5-30.0% |
| allspice | 0.01-10.0% | 0.01-10.0% | 0.5-30.0% |
| oil of sage | 0.01-10.0% | 0.01-10.0% | 0.5-30.0% |
| mace | 0.01-10.0% | 0.01-10.0% | 0.5-30.0% |
| oil of bitter almonds | 0.01-10.0% | 0.01-10.0% | 0.5-30.0% |
| cassia oil | 0.01-10.0% | 0.01-10.0% | 0.5-30.0% |
| vanilla | 0.01-10.0% | 0.01-10.0% | 0.5-30.0% |
| lemon | 0.01-10.0% | 0.01-10.0% | 0.5-30.0% |
| orange | 0.01-10.0% | 0.01-10.0% | 0.5-30.0% |
| lime | 0.01-10.0% | 0.01-10.0% | 0.5-30.0% |
| grapefruit | 0.01-10.0% | 0.01-10.0% | 0.5-30.0% |
| apple | 0.01-10.0% | 0.01-10.0% | 0.5-30.0% |
| pear | 0.01-10.0% | 0.01-10.0% | 0.5-30.0% |
| peach | 0.01-10.0% | 0.01-10.0% | 0.5-30.0% |
| grape | 0.01-10.0% | 0.01-10.0% | 0.5-30.0% |
| strawberry | 0.01-10.0% | 0.01-10.0% | 0.5-30.0% |
| raspberry | 0.01-10.0% | 0.01-10.0% | 0.5-30.0% |
| cherry | 0.01-10.0% | 0.01-10.0% | 0.5-30.0% |
| plum | 0.01-10.0% | 0.01-10.0% | 0.5-30.0% |
| pineapple | 0.01-10.0% | 0.01-10.0% | 0.5-30.0% |
| apricot | 0.01-10.0% | 0.01-10.0% | 0.5-30.0% |
| watermelon | 0.01-10.0% | 0.01-10.0% | 0.5-30.0% |
| chocolate | 0.01-10.0% | 0.01-10.0% | 0.5-30.0% |
| cola | 0.01-10.0% | 0.01-10.0% | 0.5-30.0% |
| maple | 0.01-10.0% | 0.01-10.0% | 0.5-30.0% |
| dulce de leche | 0.01-10.0% | 0.01-10.0% | 0.5-30.0% |
| raisin | 0.01-10.0% | 0.01-10.0% | 0.5-30.0% |
| caramel | 0.01-10.0% | 0.01-10.0% | 0.5-30.0% |
| cinnamyl acetate | 0.01-10.0% | 0.01-10.0% | 0.5-30.0% |
| cinnamaldehyde | 0.01-10.0% | 0.01-10.0% | 0.5-30.0% |
| citral diethylacetal | 0.01-10.0% | 0.01-10.0% | 0.5-30.0% |
| dihydrocarvyl acetate | 0.01-10.0% | 0.01-10.0% | 0.5-30.0% |
| eugenyl formate | 0.01-10.0% | 0.01-10.0% | 0.5-30.0% |
| p-methylamisol | 0.01-10.0% | 0.01-10.0% | 0.5-30.0% |
| acetaldehyde | 0.01-10.0% | 0.01-10.0% | 0.5-30.0% |
| benzaldehyde | 0.01-10.0% | 0.01-10.0% | 0.5-30.0% |
| anisic aldehyde | 0.01-10.0% | 0.01-10.0% | 0.5-30.0% |
| cinnamic aldehyde | 0.01-10.0% | 0.01-10.0% | 0.5-30.0% |
| citral | 0.01-10.0% | 0.01-10.0% | 0.5-30.0% |
| neral | 0.01-10.0% | 0.01-10.0% | 0.5-30.0% |
| decanal | 0.01-10.0% | 0.01-10.0% | 0.5-30.0% |
| ethyl vanillin | 0.01-10.0% | 0.01-10.0% | 0.5-30.0% |
| heliotrope | 0.01-10.0% | 0.01-10.0% | 0.5-30.0% |
| vanillin | 0.01-10.0% | 0.01-10.0% | 0.5-30.0% |
| alpha-amyl cinnamaldehyde | 0.01-10.0% | 0.01-10.0% | 0.5-30.0% |
| butyraldehyde | 0.01-10.0% | 0.01-10.0% | 0.5-30.0% |
| valeraldehyde | 0.01-10.0% | 0.01-10.0% | 0.5-30.0% |
| citronellal | 0.01-10.0% | 0.01-10.0% | 0.5-30.0% |
| decanal | 0.01-10.0% | 0.01-10.0% | 0.5-30.0% |
| aldehyde C-8 | 0.01-10.0% | 0.01-10.0% | 0.5-30.0% |
| aldehyde C-9 | 0.01-10.0% | 0.01-10.0% | 0.5-30.0% |
| aldehyde C-12 | 0.01-10.0% | 0.01-10.0% | 0.5-30.0% |
| 2-ethyl butyraldehyde | 0.01-10.0% | 0.01-10.0% | 0.5-30.0% |
| hexenal | 0.01-10.0% | 0.01-10.0% | 0.5-30.0% |
| tolyl aldehyde | 0.01-10.0% | 0.01-10.0% | 0.5-30.0% |
| veratraldehyde | 0.01-10.0% | 0.01-10.0% | 0.5-30.0% |
| 2,6-dimethyl-5-heptenal | 0.01-10.0% | 0.01-10.0% | 0.5-30.0% |
| 2,6-dimethyloctanal | 0.01-10.0% | 0.01-10.0% | 0.5-30.0% |
| 2-dodecenal | 0.01-10.0% | 0.01-10.0% | 0.5-30.0% |
| strawberry shortcake | 0.01-10.0% | 0.01-10.0% | 0.5-30.0% |
| pomegranate | 0.01-10.0% | 0.01-10.0% | 0.5-30.0% |
| beef | 0.01-10.0% | 0.01-10.0% | 0.5-30.0% |
| chicken | 0.01-10.0% | 0.01-10.0% | 0.5-30.0% |
| cheese | 0.01-10.0% | 0.01-10.0% | 0.5-30.0% |
| onion | 0.01-10.0% | 0.01-10.0% | 0.5-30.0% |
| III. Tastes | | | |
| A. Sweeteners | | | |
| sucrose | 5-100% | 5-100% | 5-80% |
| dextrose | 5-100% | 5-100% | 5-80% |
| maltose | 5-100% | 5-100% | 5-80% |
| dextrin | 5-100% | 5-100% | 5-80% |
| xylose | 5-100% | 5-100% | 5-80% |
| ribose | 5-100% | 5-100% | 5-80% |
| glucose | 5-100% | 5-100% | 5-80% |
| mannose | 5-100% | 5-100% | 5-80% |
| galactose | 5-100% | 5-100% | 5-80% |
| fructose | 5-100% | 5-100% | 5-80% |
| invert sugar | 5-100% | 5-100% | 5-80% |
| fructo oligo saccharide syrups | 5-100% | 5-100% | 5-80% |
| partially hydrolyzed starch | 5-100% | 5-100% | 5-80% |
| corn syrup solids | 5-100% | 5-100% | 5-80% |
| sorbitol | 5-100% | 5-100% | 5-80% |
| xylitol | 5-100% | 5-100% | 5-80% |
| mannitol | 5-100% | 5-100% | 5-80% |
| galactitol | 5-100% | 5-100% | 5-80% |
| maltitol | 5-100% | 5-100% | 5-80% |
| Isomalt | 5-100% | 5-100% | 5-80% |
| lactitol | 5-100% | 5-100% | 5-80% |
| erythritol | 5-100% | 5-100% | 5-80% |
| hydrogenated starch hydrolysate | 5-100% | 5-100% | 5-80% |
| stevia | 10-20,000 ppm | 10-20,000 ppm | 10-20,000 ppm |
| dihydrochalcones | 10-20,000 ppm | 10-20,000 ppm | 10-20,000 ppm |
| monellin | 10-20,000 ppm | 10-20,000 ppm | 10-20,000 ppm |
| steviosides | 10-20,000 ppm | 10-20,000 ppm | 10-20,000 ppm |
| glycyrrhizin | 10-20,000 ppm | 10-20,000 ppm | 10-20,000 ppm |
| dihydroflavenol | 10-20,000 ppm | 10-20,000 ppm | 10-20,000 ppm |
| L-aminodicarboxylic acid | 10-20,000 ppm | 10-20,000 ppm | 10-20,000 ppm |
| aminoalkenoic acid ester amides | | | |
| sodium or calcium saccharin salts | 10-20,000 ppm | 10-20,000 ppm | 10-20,000 ppm |
| cyclamate salts | 10-20,000 ppm | 10-20,000 ppm | 10-20,000 ppm |
| sodium, ammonium or calcium | 10-20,000 ppm | 10-20,000 ppm | 10-20,000 ppm |
| salt of 3,4-dihydro-6-methyl-1,2,3- | | | |
| oxathiazine-4-one-2,2-dioxide | | | |
| Acesulfame-K | 10-20,000 ppm | 10-20,000 ppm | 10-20,000 ppm |
| free acid form of saccharin | 10-20,000 ppm | 10-20,000 ppm | 10-20,000 ppm |
| Aspartame | 10-20,000 ppm | 10-20,000 ppm | 10-20,000 ppm |
| Alitame | 10-20,000 ppm | 10-20,000 ppm | 10-20,000 ppm |
| Neotame | 10-20,000 ppm | 10-20,000 ppm | 10-20,000 ppm |
| methyl esters of L-aspartyl-L- | 10-20,000 ppm | 10-20,000 ppm | 10-20,000 ppm |
| phenylglycerine and L-aspartyl-L- | | | |
| 2,5-dihydrophenyl-glycine | | | |
| L-aspartyl-2,5-dihydro-L- | 10-20,000 ppm | 10-20,000 ppm | 10-20,000 ppm |
| phenylalanine | | | |
| L-aspartyl-L-(1-cyclohexen)- | 10-20,000 ppm | 10-20,000 ppm | 10-20,000 ppm |
| alanine | | | |
| Sucralose | 10-20,000 ppm | 10-20,000 ppm | 10-20,000 ppm |
| 1-chloro-1′-deoxysucrose | 10-20,000 ppm | 10-20,000 ppm | 10-20,000 ppm |
| 4-chloro-4-deoxy-alpha-D- | 10-20,000 ppm | 10-20,000 ppm | 10-20,000 ppm |
| galactopyranosyl-alpha-D- | | | |
| fructofuranoside | | | |
| 4-chloro-4-deoxygalactosucrose | 10-20,000 ppm | 10-20,000 ppm | 10-20,000 ppm |
| 4-chloro-4-deoxy-alpha-D- | 10-20,000 ppm | 10-20,000 ppm | 10-20,000 ppm |
| galactopyranosyl-1-chloro-1- | | | |
| deoxy-beta-D-fructo-furanoside | | | |
| 4,1′-dichloro-4,1′- | 10-20,000 ppm | 10-20,000 ppm | 10-20,000 ppm |
| dideoxygalactosucrose | | | |
| 1′,6′-dichloro1′,6′-dideoxysucrose | 10-20,000 ppm | 10-20,000 ppm | 10-20,000 ppm |
| 4-chloro-4-deoxy-alpha-D- | 10-20,000 ppm | 10-20,000 ppm | 10-20,000 ppm |
| galactopyranosyl-1,6-dichloro-1,6- | | | |
| dideoxy-beta-D-fructofuranoside | | | |
| 4,1′,6′-trichloro-4,1′,6′- | 10-20,000 ppm | 10-20,000 ppm | 10-20,000 ppm |
| trideoxygalactosucrose | | | |
| 4,6-dichloro-4,6-dideoxy-alpha-D- | 10-20,000 ppm | 10-20,000 ppm | 10-20,000 ppm |
| galactopyranosyl-6-chloro-6- | | | |
| deoxy-beta-D-fructofuranoside | | | |
| 4,6,6′-trichloro-4,6,6′- | 10-20,000 ppm | 10-20,000 ppm | 10-20,000 ppm |
| trideoxygalactosucrose | | | |
| 6,1′,6′-trichloro-6,1′,6′- | 10-20,000 ppm | 10-20,000 ppm | 10-20,000 ppm |
| trideoxysucrose | | | |
| 4,6-dichloro-4,6-dideoxy-alpha-D- | 10-20,000 ppm | 10-20,000 ppm | 10-20,000 ppm |
| galacto-pyranosyl-1,6-dichloro-1,6- | | | |
| dideoxy-beta-D-fructofuranoside | | | |
| 4,6,1′,6′-tetrachloro4,6,1′,6′- | 10-20,000 ppm | 10-20,000 ppm | 10-20,000 ppm |
| tetradeoxygalacto-sucrose | | | |
| 4,6,1′,6′-tetradeoxy-sucrose | 10-20,000 ppm | 10-20,000 ppm | 10-20,000 ppm |
| Thaumatin I and II | 10-20,000 ppm | 10-20,000 ppm | 10-20,000 ppm |
| Monatin | 10-20,000 ppm | 10-20,000 ppm | 10-20,000 ppm |
| B. Sour | | | |
| acetic acid | 0.00005-10% | 0.00005-10% | 0.00005-10% |
| adipic acid | 0.00005-10% | 0.00005-10% | 0.00005-10% |
| ascorbic acid | 0.00005-10% | 0.00005-10% | 0.00005-10% |
| butyric acid | 0.00005-10% | 0.00005-10% | 0.00005-10% |
| citric acid | 0.00005-10% | 0.00005-10% | 0.00005-10% |
| formic acid | 0.00005-10% | 0.00005-10% | 0.00005-10% |
| fumaric acid | 0.00005-10% | 0.00005-10% | 0.00005-10% |
| glyconic acid | 0.00005-10% | 0.00005-10% | 0.00005-10% |
| lactic acid | 0.00005-10% | 0.00005-10% | 0.00005-10% |
| phosphoric acid | 0.00005-10% | 0.00005-10% | 0.00005-10% |
| malic acid | 0.00005-10% | 0.00005-10% | 0.00005-10% |
| oxalic acid | 0.00005-10% | 0.00005-10% | 0.00005-10% |
| succinic acid | 0.00005-10% | 0.00005-10% | 0.00005-10% |
| tartaric acid | 0.00005-10% | 0.00005-10% | 0.00005-10% |
| C. Bitter/Astringent | | | |
| quinine | 0.01-100 ppm | 0.01-100 ppm | 0.01-100 ppm |
| naringin | 0.01-100 ppm | 0.01-100 ppm | 0.01-100 ppm |
| quassia | 0.01-100 ppm | 0.01-100 ppm | 0.01-100 ppm |
| phenyl thiocarbamide (PTC) | 0.01-100 ppm | 0.01-100 ppm | 0.01-100 ppm |
| 6-n-propylthiouracil (Prop) | 0.01-100 ppm | 0.01-100 ppm | 0.01-100 ppm |
| alum | 0.01-100 ppm | 0.01-100 ppm | 0.01-100 ppm |
| salicin | 0.01-100 ppm | 0.01-100 ppm | 0.01-100 ppm |
| caffeine | 0.01-100 ppm | 0.01-100 ppm | 0.01-100 ppm |
| D. Salty | | | |
| sodium chloride | 0.01-1% | 0.01-1% | 0.01-1% |
| calcium chloride | 0.01-1% | 0.01-1% | 0.01-1% |
| potassium chloride | 0.01-1% | 0.01-1% | 0.01-1% |
| 1-lysine | 0.01-1% | 0.01-1% | 0.01-1% |
| IV. Functional agents | | | |
| A. Surfactants | | | |
| salts of fatty acids selected from | 0.001-2% | 0.001-2% | 0.001-2% |
| the group consisting of C₈-C₂₄ | | | |
| palmitoleic acid | 0.001-2% | 0.001-2% | 0.001-2% |
| oleic acid | 0.001-2% | 0.001-2% | 0.001-2% |
| eleosteric acid | 0.001-2% | 0.001-2% | 0.001-2% |
| butyric acid | 0.001-2% | 0.001-2% | 0.001-2% |
| caproic acid | 0.001-2% | 0.001-2% | 0.001-2% |
| caprylic acid | 0.001-2% | 0.001-2% | 0.001-2% |
| capric acid | 0.001-2% | 0.001-2% | 0.001-2% |
| lauric acid | 0.001-2% | 0.001-2% | 0.001-2% |
| myristic acid | 0.001-2% | 0.001-2% | 0.001-2% |
| palmitic acid | 0.001-2% | 0.001-2% | 0.001-2% |
| stearic acid | 0.001-2% | 0.001-2% | 0.001-2% |
| ricinoleic acid | 0.001-2% | 0.001-2% | 0.001-2% |
| arachidic acid | 0.001-2% | 0.001-2% | 0.001-2% |
| behenic acid | 0.001-2% | 0.001-2% | 0.001-2% |
| lignoceric acid | 0.001-2% | 0.001-2% | 0.001-2% |
| cerotic acid | 0.001-2% | 0.001-2% | 0.001-2% |
| sulfated butyl oleate | 0.001-2% | 0.001-2% | 0.001-2% |
| medium and long chain fatty acid | 0.001-2% | 0.001-2% | 0.001-2% |
| esters | | | |
| sodium oleate | 0.001-2% | 0.001-2% | 0.001-2% |
| salts of fumaric acid | 0.001-2% | 0.001-2% | 0.001-2% |
| potassium glomate | 0.001-2% | 0.001-2% | 0.001-2% |
| organic acid esters of mono- and | 0.001-2% | 0.001-2% | 0.001-2% |
| diglycerides | | | |
| stearyl monoglyceridyl citrate | 0.001-2% | 0.001-2% | 0.001-2% |
| succistearin | 0.001-2% | 0.001-2% | 0.001-2% |
| dioctyl sodium sulfosuccinate | 0.001-2% | 0.001-2% | 0.001-2% |
| glycerol tristearate | 0.001-2% | 0.001-2% | 0.001-2% |
| lecithin | 0.001-2% | 0.001-2% | 0.001-2% |
| hydroxylated lecithin | 0.001-2% | 0.001-2% | 0.001-2% |
| sodium lauryl sulfate | 0.001-2% | 0.001-2% | 0.001-2% |
| acetylated monoglycerides | 0.001-2% | 0.001-2% | 0.001-2% |
| succinylated monoglycerides | 0.001-2% | 0.001-2% | 0.001-2% |
| monoglyceride citrate | 0.001-2% | 0.001-2% | 0.001-2% |
| ethoxylated mono- and | 0.001-2% | 0.001-2% | 0.001-2% |
| diglycerides | | | |
| sorbitan monostearate | 0.001-2% | 0.001-2% | 0.001-2% |
| calcium stearyl-2-lactylate | 0.001-2% | 0.001-2% | 0.001-2% |
| sodium stearyl lactylate | 0.001-2% | 0.001-2% | 0.001-2% |
| lactylated fatty acid esters of | 0.001-2% | 0.001-2% | 0.001-2% |
| glycerol and propylene glycerol | | | |
| glycerol-lactoesters of C8-C24 | 0.001-2% | 0.001-2% | 0.001-2% |
| fatty acids | | | |
| polyglycerol esters of C8-C24 | 0.001-2% | 0.001-2% | 0.001-2% |
| fatty acids | | | |
| propylene glycol alginate | 0.001-2% | 0.001-2% | 0.001-2% |
| sucrose C8-C24 fatty acid esters | 0.001-2% | 0.001-2% | 0.001-2% |
| diacetyl tartaric and citric acid | 0.001-2% | 0.001-2% | 0.001-2% |
| esters of mono- and diglycerides | | | |
| triacetin | 0.001-2% | 0.001-2% | 0.001-2% |
| sarcosinate surfactants | 0.001-2% | 0.001-2% | 0.001-2% |
| isethionate surfactants | 0.001-2% | 0.001-2% | 0.001-2% |
| tautate surfactants | 0.001-2% | 0.001-2% | 0.001-2% |
| pluronics | 0.001-2% | 0.001-2% | 0.001-2% |
| polyethylene oxide condensates of | 0.001-2% | 0.001-2% | 0.001-2% |
| alkyl phenols | | | |
| products derived from the | 0.001-2% | 0.001-2% | 0.001-2% |
| condensation of ethylene oxide | | | |
| with the reaction product of | | | |
| propylene oxide and ethylene | | | |
| diamine | | | |
| ethylene oxide condensates of | 0.001-2% | 0.001-2% | 0.001-2% |
| aliphatic alcohols | | | |
| long chain tertiary amine oxides | 0.001-2% | 0.001-2% | 0.001-2% |
| long chain tertiary phosphine | 0.001-2% | 0.001-2% | 0.001-2% |
| oxides | | | |
| long chain dialkyl sulfoxides | 0.001-2% | 0.001-2% | 0.001-2% |
| B. Breath freshening agents | | | |
| spearmint oil | 0.001-10% | 0.001-10% | 0.001-10% |
| peppermint oil | 0.001-10% | 0.001-10% | 0.001-10% |
| wintergreen oil | 0.001-10% | 0.001-10% | 0.001-10% |
| sassafras oil | 0.001-10% | 0.001-10% | 0.001-10% |
| chlorophyll oil | 0.001-10% | 0.001-10% | 0.001-10% |
| citral oil | 0.001-10% | 0.001-10% | 0.001-10% |
| geraniol oil | 0.001-10% | 0.001-10% | 0.001-10% |
| cardamom oil | 0.001-10% | 0.001-10% | 0.001-10% |
| clove oil | 0.001-10% | 0.001-10% | 0.001-10% |
| sage oil | 0.001-10% | 0.001-10% | 0.001-10% |
| carvacrol oil | 0.001-10% | 0.001-10% | 0.001-10% |
| eucalyptus oil | 0.001-10% | 0.001-10% | 0.001-10% |
| cardamom oil | 0.001-10% | 0.001-10% | 0.001-10% |
| magnolia bark extract oil | 0.001-10% | 0.001-10% | 0.001-10% |
| marjoram oil | 0.001-10% | 0.001-10% | 0.001-10% |
| cinnamon oil | 0.001-10% | 0.001-10% | 0.001-10% |
| lemon oil | 0.001-10% | 0.001-10% | 0.001-10% |
| lime oil | 0.001-10% | 0.001-10% | 0.001-10% |
| grapefruit oil | 0.001-10% | 0.001-10% | 0.001-10% |
| orange oil | 0.001-10% | 0.001-10% | 0.001-10% |
| cinnamic aldehyde | 0.001-10% | 0.001-10% | 0.001-10% |
| salicylaldehyde | 0.001-10% | 0.001-10% | 0.001-10% |
| menthol | 0.001-10% | 0.001-10% | 0.001-10% |
| carvone | 0.001-10% | 0.001-10% | 0.001-10% |
| iso-garrigol | 0.001-10% | 0.001-10% | 0.001-10% |
| anethole | 0.001-10% | 0.001-10% | 0.001-10% |
| zinc citrate | 0.01-25% | 0.01-25% | 0.1-15% |
| zinc acetate | 0.01-25% | 0.01-25% | 0.1-15% |
| zinc fluoride | 0.01-25% | 0.01-25% | 0.1-15% |
| zinc ammonium sulfate | 0.01-25% | 0.01-25% | 0.1-15% |
| zinc bromide | 0.01-25% | 0.01-25% | 0.1-15% |
| zinc iodide | 0.01-25% | 0.01-25% | 0.1-15% |
| zinc chloride | 0.01-25% | 0.01-25% | 0.1-15% |
| zinc nitrate | 0.01-25% | 0.01-25% | 0.1-15% |
| zinc flurosilicate | 0.01-25% | 0.01-25% | 0.1-15% |
| zinc gluconate | 0.01-25% | 0.01-25% | 0.1-15% |
| zinc tartarate | 0.01-25% | 0.01-25% | 0.1-15% |
| zinc succinate | 0.01-25% | 0.01-25% | 0.1-15% |
| zinc formate | 0.01-25% | 0.01-25% | 0.1-15% |
| zinc chromate | 0.01-25% | 0.01-25% | 0.1-15% |
| zinc phenol sulfonate | 0.01-25% | 0.01-25% | 0.1-15% |
| zinc dithionate | 0.01-25% | 0.01-25% | 0.1-15% |
| zinc sulfate | 0.01-25% | 0.01-25% | 0.1-15% |
| silver nitrate | 0.01-25% | 0.01-25% | 0.1-15% |
| zinc salicylate | 0.01-25% | 0.01-25% | 0.1-15% |
| zinc glycerophosphate | 0.01-25% | 0.01-25% | 0.1-15% |
| copper nitrate | 0.01-25% | 0.01-25% | 0.1-15% |
| chlorophyll | 0.01-25% | 0.01-25% | 0.1-15% |
| copper chlorophyll | 0.01-25% | 0.01-25% | 0.1-15% |
| chlorophyllin | 0.01-25% | 0.01-25% | 0.1-15% |
| hydrogenated cottonseed oil | 0.5-5% | 0.5-70% | 0.5-15% |
| chlorine dioxide | 0.025-0.50% | 0.025-0.50% | 0.025-0.50% |
| beta cyclodextrin | 0.1-5% | 0.1-5% | 0.1-5% |
| zeolite | 0.1-5% | 0.1-5% | 0.1-5% |
| silica-based materials | 0.1-5% | 0.1-5% | 0.1-5% |
| carbon-based materials | 0.1-5% | 0.1-5% | 0.1-5% |
| enzymes such as laccase, papain, | 0.1-5% | 0.1-5% | 0.1-5% |
| krillase, amylase, glucose oxidase | | | |
| C. Anti-microbial agents | | | |
| cetylpyridinium chloride | 0.01-1% | 0.01-1% | 0.01-1% |
| zinc compounds | 0.01-25% | 0.01-25% | 0.1-15% |
| copper compounds | 0.01-25% | 0.01-25% | 0.1-15% |
| D. Antibacterial agents | | | |
| chlorhexidine | 0.0025-2% | 0.0025-2% | 0.0025-2% |
| alexidine | 0.0025-2% | 0.0025-2% | 0.0025-2% |
| quaternary ammonium salts | 0.0025-2% | 0.0025-2% | 0.0025-2% |
| benzethonium chloride | 0.0025-2% | 0.0025-2% | 0.0025-2% |
| cetyl pyridinium chloride | 0.0025-2% | 0.0025-2% | 0.0025-2% |
| 2,4,4′-trichloro-2′-hydroxy- | 0.0025-2% | 0.0025-2% | 0.0025-2% |
| diphenyl ether (triclosan) | | | |
| E. Anti-calculus agents | | | |
| pyrophosphates | 1-6% | 1-6% | 1-6% |
| triphosphates | 0.1-10% | 0.1-10% | 0.1-10% |
| polyphosphates | 0.1-10% | 0.1-10% | 0.1-10% |
| polyphosphonates | 0.1-10% | 0.1-10% | 0.1-10% |
| dialkali metal pyrophosphate salt | 1-6% | 1-6% | 1-6% |
| tetra alkali polyphosphate salt | 0.1-10% | 0.1-10% | 0.1-10% |
| tetrasodium pyrophosphate | 1-6% | 1-6% | 1-6% |
| tetrapotassium pyrophosphate | 1-6% | 1-6% | 1-6% |
| sodium tripolyphosphate | 0.1-10% | 0.1-10% | 0.1-10% |
| F. Anti-plaque agents | | | |
| chlorhexidine | 0.0025-2% | 0.0025-2% | 0.0025-2% |
| triclosan | 0.01-2% | 0.01-2% | 0.01-2% |
| hexetidine | 0.01-2% | 0.01-2% | 0.01-2% |
| zinc citrate | 0.01-25% | 0.01-25% | 0.1-15% |
| essential oils | 0.001-10% | 0.001-10% | 0.001-10% |
| sodium lauryl sulfate | 0.001-2% | 0.001-2% | 0.001-2% |
| G. Fluoride compounds | | | |
| sodium fluoride | 0.01-1% | 0.01-1% | 0.01-1% |
| sodium monofluorophosphate | 0.01-1% | 0.01-1% | 0.01-1% |
| stannous fluoride | 0.01-1% | 0.01-1% | 0.01-1% |
| H. Quaternary ammonium | | | |
| compounds | | | |
| Benzalkonium Chloride | 0.01-1% | 0.01-1% | 0.01-1% |
| Benzethonium Chloride | 0.01-1% | 0.01-1% | 0.01-1% |
| Cetalkonium Chloride | 0.01-1% | 0.01-1% | 0.01-1% |
| Cetrimide | 0.01-1% | 0.01-1% | 0.01-1% |
| Cetrimonium Bromide | 0.01-1% | 0.01-1% | 0.01-1% |
| Cetylpyridinium Chloride | 0.01-1% | 0.01-1% | 0.01-1% |
| Glycidyl Trimethyl Ammonium | 0.01-1% | 0.01-1% | 0.01-1% |
| Chloride | | | |
| Stearalkonium Chloride | 0.01-1% | 0.01-1% | 0.01-1% |
| I. Remineralization agents | | | |
| phosphopeptide-amorphous | 0.1-5% | 0.1-5% | 0.1-5% |
| calcium phosphate | | | |
| casein phosphoprotein-calcium | 0.1-5% | 0.1-5% | 0.1-5% |
| phosphate complex | | | |
| casein phosphopeptide-stabilized | 0.1-5% | 0.1-5% | 0.1-5% |
| calcium phosphate | | | |
| J. Pharmaceutical actives | | | |
| drugs or medicaments | 0.0001-10% | 0.0001-10% | 0.0001-10% |
| vitamins and other dietary | 0.0001-10% | 0.0001-10% | 0.0001-10% |
| supplements | | | |
| minerals | 0.0001-10% | 0.0001-10% | 0.0001-10% |
| caffeine | 0.0001-10% | 0.0001-10% | 0.0001-10% |
| nicotine | 0.0001-10% | 0.0001-10% | 0.0001-10% |
| fruit juices | 2-10% | 2-60% | 1-15% |
| K. Micronutrients | | | |
| vitamin A | 0.0001-10% | 0.0001-10% | 0.0001-10% |
| vitamin D | 0.0001-10% | 0.0001-10% | 0.0001-10% |
| vitamin E | 0.0001-10% | 0.0001-10% | 0.0001-10% |
| vitamin K | 0.0001-10% | 0.0001-10% | 0.0001-10% |
| vitamin C (ascorbic acid) | 0.0001-10% | 0.0001-10% | 0.0001-10% |
| B vitamins (thiamine or B1, | 0.0001-10% | 0.0001-10% | 0.0001-10% |
| riboflavoin or B2, niacin or B3, | | | |
| pyridoxine or B6, folic acid or B9, | | | |
| cyanocobalimin or B12, | | | |
| pantothenic acid, biotin) | | | |
| sodium | 0.0001-10% | 0.0001-10% | 0.0001-10% |
| magnesium | 0.0001-10% | 0.0001-10% | 0.0001-10% |
| chromium | 0.0001-10% | 0.0001-10% | 0.0001-10% |
| iodine | 0.0001-10% | 0.0001-10% | 0.0001-10% |
| iron | 0.0001-10% | 0.0001-10% | 0.0001-10% |
| manganese | 0.0001-10% | 0.0001-10% | 0.0001-10% |
| calcium | 0.0001-10% | 0.0001-10% | 0.0001-10% |
| copper | 0.0001-10% | 0.0001-10% | 0.0001-10% |
| fluoride | 0.0001-10% | 0.0001-10% | 0.0001-10% |
| potassium | 0.0001-10% | 0.0001-10% | 0.0001-10% |
| phosphorous | 0.0001-10% | 0.0001-10% | 0.0001-10% |
| molybdenum | 0.0001-10% | 0.0001-10% | 0.0001-10% |
| selenium | 0.0001-10% | 0.0001-10% | 0.0001-10% |
| zinc | 0.0001-10% | 0.0001-10% | 0.0001-10% |
| L-carnitine | 0.0001-10% | 0.0001-10% | 0.0001-10% |
| choline | 0.0001-10% | 0.0001-10% | 0.0001-10% |
| coenzyme Q10 | 0.0001-10% | 0.0001-10% | 0.0001-10% |
| alpha-lipoic acid | 0.0001-10% | 0.0001-10% | 0.0001-10% |
| omega-3-fatty acids | 0.0001-10% | 0.0001-10% | 0.0001-10% |
| pepsin | 0.0001-10% | 0.0001-10% | 0.0001-10% |
| phytase | 0.0001-10% | 0.0001-10% | 0.0001-10% |
| trypsin | 0.0001-10% | 0.0001-10% | 0.0001-10% |
| lipases | 0.0001-10% | 0.0001-10% | 0.0001-10% |
| proteases | 0.0001-10% | 0.0001-10% | 0.0001-10% |
| cellulases | 0.0001-10% | 0.0001-10% | 0.0001-10% |
| ascorbic acid | 0.0001-10% | 0.0001-10% | 0.0001-10% |
| citric acid | 0.0001-10% | 0.0001-10% | 0.0001-10% |
| rosemary oil | 0.0001-10% | 0.0001-10% | 0.0001-10% |
| vitamin A | 0.0001-10% | 0.0001-10% | 0.0001-10% |
| vitamin E phosphate | 0.0001-10% | 0.0001-10% | 0.0001-10% |
| tocopherols | 0.0001-10% | 0.0001-10% | 0.0001-10% |
| di-alpha-tocopheryl phosphate | 0.0001-10% | 0.0001-10% | 0.0001-10% |
| tocotrienols | 0.0001-10% | 0.0001-10% | 0.0001-10% |
| alpha lipoic acid | 0.0001-10% | 0.0001-10% | 0.0001-10% |
| dihydrolipoic acid | 0.0001-10% | 0.0001-10% | 0.0001-10% |
| xanthophylls | 0.0001-10% | 0.0001-10% | 0.0001-10% |
| beta cryptoxanthin | 0.0001-10% | 0.0001-10% | 0.0001-10% |
| lycopene | 0.0001-10% | 0.0001-10% | 0.0001-10% |
| lutein | 0.0001-10% | 0.0001-10% | 0.0001-10% |
| zeaxanthin | 0.0001-10% | 0.0001-10% | 0.0001-10% |
| beta-carotene | 0.0001-10% | 0.0001-10% | 0.0001-10% |
| carotenes | 0.0001-10% | 0.0001-10% | 0.0001-10% |
| mixed carotenoids | 0.0001-10% | 0.0001-10% | 0.0001-10% |
| polyphenols | 0.0001-10% | 0.0001-10% | 0.0001-10% |
| flavonoids | 0.0001-10% | 0.0001-10% | 0.0001-10% |
| cartotenoids | 0.0001-10% | 0.0001-10% | 0.0001-10% |
| chlorophyll | 0.0001-10% | 0.0001-10% | 0.0001-10% |
| chlorophyllin | 0.0001-10% | 0.0001-10% | 0.0001-10% |
| fiber | 0.0001-10% | 0.0001-10% | 0.0001-10% |
| anthocyanins | 0.0001-10% | 0.0001-10% | 0.0001-10% |
| cyaniding | 0.0001-10% | 0.0001-10% | 0.0001-10% |
| delphinidin | 0.0001-10% | 0.0001-10% | 0.0001-10% |
| malvidin | 0.0001-10% | 0.0001-10% | 0.0001-10% |
| pelargonidin | 0.0001-10% | 0.0001-10% | 0.0001-10% |
| peonidin | 0.0001-10% | 0.0001-10% | 0.0001-10% |
| petunidin | 0.0001-10% | 0.0001-10% | 0.0001-10% |
| flavanols | 0.0001-10% | 0.0001-10% | 0.0001-10% |
| flavonols | 0.0001-10% | 0.0001-10% | 0.0001-10% |
| catechin | 0.0001-10% | 0.0001-10% | 0.0001-10% |
| epicatechin | 0.0001-10% | 0.0001-10% | 0.0001-10% |
| epigallocatechin | 0.0001-10% | 0.0001-10% | 0.0001-10% |
| epigallocatechingallate | 0.0001-10% | 0.0001-10% | 0.0001-10% |
| theaflavins | 0.0001-10% | 0.0001-10% | 0.0001-10% |
| thearubigins | 0.0001-10% | 0.0001-10% | 0.0001-10% |
| proanthocyanins | 0.0001-10% | 0.0001-10% | 0.0001-10% |
| quercetin | 0.0001-10% | 0.0001-10% | 0.0001-10% |
| kaempferol | 0.0001-10% | 0.0001-10% | 0.0001-10% |
| myricetin | 0.0001-10% | 0.0001-10% | 0.0001-10% |
| isorhamnetin | 0.0001-10% | 0.0001-10% | 0.0001-10% |
| flavononeshesperetin | 0.0001-10% | 0.0001-10% | 0.0001-10% |
| naringenin | 0.0001-10% | 0.0001-10% | 0.0001-10% |
| eriodictyol | 0.0001-10% | 0.0001-10% | 0.0001-10% |
| tangeretin | 0.0001-10% | 0.0001-10% | 0.0001-10% |
| flavones | 0.0001-10% | 0.0001-10% | 0.0001-10% |
| apigenin | 0.0001-10% | 0.0001-10% | 0.0001-10% |
| luteolin | 0.0001-10% | 0.0001-10% | 0.0001-10% |
| lignans | 0.0001-10% | 0.0001-10% | 0.0001-10% |
| phytoestrogens | 0.0001-10% | 0.0001-10% | 0.0001-10% |
| resveratrol | 0.0001-10% | 0.0001-10% | 0.0001-10% |
| isoflavones | 0.0001-10% | 0.0001-10% | 0.0001-10% |
| daidzein | 0.0001-10% | 0.0001-10% | 0.0001-10% |
| genistein | 0.0001-10% | 0.0001-10% | 0.0001-10% |
| soy isoflavones | 0.0001-10% | 0.0001-10% | 0.0001-10% |
| L. Throat care actives | | | |
| (1) analgesics, anesthetics, | | | |
| antipyretic and anti- | | | |
| inflammatory agents | | | |
| menthol | 10-500 ppm | 10-500 ppm | 500-20,000 ppm |
| phenol | 0.1-10% | 0.1-50% | 0.1-20% |
| hexylresorcinol | 0.1-10% | 0.1-50% | 0.1-20% |
| benzocaine | 0.1-10% | 0.1-50% | 0.1-20% |
| dyclonine hydrochloride | 0.1-10% | 0.1-50% | 0.1-20% |
| benzyl alcohol | 0.1-10% | 0.1-50% | 0.1-20% |
| salicyl alcohol | 0.1-10% | 0.1-50% | 0.1-20% |
| acetaminophen | 0.1-10% | 0.1-50% | 0.1-20% |
| aspirin | 0.1-10% | 0.1-50% | 0.1-20% |
| diclofenac | 0.1-10% | 0.1-50% | 0.1-20% |
| diflunisal | 0.1-10% | 0.1-50% | 0.1-20% |
| etodolac | 0.1-10% | 0.1-50% | 0.1-20% |
| fenoprofen | 0.1-10% | 0.1-50% | 0.1-20% |
| flurbiprofen | 0.1-10% | 0.1-50% | 0.1-20% |
| ibuprofen | 0.1-10% | 0.1-50% | 0.1-20% |
| ketoprofen | 0.1-10% | 0.1-50% | 0.1-20% |
| ketorolac | 0.1-10% | 0.1-50% | 0.1-20% |
| nabumetone | 0.1-10% | 0.1-50% | 0.1-20% |
| naproxen | 0.1-10% | 0.1-50% | 0.1-20% |
| piroxicam | 0.1-10% | 0.1-50% | 0.1-20% |
| caffeine | 0.0001-10% | 0.0001-10% | 0.0001-10% |
| lidocaine | 0.1-10% | 0.1-50% | 0.1-20% |
| benzocaine | 0.1-10% | 0.1-50% | 0.1-20% |
| phenol | 0.1-10% | 0.1-50% | 0.1-20% |
| dyclonine | 0.1-10% | 0.1-50% | 0.1-20% |
| benzonotate | 0.1-10% | 0.1-50% | 0.1-20% |
| (2) demulcents | | | |
| slippery elm bark | 0.1-10% | 0.1-10% | 0.1-10% |
| pectin | 0.1-10% | 0.1-10% | 0.1-10% |
| gelatin | 0.1-10% | 0.1-10% | 0.1-10% |
| (3) antiseptics | | | |
| cetylpyridinium chloride | 0.01-1% | 0.01-1% | 0.01-1% |
| domiphen bromide | 0.01-1% | 0.01-1% | 0.01-1% |
| dequalinium chloride | 0.01-1% | 0.01-1% | 0.01-1% |
| (4) antitussives | | | |
| chlophedianol hydrochloride | 0.0001-2% | 0.0001-2% | 0.0001-2% |
| codeine | 0.0001-2% | 0.0001-2% | 0.0001-2% |
| codeine phosphate | 0.0001-2% | 0.0001-2% | 0.0001-2% |
| codeine sulfate | 0.0001-2% | 0.0001-2% | 0.0001-2% |
| dextromethorphan | 0.0001-2% | 0.0001-2% | 0.0001-2% |
| dextromethorphan hydrobromide | 0.0001-2% | 0.0001-2% | 0.0001-2% |
| diphenhydramine citrate | 0.0001-2% | 0.0001-2% | 0.0001-2% |
| diphenhydramine hydrochloride | 0.0001-2% | 0.0001-2% | 0.0001-2% |
| dextrorphan | 0.0001-2% | 0.0001-2% | 0.0001-2% |
| diphenhydramine | 0.0001-2% | 0.0001-2% | 0.0001-2% |
| hydrocodone | 0.0001-2% | 0.0001-2% | 0.0001-2% |
| noscapine | 0.0001-2% | 0.0001-2% | 0.0001-2% |
| oxycodone | 0.0001-2% | 0.0001-2% | 0.0001-2% |
| pentoxyverine | 0.0001-2% | 0.0001-2% | 0.0001-2% |
| (5) throat soothing agents | | | |
| honey | 0.5-25% | 0.5-90% | 0.5-15% |
| propolis | 0.1-10% | 0.1-10% | 0.1-10% |
| aloe vera | 0.1-10% | 0.1-10% | 0.1-10% |
| glycerine | 0.1-10% | 0.1-10% | 0.1-10% |
| menthol | 10-500 ppm | 10-500 ppm | 500-20,000 ppm |
| (6) cough suppressants | | | |
| codeine | 0.0001-2% | 0.0001-2% | 0.0001-2% |
| antihistamines | 0.0001-2% | 0.0001-2% | 0.0001-2% |
| dextromethorphan | 0.0001-2% | 0.0001-2% | 0.0001-2% |
| isoproterenol | 0.0001-2% | 0.0001-2% | 0.0001-2% |
| (7) expectorants | | | |
| ammonium chloride | 0.0001-2% | 0.0001-2% | 0.0001-2% |
| guaifenesin | 0.0001-2% | 0.0001-2% | 0.0001-2% |
| ipecac fluid extract | 0.0001-2% | 0.0001-2% | 0.0001-2% |
| potassium iodide | 0.0001-2% | 0.0001-2% | 0.0001-2% |
| (8) mucolytics | | | |
| acetylcycsteine | 0.0001-2% | 0.0001-2% | 0.0001-2% |
| ambroxol | 0.0001-2% | 0.0001-2% | 0.0001-2% |
| bromhexine | 0.0001-2% | 0.0001-2% | 0.0001-2% |
| (9) antihistamines | | | |
| acrivastine | 0.05-10% | 0.05-10% | 0.05-10% |
| azatadine | 0.05-10% | 0.05-10% | 0.05-10% |
| brompheniramine | 0.05-10% | 0.05-10% | 0.05-10% |
| chlorpheniramine | 0.05-10% | 0.05-10% | 0.05-10% |
| clemastine | 0.05-10% | 0.05-10% | 0.05-10% |
| cyproheptadine | 0.05-10% | 0.05-10% | 0.05-10% |
| dexbrompheniramine | 0.05-10% | 0.05-10% | 0.05-10% |
| dimenhydrinate | 0.05-10% | 0.05-10% | 0.05-10% |
| diphenhydramine | 0.05-10% | 0.05-10% | 0.05-10% |
| doxylamine | 0.05-10% | 0.05-10% | 0.05-10% |
| hydroxyzine | 0.05-10% | 0.05-10% | 0.05-10% |
| meclizine | 0.05-10% | 0.05-10% | 0.05-10% |
| phenindamine | 0.05-10% | 0.05-10% | 0.05-10% |
| phenyltoloxamine | 0.05-10% | 0.05-10% | 0.05-10% |
| promethazine | 0.05-10% | 0.05-10% | 0.05-10% |
| pyrilamine | 0.05-10% | 0.05-10% | 0.05-10% |
| tripelennamine | 0.05-10% | 0.05-10% | 0.05-10% |
| triprolidine | 0.05-10% | 0.05-10% | 0.05-10% |
| astemizole | 0.05-10% | 0.05-10% | 0.05-10% |
| cetirizine | 0.05-10% | 0.05-10% | 0.05-10% |
| ebastine | 0.05-10% | 0.05-10% | 0.05-10% |
| fexofenadine | 0.05-10% | 0.05-10% | 0.05-10% |
| loratidine | 0.05-10% | 0.05-10% | 0.05-10% |
| terfenadine | 0.05-10% | 0.05-10% | 0.05-10% |
| (10) nasal decongestants | | | |
| phenylpropanolamine | 0.1-10% | 0.1-50% | 0.1-20% |
| pseudoephedrine | 0.1-10% | 0.1-50% | 0.1-20% |
| ephedrine | 0.1-10% | 0.1-50% | 0.1-20% |
| phenylephrine | 0.1-10% | 0.1-50% | 0.1-20% |
| oxymetazoline | 0.1-10% | 0.1-50% | 0.1-20% |
| menthol | 0.1-10% | 0.1-50% | 0.1-20% |
| camphor | 0.1-10% | 0.1-50% | 0.1-20% |
| borneol | 0.1-10% | 0.1-50% | 0.1-20% |
| ephedrine | 0.1-10% | 0.1-50% | 0.1-20% |
| eucalyptus oil | 0.001-10% | 0.001-10% | 0.001-10% |
| peppermint oil | 0.001-10% | 0.001-10% | 0.001-10% |
| methyl salicylate | 0.001-10% | 0.001-10% | 0.001-10% |
| bornyl acetate | 0.001-10% | 0.001-10% | 0.001-10% |
| lavender oil | 0.001-10% | 0.001-10% | 0.001-10% |
| wasabi extracts | 0.001-10% | 0.001-10% | 0.001-10% |
| horseradish extracts | 0.001-10% | 0.001-10% | 0.001-10% |
| M. Tooth whitening/Stain | | | |
| removing agents | | | |
| surfactants | 0.001-2% | 0.001-2% | 0.001-2% |
| chelators | 0.1-10% | 0.1-10% | 0.1-10% |
| abrasives | 0.1-5% | 0.1-5% | 0.1-5% |
| oxidizing agents | 0.1-5% | 0.1-5% | 0.1-5% |
| hydrolytic agents | 0.1-5% | 0.1-5% | 0.1-5% |
| N. Energy boosting agents | | | |
| caffeine | 0.0001-10% | 0.0001-10% | 0.0001-10% |
| vitamins | 0.0001-10% | 0.0001-10% | 0.0001-10% |
| minerals | 0.0001-10% | 0.0001-10% | 0.0001-10% |
| amino acids | 0.0001-10% | 0.0001-10% | 0.0001-10% |
| ginseng extract | 0.0001-10% | 0.0001-10% | 0.0001-10% |
| ginko extract | 0.0001-10% | 0.0001-10% | 0.0001-10% |
| guarana extract | 0.0001-10% | 0.0001-10% | 0.0001-10% |
| green tea extract | 0.0001-10% | 0.0001-10% | 0.0001-10% |
| taurine | 0.0001-10% | 0.0001-10% | 0.0001-10% |
| kola nut extract | 0.0001-10% | 0.0001-10% | 0.0001-10% |
| yerba mate leaf | 0.0001-10% | 0.0001-10% | 0.0001-10% |
| Niacin | 0.0001-10% | 0.0001-10% | 0.0001-10% |
| rhodiola root extract | 0.0001-10% | 0.0001-10% | 0.0001-10% |
| O. Concentration boosting | | | |
| agents | | | |
| caffeine | 0.0001-10% | 0.0001-10% | 0.0001-10% |
| ginko extract | 0.0001-10% | 0.0001-10% | 0.0001-10% |
| gotu cola (centella asiatica) | 0.0001-10% | 0.0001-10% | 0.0001-10% |
| German chamomile | 0.0001-10% | 0.0001-10% | 0.0001-10% |
| avina sativa | 0.0001-10% | 0.0001-10% | 0.0001-10% |
| phosphatidyl serine | 0.0001-10% | 0.0001-10% | 0.0001-10% |
| aspalathus linearis | 0.0001-10% | 0.0001-10% | 0.0001-10% |
| pregnenolone | 0.0001-10% | 0.0001-10% | 0.0001-10% |
| rhodiola root extract | 0.0001-10% | 0.0001-10% | 0.0001-10% |
| theanine | 0.0001-10% | 0.0001-10% | 0.0001-10% |
| vinpocetine | 0.0001-10% | 0.0001-10% | 0.0001-10% |
| P. Appetite suppressants | | | |
| caffeine | 0.0001-10% | 0.0001-10% | 0.0001-10% |
| guarana extract | 0.0001-10% | 0.0001-10% | 0.0001-10% |
| hoodia gordonii | 0.0001-10% | 0.0001-10% | 0.0001-10% |
| glucomannan | 0.0001-10% | 0.0001-10% | 0.0001-10% |
| calcium | 0.0001-10% | 0.0001-10% | 0.0001-10% |
| garcinia cambogia extract | 0.0001-10% | 0.0001-10% | 0.0001-10% |
| n-acetyl-tyrosine | 0.0001-10% | 0.0001-10% | 0.0001-10% |
| soy phospholipids | 0.0001-10% | 0.0001-10% | 0.0001-10% |
| V. Colors | | | |
| Annatto extract | 0.5-10% | 0.5-20% | 0.5-10% |
| Beta-carotene | 0.5-10% | 0.5-20% | 0.5-10% |
| Canthaxanthin | 0.5-10% | 0.5-20% | 0.5-10% |
| Grape color extract | 0.5-10% | 0.5-20% | 0.5-10% |
| Turmeric oleoresin | 0.5-10% | 0.5-20% | 0.5-10% |
| B-Apo-8′-carotenal | 0.5-10% | 0.5-20% | 0.5-10% |
| Beet powder | 0.5-10% | 0.5-20% | 0.5-10% |
| Caramel color | 0.5-10% | 0.5-20% | 0.5-10% |
| Carmine | 0.5-10% | 0.5-20% | 0.5-10% |
| Cochineal extract | 0.5-10% | 0.5-20% | 0.5-10% |
| Grape skin extract | 0.5-10% | 0.5-20% | 0.5-10% |
| Saffron | 0.5-10% | 0.5-20% | 0.5-10% |
| Tumeric | 0.5-10% | 0.5-20% | 0.5-10% |
| Titanium dioxide | 0.05-2% | 0.05-2% | 0.05-2% |
| F.D. & C. Blue No. 1 | 0.05-2% | 0.05-2% | 0.05-2% |
| F.D.& C. Blue No. 2 | 0.05-2% | 0.05-2% | 0.05-2% |
| F.D.& C. Green No. 1 | 0.05-2% | 0.05-2% | 0.05-2% |
| F.D. & C. Red No. 40 | 0.05-2% | 0.05-2% | 0.05-2% |
| F.D. & C. Red No. 3 | 0.05-2% | 0.05-2% | 0.05-2% |
| F.D. & C. Yellow No. 6 | 0.05-2% | 0.05-2% | 0.05-2% |
| F.D. & C. Yellow No. 5 | 0.05-2% | 0.05-2% | 0.05-2% |

As mentioned above, some embodiments described herein may include more than one duality in the chewing gum composition. Such compositions may be referred to as multi-modality compositions. In some embodiments, more than one duality of the same type may be included, such as, two different flavor dualities. Alternatively, different types of dualities may be combined in a single chewing gum composition. For instance, a flavor duality and a sensation duality may be used together. Further, three or even four of the different duality types may be included in one chewing gum composition in some embodiments.

### Center-Fill Chewing Gum Compositions

As described in detail herein, components that create the dualities described above may be added to the same or different regions of a center-fill gum composition. Center-fill gum compositions may include a center-fill region and a gum region, which includes a gum base. The gum region may at least partially surround or be positioned adjacent to the center-fill region. Optionally, a third region, or a coating, may at least partially surround the gum region.

In some embodiments, the gum region may have a non-uniform thickness. In particular, the gum region in layered configuration embodiments may be thinner on the ends than on the sides of the gum piece.

The center-fill region of the gum composition may be a liquid, solid or semi-solid, gas, or the like. Embodiments that include a liquid center-fill composition, as well as some semi-solid center-fill compositions, may involve concerns regarding retention of the liquid center during manufacturing and shelf-life, as mentioned above. It may be desirable, therefore, to employ gum region compositions with liquid-fill gums that substantially reduce or prevent leaking of the liquid center. Suitable gum region compositions are discussed in detail below.

Non-liquid, i.e., solid, some semi-solid and gaseous center-fill regions, however, may not involve leaking concerns. Accordingly, gum region compositions that may exhibit leaking problems when combined with liquid centers may be suitable for use with non-liquid centers. As such, in addition to the gum region compositions discussed below for use with liquid centers, any conventional chewing gum composition may be employed in the gum region in non-liquid center-fill embodiments.

In some embodiments, the composition in the center-fill may be lipophilic. In such embodiments, it may be desirable to adjust the gum region composition to account for such compositions. In particular, in some embodiments, the gum base used in the gum region composition may be adjusted to include higher proportions of fat when the center-fill composition is lipophilic.

In some embodiments, the center-fill region may be substantially or completely filled with the liquid, solid, semi-solid or gaseous center-fill composition. In some other embodiments, the center-fill region may be only partially filled with the liquid, solid, semi-solid or gaseous center-fill composition.

In some embodiments, the center-fill region may include two or more center-fill compositions. The two or more center-fill compositions may be the same or different forms. For example, some embodiments may contain a mixture of two or more distinct liquids, which may or may not be miscible. Similarly, some embodiments may contain two or more distinct solids, semi-solids or gasses in the center-fill region. Mixtures of different center-fill forms also may be included in some embodiments. For example, a liquid and a solid may be included in the center-fill region. The two or more liquids, solids, semi-solids and/or gasses employed in the center-fill region may be included in the same or different amounts and may have similar or distinct characteristics. More specifically, in some embodiments, the two or more center-fill compositions may differ in a variety of characteristics, such as, viscosity, color, flavor, taste, texture, sensation, ingredient components, functional components, sweeteners, or the like.

In some embodiments, the center-fill composition also may include non-liquid components, such as, for example, flavor beads, fruit particles, nut particles, flavor particles, gelatin beads or portions, and the like.

The center-fill gum composition and other compositions described herein may be formed by any technique known in the art which includes the method described by U.S. Pat. No. 6,280,780 to Degady et al. (“Degady”), referred to above. Degady describes an apparatus and method for forming center-filled gum pellets. The method includes first extruding a liquid-filled rope of a chewing gum layer and passing the rope through a sizing mechanism including a series of pairs of pulley-shaped roller members. The roller members “size” the rope or strand of gum material such that it leaves the series of rollers with the desired size and shape for entering a tablet-forming mechanism.

The rope is then led into a tablet-forming mechanism including a pair of rotating chain die members which are endless chain mechanisms and both rotate at the same speed by a motor and gear mechanism. Each of the chain mechanisms include a plurality of open curved die groove members which mate and form die cavities in which the pieces of gum material (pellets or tablets) are formed. While Degady is limited to the formation of pellet or tablet shaped pieces, the gum pieces may be of other shapes as described above. The shape of the die groove members may be altered to provide any desired shape.

The gum may optionally be passed through a cooling tunnel either before entering the tablet-forming mechanism, after exiting the tablet-forming mechanism or both. Cooling of the rope prior to entering the tablet-forming mechanism may be beneficial to prevent rebound of the individual pieces and thus may provide an increase in productivity.

The cooled pieces of gum material are then fed into a storage container for conditioning and further processing. At this point, the cooled pieces of gum material could also be fed directly into a coating tunnel mechanism, such as a rotating tunnel mechanism.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. A variety of coating processes or mechanisms of this type are known. In some embodiments, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusion, or any other process that creates an outermost region.

The coating composition may range from about 2% to about 80%, more specifically, about 20% to about 40% by weight of an individual gum piece which includes a center-fill, a gum region and a coating; even more specifically, from 25% to 35% and still more specifically around 30%. The coating may include sugar or polyol such as maltitol as the primary component, but may also include flavors, colors, etc. as described below in the discussion of the gum region. The coating or outermost region may be crystalline or amorphous.

In some embodiments, the center-filled chewing gum provides resistance from moisture migration from the center-fill to the gum region by modifying both the saccharide or polyol composition and gum base composition present in the gum region. This is particularly relevant for liquid-fill chewing gum embodiments. This is in contrast to the aforementioned conventional approaches and which have not fully addressed the problems associated with manufacturing and shelf-stability of liquid center-filled products.

In some embodiments of the invention, there are included smaller piece-sizes. For example, the smallest conventional piece sizes of commercially available gum are generally in pellet forms. These piece-sizes currently range from about 5-7 grams. In some embodiments liquid filled products have been made using substantially smaller piece sizes, i.e., 50-60% smaller by weight, without loss of liquidity or migration of liquid into the gum region or beyond into the coating. Some inventive embodiments provide a liquid-filled gum piece size range which is greater than about 0.5 grams, more specifically greater than 1.5 grams up to about 3 grams, including the addition of an outer hard coating shell. In addition, in some embodiments a gum piece may include a center-fill, a gum region including a gum base and an outer coating. Such gum pieces may be about 2.2 grams total weight per piece.

With respect to liquid-fill embodiments, it has been discovered that pieces of such small size and particularly with gum shapes or configurations having proportionally more liquid-fill surface area as compared to the weight of the liquid per se, have a greater tendency to lose the liquidity of the center due to the interaction of different factors. While not limited to a single theory, these factors include the small amount of liquid-fill in comparison to the surface of the gum region in which the liquid-fill is in direct contact, the interaction of the type of elastomer with the center-fill (i.e. SBR versus non-SBR), the compatibility of the gum region components with the liquid-fill components, and the potential capillary action of the polyol used in the gum region. For example, the structure of sorbitol, which is customarily used in gum formulations in the United States, does not provide a tightly packed crystalline structure, giving almost a sponge-like appearance. Therefore, in order to provide a center-filled gum piece of less than about 3 grams, the present invention alters the gum and gum base in some embodiments to include a polyol composition having a dense, tightly packed crystalline structure which is unlike the sponge-like structure in conventional sorbitol gum region formulations, in order to provide a center-filled gum piece which resists loss of liquidity.

For other useful center-fill gum compositions and/or components for use therein, see the following co-pending commonly owned patent applications, the contents of which are incorporated herein by reference in their entirety: U.S. Application No. 60/776,748, filed on Feb. 24, 2006, entitled “Liquid-Filled Chewing Gum Composition”; U.S. Application No. 60/776,642, filed on Feb. 24, 2006, entitled “Liquid-Filled Chewing Gum Composition”; U.S. Application No. 60/776,641, filed on Feb. 24, 2006, entitled “Liquid-Filled Chewing Gum Composition”; U.S. Application No. 60/776,508, filed on Feb. 24, 2006, entitled “Center-Filled Chewing Gum with Barrier Layer”; U.S. Application No. 60/776,382, filed on Feb. 24, 2006, entitled “Center-Filled Chewing Gum Composition”; and U.S. Application No. 60/776,637, filed on Feb. 24, 2006, entitled “Center-Filled Chewing Gum Composition”.

### Gum Region

The gum region, also referred to as the second region in the claims, may include one or more cavities therein to house the center-fill. The shape of the cavity will be largely dictated by the final configuration of the chewing gum piece. The gum region also may include a gum base.

In some liquid-fill embodiments, the gum region may provide a liquid barrier to surround and prevent the liquid-fill from migration and premature release. By selection of the ratio of the desired cavity surface area to the liquid-fill weight, optimization of the reduction in potential liquid-fill migration in to the gum region area can be achieved. This is particularly useful when the gum piece size is desired to be substantially smaller than conventional commercialized gum pieces. In particular, liquid-filled pellet gums having sizes of 2 to 3 grams by weight of the entire gum piece have been successfully made. However, smaller gum pieces, as small as about 0.5 grams are contemplated.

Some embodiments, particularly liquid-fill embodiments, may incorporate a modified polyol composition including at least one polyol incorporated into the gum region as discussed herein. Moreover, the selection of a non-SBR gum base in the gum region, in combination with the modified polyol composition has been found to be particularly useful in achieving stable liquid-filled chewing gum compositions.

As mentioned above, the gum region may include a gum base. The gum base may include any component known in the chewing gum art. For example, the gum region may include elastomers, bulking agents, waxes, elastomer solvents, emulsifiers, plasticizers, fillers and mixtures thereof. Wherein the gum region is included in a three component composition including a center-fill, a gum region and a coating layer, the gum region may comprise from about 40% to about 97%, more specifically from about 55% to about 65% by weight of the chewing gum piece, even more specifically about 62%.

The amount of the gum base which is present in the gum region may also vary. In some embodiments, the gum base may be included in the gum region in an amount from about 25% to about 45% by weight of the gum region. A more specific range of gum base in some embodiments may be from about 28% to about 42% by weight of the gum region. Even more. specifically, the range may be from about 28% to about 35% or from about 28% to about 30% in some embodiments. Alternatively, in some high gum base embodiments, the gum base may be present in an amount from about 45% to about 100% by weight of the gum region.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight of the gum region, desirably from about 35% to about 40% by weight.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the imrnmiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include are the hydrogenated vegetable oils and include soybean oil and cottonseed oil which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof These fillers or adjuvants may be used in the gum base compositions in various amounts. The amount of filler, may be present in an amount from about zero to about 40%, and more specifically from about zero to about 30%, by weight of the gum base. In some embodiments, the amount of filler will be from about zero to about 15%, more specifically from about 3% to about 11%.

A variety of traditional ingredients may be optionally included in the gum base in effective amounts such as coloring agents, antioxidants, preservatives, flavoring agents, high intensity sweeteners, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, and mixtures thereof, may also be included. Other conventional chewing gum additives known to one having ordinary skill in the chewing gum art may also be used in the gum base. A variety of components which may be added to the gum region, or alternatively to the liquid-fill region or coating are described in greater detail in the section entitled “Additional Components” hereinbelow.

Some embodiments extend to methods of making the center-fill gum compositions. The manner in which the gum base components are mixed is not critical and is performed using standard techniques and apparatus known to those skilled in the art. In a typical method, an elastomer is admixed with an elastomer solvent and/or a plasticizer and/or an emulsifier and agitated for a period of from 1 to 30 minutes. The remaining ingredients, such as the low melting point wax, are then admixed, either in bulk or incrementally, while the gum base mixture is blended again for 1 to 30 minutes.

The gum composition may include amounts of conventional additives selected from the group consisting of sweetening agents (sweeteners), plasticizers, softeners, emulsifiers, waxes, fillers, bulking agents (carriers, extenders, bulk sweeteners), mineral adjuvants, flavoring agents (flavors, flavorings), coloring agents (colorants, colorings), antioxidants, acidulants, thickeners, medicaments, and the like, and mixtures thereof. Some of these additives may serve more than one purpose. For example, in sugarless gum compositions, a sweetener, such as maltitol or other sugar alcohol, may also function as a bulking agent.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and mixtures thereof, and fillers, such as those discussed above under the category of mineral adjuvants.

In some embodiments, the gum region may also contain a bulking agent. Suitable bulking agents may be water-soluble and include sweetening agents selected from, but not limited to, monosaccharides, disaccharides, polysaccharides, sugar alcohols, and mixtures thereof; randomly bonded glucose polymers such as those polymers distributed under the tradename Litesse™ which is the brand name for polydextrose and is manufactured by Danisco Sweeteners, Ltd. of 41-51 Brighton Road, Redhill, Surryey, RH1 6YS, United Kingdom.; isomalt (a racemic mixture of alpha-D-glucopyranosyl-1,6-mannitol and alpha-D-glucopyranosyl-1,6-sorbitol manufactured under the tradename PALATINIT by Palatinit Sussungsmittel GmbH of Gotlieb-Daimler-Strause 12 a, 68165 Mannheim, Germany); maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugar bulking agents include monosaccharides, disaccharides and polysaccharides such as xylose, ribulose, glucose (dextrose), lactose, mannose, galactose, fructose (levulose), sucrose (sugar), maltose, invert sugar, partially hydrolyzed starch and corn syrup solids, and mixtures thereof.

Suitable sugar alcohol bulking agents include sorbitol, xylitol, mannitol, galactitol, lactitol, maltitol, erythritol, isomalt and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

The sweetening agents which may be included in the compositions of some embodiments may be any of a variety of sweeteners known in the art. These are described in more detail in the “Additional Components” section herein below and may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

Desirably, the sweetener is a high intensity sweetener such as aspartame, neotame, sucralose, and acesulfame potassium (Ace-K).

In general, an effective amount of sweetener may be utilized to provide the level of sweetness desired, and this amount may vary with the sweetener selected. In some embodiments the amount of sweetener may be present in amounts from about 0.001% to about 3%, by weight of the gum composition, depending upon the sweetener or combination of sweeteners used. The exact range of amounts for each type of sweetener may be selected by those skilled in the art.

In some embodiments, particularly liquid-fill embodiments, the gum region may include a specific polyol composition including at least one polyol which is from about 30% to about 80% by weight of said gum region, and specifically from 50% to about 60%. In some liquid-fill embodiments, such gum region compositions may substantially reduce or prevent leaking of the liquid center. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the gum region will depend on many factors including the type of elastomers used in the gum base and the particular polyols used. For example, wherein the total amount of the polyol composition is in the range of about 40% to about 65% based on the weight of the gum region, the amount of maltitol may be from about 40% to about 60% in addition to an amount of sorbitol from about 0 up to about 10%, more specifically, an amount of maltitol may be from about 45% to about 55% in combination with sorbitol from about 5% to about 10% based on the weight of the gum region.

Maltitol is a sweet, water-soluble sugar alcohol useful as a bulking agent in the preparation of beverages and foodstuffs and is more fully described in U.S. Pat. No. 3,708,396, which disclosure is incorporated herein by reference. Maltitol is made by hydrogenation of maltose which is the most common reducing disaccharide and is found in starch and other natural products.

The polyol composition which may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from process in which genetically modified organisms are not utilized.

Some embodiments may include a polyol composition including maltitol which has a greater crystalline density than sorbitol. Other polyols which exhibit a greater crystalline density than sorbitol include xylitol and mannitol. The greater the crystalline density of the polyol the better the barrier properties are. Specifically, a polyol of a greater crystalline density results in a structure with fewer pores, which provides less surface area for potential moisture or fluid migration into the gum region from the liquid-fill.

Since sugar (sucrose) is generally accepted as the baseline for sweetness intensity comparison of sweeteners, including polyols, the polyol composition of some embodiments is described similarly. For example, the polyol composition of may have a sweetness of greater than about 50% of the sweetness of sucrose. More specifically, the polyol composition of the present invention may have sweetness greater than about 70% the sweetness of sucrose.

The polyol composition of some embodiments may also be described in terms of the solubility of the composition. The solubility of the polyol composition will depend on the solubility of the one or more polyols included in the composition. For example, if maltitol is the only polyol included in the polyol composition, the solubility of the polyol composition in water will be about 60% at 25° C.

Blends of different polyols may also be used in some embodiments. Examples of useful polyols are erythritol, lactitol, xylitol, mannitol, maltitol, sorbitol, isomalt, and combinations thereof. Where a blend of more than one polyol is used, the solubility of the polyol composition will depend on a weighted ratio of the amount of the polyol in the blend and the solubility of each individual polyol which is included. For example, a combination of two or more polyols may have a water solubility range of about 60% to about 72%, if it includes maltitol, which has a water solubility of 60% at 25° C., and sorbitol, which has a water solubility of about 72% at 25° C. Other suitable solubility ranges, which depend on the included two or more polyols include the ranges from about 40% to about 60% at 25° C. and 55% to 65% at 25° C. The range of the solubility may vary, depending on the particular polyols used. Alternative suitable solubilities of a polyol combination include those having a solubility less than sucrose (i.e., less than 67%).

In some embodiments, the polyol composition may include particles of a variety of sizes. Specifically, the average particle size of the polyol composition ranges from about 30 microns to about 600 microns, more specifically from about 30 microns to about 200 microns.

Coloring agents may be used in amounts effective to produce the desired color. The coloring agents may include pigments which may be incorporated in amounts up to about 6%, by weight of the gum composition. For example, titanium dioxide may be incorporated in amounts up to about 2%, and preferably less than about 1%, by weight of the gum composition. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino)diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference. Additional coloring components are described in the “Additional Components” section hereinbelow.

Suitable oils and fats usable in gum compositions include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum composition.

Some embodiments may include a method for preparing the improved chewing gum compositions for the gum region, including both chewing gum and bubble gum compositions. The chewing gum compositions may be prepared using standard techniques and equipment known to those skilled in the art. The apparatus useful in accordance with some embodiments comprises mixing and heating apparatus well known in the chewing gum manufacturing arts, and therefore the selection of the specific apparatus will be apparent to the artisan.

With respect to the center-fill layer, the gum region may have a water activity greater than or equal to the water activity of the center-fill composition. However, in compositions wherein a greater water activity is desired in the center or liquid-fill, the water activity of the center-fill composition may be greater than that of the gum region. A higher moisture content will aid in hydration of thickeners like xanthan gum and cellulose when present in the center-fill.

The gum region may have a total moisture content of about 14% by weight of the gum region and more specifically may have a total moisture content from about 9% to about 14% by weight, with a free moisture content of less than about 5%. The center-fill further may have total moisture content including free and bound moisture from about zero up to about 35% by weight of said center-fill, specifically about 22%.

### Center-Fill Composition

The center-fill, also referred to as the interior portion, of the chewing gum composition can take the physical form of a solid, a liquid, a semi-solid or a gas. Depending on the physical form of the center, adjustments can be made to the adjacent portion of the chewing gum composition that will be in contact with the interior portion.

In some embodiments, liquid centers may present viscosity differences that can be manipulated for a desired effect. In some embodiments, liquid centers can be formulated to have low viscosities that consumers perceive as refreshing.

In some embodiments, solid centers may be particulate or unitary. In embodiments where the solid center is particulate, the center can include a plurality of particles. In some particulate solid center-fill embodiments, variables such as particle size and particle size distribution can be manipulated for a desired effect. In some embodiments, small particles with narrow particle size distribution can be included in the center to provide rapid dissolution when contacted with saliva.

In embodiments where the solid center is unitary, the center can include a cohesive mass where distinct particles are not discernible. In some unitary solid center embodiments, the texture can be manipulated for a desired effect. In some embodiments, a unitary solid center can comprise a confectionery format such as nougat to provide a chewy texture experience.

In some embodiments, gaseous centers can form a void in the chewing gum composition that alters the chewing gum composition's texture profile by collapsing upon chewing. In some embodiments, the gaseous center can include a trapped gas such as nitrogen while in other embodiments, the gaseous center can include a mixed gas composition such as air. In some embodiments, the gas can be included in the center as part of a matrix such as a foam or glassy matrix.

Additionally in some embodiments, the physical form of the center region can change. In some embodiments, the center can be solid when manufactured and then become liquid over time. In some embodiments, the initially solid center portion can be a substrate-enzyme blend where the enzyme acts upon the substrate to liquefy the solid. In other embodiments, the initial center solid portion can be a solid at a manufacturing temperature that is lower than the storage temperature such that the center liquefies as the temperature reaches the storage temperature. In some embodiments, the center is a liquid-filled particle that remains solid until ruptured or disrupted when it releases liquid. In some embodiments, the initially solid center portion can interact with an adjacent region configured to contain free moisture such that the center portion pulls moisture from the adjacent region and becomes liquid.

### Solid Center-Fill Compositions

In some embodiments, the solid center can include particulates. Particulates can include, but are not limited to nuts; seeds; cocoa beans; coffee beans; milk powders; fruit-containing particles such as restructured fruit as described in U.S. Pat. No. 6,027,758; freeze dried fruit; freeze dried vegetables; fat particles; cocoa powder; sucrose; starch; polyols such as xylitol, erythritol, sorbitol, mannitol, lactitol, maltitol, isomalt, hydrogenated starch hydrolysates; waxes; and combinations thereof.

In some embodiments, the solid center can include particles onto which other materials have been complexed. In some embodiments, the solid particle can include an absorbent material to which a second material is absorbed. In some embodiments, the solid particle can include an adsorbent material to which a second material is adsorbed. In some embodiments, the solid particle can include a complexation material to which a second material is complexed. In some embodiments, silica particles can absorb at least a second material to form a particulate solid interior portion. In some embodiments, cyclodextrin particles can complex with at least a second material to form a particulate solid interior portion.

In some embodiments where the solid center can change to a liquid, the solid center can include a mixture of invertase and sucrose such invertase operates on sucrose to form liquid invert sugar resulting in a liquid interior portion over time. In some embodiments, the center can be a fat with melting characteristics such that at manufacturing temperatures the fat is solid and then melts to become liquid at storage temperatures. In some embodiments, the solid center can include liquid-filled gelatin or sucrose beads that release liquid when ruptured or disrupted.

In some embodiments, the solid center can include a unitary or particulate solid confectionery composition. Such confectionery compositions can include, but are not limited to, chocolate, compound coating, carob coating, cocoa butter, butter fat, hydrogenated vegetable fat, illipe butter, fondant including fondant-based cremes, fudge, frappe, caramel, nougat, compressed tablet, candy floss (also known as cotton candy), marzipan, hard boiled candy, gummy candy, jelly beans, toffees, jellies including pectin-based gels, jams, preserves, butterscotch, nut brittles or croquant, candied fruit, marshmallow, pastilles, pralines or nougats, flour or starch confectionery, truffles, nonpareils, bon bons, after-dinner mints, fourres, nut pastes, peanut butter, chewing gum, kisses, angel kisses, montelimart, nougatine, fruit chews, Turkish delight, hard gums, soft gums, starch jellies, gelatin jellies, agar jellies, persipan, coconut paste, coconut ice, lozenges, cachous, creme paste, dragees, sugared nuts, sugared almonds, comfits, aniseed balls, licorice, licorice paste, chocolate spreads, chocolate crumb, truffles, gasified candy and combinations thereof.

### Liquid Center-Fill Compositions

In some embodiments, the liquid center can be aqueous while in other embodiments the liquid center can be non-aqueous. In some embodiments, the liquid center can be a solution while in other embodiments, the center can be a suspension while in still other embodiments, the center can be an emulsion.

In some embodiments, the viscosity of the liquid center can be manipulated for a variety of reasons including, but not limited to, processing efficiency or creation of a desired perception. In some embodiments, the viscosity of the liquid center can be 3,000 to 10,000 pascal seconds. In some embodiments, the viscosity of the liquid center can be 4,000 to 6,5000 pascal seconds.

In some embodiments, the water activity of the liquid center can be manipulated for a variety of reasons including, but not limited to, microbial stability or maintenance of a desired texture. In some embodiments, the water activity of the liquid center can be 0.1 to 0.7. In some embodiments, the water activity of the liquid center can be 0.25 to 0.35.

Liquids that can be included in the liquid center can include, but are not limited to, fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk, cream, etc.; and combinations thereof.

### Gaseous Center-Fill Compositions

In some embodiments, a gaseous center can be formed by creating a hollow center. The gas can include a mixed composition gas such as air or it can include a single gas such as nitrogen, carbon dioxide, or oxygen. In some embodiments, a gaseous center will include gas trapped in a matrix such as a glassy matrix or foam. In some embodiments where gas can be trapped in a glassy matrix, the glass can be sucrose and the gas can be carbon dioxide. In some embodiments where gas can be introduced into the center in a foam, the foam can include milk proteins and the gas can include a mixed composition gas such as air.

Any of the center-fill compositions discussed above may include any components known in the art for incorporation with a center-fill composition. In some embodiments, particularly liquid-fill embodiments, for instance, this may include glycerine in addition to one or more other polyols in amounts greater than zero up to about 20%, more specifically, up to about 10% by weight of the total chewing gum composition, i.e., including a center-fill composition, a gum region and a coating. In some embodiments, the center-fill is approximately 8% by weight of the total chewing gum composition. In some embodiments, the other polyol component includes desirably maltitol, sorbitol, xylitol, or a combination thereof.

In some embodiments, the centers may contain those traditional ingredients well known in the chewing gum and confectionery arts, such as flavoring agents, sweetening agents, and the like, and mixtures thereof, as described above. In addition to confectionery additives, the centers may also contain pharmaceutical additives such as medicaments, breath fresheners, vitamins, minerals, caffeine, fruit juices, and the like, and mixtures thereof. The confectionery and pharmaceutical agents may be used in many distinct physical forms well known in the art to provide an initial burst of sweetness and flavor and/or therapeutic activity or a prolonged sensation of sweetness and flavor and/or therapeutic activity. Without being limited thereto, such physical forms include free forms, such as spray dried, powdered, and beaded forms, and encapsulated forms, and mixtures thereof. Illustrative, but not limiting, examples of liquid centers suitable for use in some embodiments include those centers disclosed in U.S. Pat. Nos. 3,894,154, 4,156,740, 4,157,402, 4,316,915, and 4,466,983, which disclosures are incorporated herein by reference. Specific examples of suitable additional components include taurine, guarana, vitamins, Actizol™, chlorophyll, Recaldent™ tooth remineralization technology, and Retsyn™ breath freshening technology.

In some embodiments, particularly liquid-fill embodiments, the center-fill composition also may include a natural or synthetic gum such as carboxymethylcellulose, pectin, propylene glycol aginate, agar and gum tragacanth. These compositions serve to increase viscosity by reducing the amount of free water in the composition. The viscosity of the center-fill may range from about 300 cp to about 6,000 cp at 25° C. In liquid-fill compositions which have a greater water activity than the surrounding gum region, the viscosity may range from about 3,000 cp to about 6,000 cp at 25° C.

Xanthan gum may also be used to increase the viscosity of the center-fill composition. In some liquid-fill embodiments, increasing viscosity of the liquid also helps prevent the liquid from leaking through the gum piece. Xanthan gum is available under the tradename Keltrol® from CP Kelco of Altanta, Ga.

Some embodiments extend to methods of making the improved center-filled chewing gum compositions. The improved compositions may be prepared using standard techniques and equipment known to those skilled in the art. The apparatus useful in accordance with the embodiments described herein comprises mixing and heating apparatus well known in the chewing gum manufacturing arts, and therefore the selection of the specific apparatus will be apparent to the artisan. Such methods and apparatus are disclosed, for example, in U.S. Pat. Nos. 3,806,290 and 3,857,963, which disclosures are incorporated herein by reference.

### Coating Composition

The coating composition, when included in the center-fill compositions, may be applied by any method known in the art including the method described above. The coating composition may be present in an amount from about 2% to about 80%, more specifically from about 25% to about 35% by weight of the total center-filled gum piece, even more specifically about 30% by weight of the gum piece.

The outer coating may be hard, crunchy or soft. Typically, the outer coating may include sorbitol, maltitol, xylitol, erythritol, isomalt, and other crystallizable polyols; sucrose may also be used. Furthermore the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition comprises a coating, it is possible that one or more oral care actives can be dispersed throughout the coating. This is especially preferred if one or more oral care actives is incompatible in a single phase composition with another of the actives. Flavors may also be added to yield unique product characteristics.

In some embodiments, the coating may also be formulated to assist with increasing the thermal stability of the gum piece and preventing leaking of the liquid fill. In some embodiments, the coating may include a gelatin composition. The gelatin composition may be added as a 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitation, cellulosics such as carboxymethyl cellulose, gelatin, pullulan, alginate, starch, carrageenan, xanthan gum, gum arabic and polyvinyl acetate (PVA).

The coating composition may also include a pre-coating which is added to the individual gum pieces prior to an optional hard coating. The pre-coating may include an application of polyvinyl acetate (PVA). This may be applied as a solution of PVA in a solvent, such as ethyl alcohol. When an outer hard coating is desired, the PVA application may be approximately 3% to 4% by weight of the total coating or about 1% of the total weight of the gum piece (including a center-fill, gum region and hard coating).

Various other coating compositions and methods of making are also contemplated including but not limited to soft panning, dual or multiple extrusion, lamination, etc. Thus, in some embodiments, the coating can be amorphous or crystalline and the resulting texture can be hard, crunchy, crispy, soft or chewy.

### Additional Components

In addition to the components added to create the duality, or multi-modality, a variety of optional additives also may be included in some embodiments. The optional additives include components, such as flavors, sensates, tastants and functional agents, as set forth above, as well as other optional ingredients. In some embodiments, it may be desirable to include other components in the chewing gum composition, in addition to the components that participate in the duality, or multi-modality. For example, in embodiments in which the duality is among functionalities, it may be desirable to add a flavor to one or more regions of the chewing gum composition to provide a flavored chewing gum product. Such additives include, for example, physiological cooling agents, throat-soothing agents, spices, warming agents, tooth-whitening agents, breath-freshening agents, vitamins minerals, caffeine, drugs and other actives, which may be included in any or all portions or regions of the chewing gum composition. Such components may be used in amounts sufficient to achieve their intended effects.

Any of the optional components discussed herein may be added to any region of the center-fill chewing gum composition in their modified release form and/or without modified release (sometimes referred to as “free” components). In some embodiments, for instance, a single component may be added to the center-fill chewing gum in its modified release form and free form. The modified release component and free component may be included together in the same region of the center-fill chewing gum or, in some embodiments, the two components may be included in different regions of the gum.

Types of individual ingredients for which optional managed release from a chewing gum composition may be desired, include, but are not limited to sweeteners, flavors, actives, effervescing ingredients, appetite suppressors, breath fresheners, dental care ingredients, emulsifiers, flavor potentiators, bitterness masking or blocking ingredients, food acids, micronutrients, sensates, mouth moistening ingredients, throat care ingredients, colors, and combinations thereof. Ingredients may be available in different forms such as, for example, liquid form, spray-dried form, or crystalline form. In some embodiments, a delivery system or chewing gum composition may include the same type of ingredient in different forms. For example, a chewing gum composition may include a liquid flavor and a spray-dried version of the same flavor. In some embodiments, the ingredient may be in its free or encapsulated form and may be present in any region of the gum composition such as in the center-fill, the gum region, or the coating.

In some embodiments, an ingredient's release is modified such that when a consumer chews the chewing gum, they may experience an increase in the duration of flavor or sweetness perception and/or the ingredient is released or otherwise made available over a longer period of time. Modified release may be accomplished by any method known in the art, such as by encapsulation. Where modified release is due to encapsulation, this may be accomplished by a variety of means such as by spray coating or extrusion.

Additionally, if early and extended release of the ingredient is desired, the chewing gum composition may include ingredients without modified release (sometimes referred to as “free” ingredients), as well as ingredients with modified release. In some embodiments, a free ingredient may be used to deliver an initial amount or “hit” of an ingredient (e.g., flavor, cooling agent) or an initial sensation or benefit caused by the ingredient (e.g., flavor, nasal action, cooling, warming, tingling, saliva generation, breath freshening, teeth whitening, throat soothing, mouth moistening, etc.). In some embodiments, the same ingredient can be provided with modified release characteristics to provide an additional or delayed amount of the same sensation or benefit. By using both the free ingredient and the ingredient with modified release characteristics, the sensation or benefit due to the ingredient may be provided over a longer period of time and/or perception of the sensation or benefit by a consumer may be improved. Also, in some embodiments the initial amount or “hit” of the ingredient may predispose or precondition the consumers' mouth or perception of the chewing gum composition.

As another example, in some embodiments it may be desirable to provide a sustained release of an ingredient in a chewing gum composition over time. To accomplish sustained release, the ingredient may be modified to allow for a lower concentration of the ingredient to be released over a longer period of time versus the release of a higher concentration of the ingredient over a shorter period of time. A sustained release of an ingredient may be advantageous in situations when the ingredient has a bitter or other bad taste at the higher concentrations. A sustained release of an ingredient also may be advantageous when release of the ingredient in higher concentrations over a shorter period of time may result in a lesser amount of the ingredient being optimally delivered to the consumer. For example, for a tooth whitening or breath freshening ingredient, providing too much of the ingredient too fast may result in a consumer swallowing a significant portion of the ingredient before the ingredient has had a chance to interact with the consumer's teeth, mucous membranes, and/or dental work, thereby wasting the ingredient or at least reducing the benefit of having the ingredient in the chewing gum composition.

### Ingredient Release Management

In different embodiments, different techniques, ingredients, and/or delivery systems, may be used to manage release of one or more ingredients in a chewing gum composition. In some embodiments, more than one of the techniques, ingredients, and/or delivery systems may be used.

In some embodiments, the delay in availability or other release of an ingredient in a chewing gum composition caused by encapsulation of the ingredient may be based, in whole or in part, by one or more of the following: the type of encapsulating material, the molecular weight of the encapsulating material, the tensile strength of the delivery system containing the ingredient, the hydrophobicity of the encapsulating material, the presence of other materials in the chewing gum composition (e.g., tensile strength modifying agents, emulsifiers), the ratio of the amounts of one or more ingredients in the delivery system to the amount of the encapsulating material in the delivery system, the number of layers of encapsulating material, the desired texture, flavor, shelf life, or other characteristic of chewing gum composition, the ratio of the encapsulating material to the ingredient being encapsulated, etc. Thus, by changing or managing one or more of these characteristics of a delivery system or the chewing gum composition, release of one or more ingredients in a chewing gum composition during consumption of the chewing gum composition can be managed more effectively and/or a more desirable release profile for one or more ingredients in the delivery system or the gum composition may be obtained. This may lead to a more positive sensory or consumer experience during consumption of the chewing gum composition, more effective release of such one or more ingredients during consumption of the chewing gum composition, less need for the ingredient (e.g., more effective release of the ingredient may allow the amount of the ingredient in the chewing gum composition to be reduced), increased delivery of a therapeutic or other functional benefit to the consumer, etc. Additionally, in some embodiments, managing the release rate or profile can be tailored to specific consumer segments.

### Encapsulation

In some embodiments, one or more ingredients may be encapsulated with an encapsulating material to modify the release profile of the ingredient. In general, partially or completely encapsulating an ingredient used in a chewing gum composition with an encapsulating material may delay release of the ingredient during consumption of the chewing gum composition, thereby delaying when the ingredient becomes available inside the consumer's mouth, throat, and/or stomach, available to react or mix with another ingredient, and/or available to provide some sensory experience and/or functional or therapeutic benefit. This can be particularly true when the ingredient is water soluble or at least partially water soluble.

In some embodiments, encapsulation may be employed to provide barrier protection to or from a component rather than to modify the release of the component. For instance, it often is desirable to limit the exposure of acids to other components in a chewing gum composition. Such acids may be encapsulated to limit their exposure to other components, or alternatively, the other components in the chewing gum composition may be encapsulated to limit their exposure to the acid.

In some embodiments, a material used to encapsulate an ingredient may include water insoluble polymers, co-polymers, or other materials capable of forming a strong matrix, solid coating, or film as a protective barrier with or for the ingredient. In some embodiments, the encapsulating material may completely surround, coat, cover, or enclose an ingredient. In other embodiments, the encapsulating material may only partially surround, coat, cover, or enclose an ingredient. Different encapsulating materials may provide different release rates or release profiles for the encapsulated ingredient. In some embodiments, encapsulating material used in a delivery system may include one or more of the following: polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof.

In some embodiments, an ingredient may be pre-treated prior to encapsulation with an encapsulating material. For example, an ingredient may be coated with a “coating material” that is not miscible with the ingredient or is at least less miscible with the ingredient relative to the ingredient's miscibility with the encapsulating material.

In some embodiments, an encapsulation material may be used to individually encapsulate different ingredients in the same chewing gum composition. For example, a delivery system may include aspartame encapsulated by polyvinyl acetate. Another delivery system may include ace-k encapsulated by polyvinyl acetate. Both delivery systems may be used as ingredients in the same chewing gum or in other chewing gum compositions. For additional examples, see U.S. Patent Application Ser. No. 60/683,634 entitled “Methods and Delivery Systems for Managing Release of One or More Ingredients in an Edible Composition” and filed May 23, 2005, the entire contents of which are incorporated herein by reference for all purposes.

In some embodiments, different encapsulation materials may be used to individually encapsulate different ingredients used in the same chewing gum composition. For example, a delivery system may include aspartame encapsulated by polyvinyl acetate. Another delivery system may include ace-k encapsulated by EVA. Both delivery systems may be used as ingredients in the same chewing gum or other chewing gum compositions. Examples of encapsulated ingredients using different encapsulating materials can be found in U.S. Patent Application Ser. No. 60/655,894 filed Feb. 25, 2005, and entitled “Process for Manufacturing a Delivery System for Active Components as Part of an Edible Composition,” the entire contents of which are incorporated herein by reference for all purposes.

### Methods of Encapsulation

There are many ways to encapsulate one or more ingredients with an encapsulating material. For example, in some embodiments, a sigma blade or Banbury™ type mixer may be used. In other embodiments, an extruder or other type of continuous mixer may be used. In some embodiments, spray coating, spray chilling, absorption, adsorption, inclusion complexing (e.g., creating a flavor/cyclodextrin complex), coacervation, fluidized bed coating, or other process may be used to encapsulate an ingredient with an encapsulating material.

Examples of encapsulation of ingredients can be found in U.S. Patent Application Ser. No. 60/655,894, filed Feb. 25, 2005, and entitled “Process for Manufacturing a Delivery System for Active Components as Part of an Edible Composition,” the entire contents of which are incorporated herein by reference for all purposes. Other examples of encapsulation of ingredients can be found in U.S. Patent Application Ser. No. 10/955,255 filed Sep. 30, 2004, and entitled “Encapsulated Compositions and Methods of Preparation,” the entire contents of which are incorporated herein by reference for all purposes. Further examples of encapsulation of ingredients can be found in U.S. patent application Ser. No. 10/955,149 filed Sep. 30, 2004, and entitled “Thermally Stable High Tensile Strength Encapsulation Compositions for Actives,” the entire contents of which are incorporated herein by reference for all purposes. Still further examples of encapsulation of ingredients can be found in U.S. patent application Ser. No. 11/052,672 filed Feb. 7, 2005, and entitled “Stable Tooth Whitening Gum with Reactive Components,” the entire contents of which are incorporated herein by reference for all purposes. Further encapsulation techniques and resulting delivery systems may be found in U.S. Pat. Nos. 6,770,308, 6,759,066, 6,692,778, 6,592,912, 6,586,023, 6,555,145, 6,479,071, 6,472,000, 6,444,241, 6,365,209, 6,174,514, 5,693,334, 4,711,784, 4,816,265, and 4,384,004, the contents of all of which are incorporated herein by reference for all purposes.

In some embodiments, a delivery system may be ground to a powdered material with a particular size for use as an ingredient in a chewing gum composition. For example, in some embodiments, an ingredient may be ground to approximately the same particle size of the other chewing gum ingredients so as to create a homogeneous mixture. In some embodiments, the delivery system may be ground to a powdered material with an average particle size such as, for example, about 4 to about 100 mesh or about 8 to about 25 mesh or about 12 to about 20 mesh.

### Tensile Strength

In some embodiments, selection of an encapsulating material for one or more ingredients may be based on tensile strength desired for the resulting delivery system. For example, in some embodiments, a delivery system produces delayed or otherwise controlled release of an ingredient through the use of a pre-selected or otherwise desired tensile strength.

In some embodiments, increasing the tensile strength of a delivery system may increase the delayed or extended release of an ingredient in the delivery system. The tensile strength for a delivery system may be matched with a desirable release rate selected according to the type of the ingredient(s) to be encapsulated for the delivery system, the encapsulating material used, any other additives incorporated in the delivery system and/or a chewing gum composition using the delivery system as an ingredient, the desired rate of release of the ingredient, and the like. In some embodiments, the tensile strength of a delivery system which can be at least 6,500 psi, including 7500, 10,000, 20,000, 30,000, 40,000, 50,000, 60,000, 70,000, 80,000, 90,000, 100,000, 125,000, 135,000, 150,000, 165,000, 175,000, 180,000, 195,000, 200,000 and all ranges and subranges there between, for example, a tensile strength range of 6,500 to 200,000 psi.

In some embodiments, a delivery system for one or more ingredients can be provided based on the tensile strength of the delivery system having a specific tensile strength when compared to a standard. Thus, the design of the delivery system is not focused on one characteristic (e.g., molecular weight) of one of the materials (e.g., encapsulating material) used to produce the delivery system. In this manner, a delivery system can be formulated to express a desired release profile by adjusting and modifying the tensile strength through the specific selection of the ingredient(s), encapsulating material, additives, amount of the ingredient(s), amount of encapsulating material, relative amounts of ingredient(s) to encapsulating material, etc. If a desired tensile strength is chosen for a delivery system, any delivery system that has the desired tensile strength may be used without being limited to a particular encapsulating material and its molecular weight. The formulation process can be extended to encapsulating materials that exhibit similar physical and chemical properties as the encapsulating material forming part of the standard delivery system.

In some embodiments, a delivery system for delivering an ingredient may be formulated to ensure an effective sustained release of the ingredient based on the type and amount of the ingredient and the desired release rate for the ingredient. For example, it may be desirable to affect the controlled release of a high intensity sweetener from a chewing gum over a period of twenty-five to thirty minutes to ensure against a rapid burst of sweetness that may be offensive to some consumers. A shorter controlled release time may be desirable for other type of ingredients such as pharmaceuticals or therapeutic agents, which may be incorporated into the same chewing gum composition by using separate delivery systems for each of these ingredients. Delivery systems may be formulated with a particular tensile strength associated with a range of release rates based on a standard. The standard may comprise a series of known delivery systems having tensile strengths over a range extending, for example, from low to high tensile strength values. Each of the delivery systems of the standard will be associated with a particular release rate or ranges of release rates. Thus, for example, a delivery system can be formulated with a relatively slow release rate by a fabricating a delivering system having a relatively high tensile strength. Conversely, lower tensile strength compositions tend to exhibit relatively faster release rates.

In some embodiments, encapsulating material in a delivery system may be present in amounts of from about 0.2% to 10% by weight based on the total weight of the chewing gum composition, including 0.3, 0.5, 0.7, 0.9, 1.0, 1.25, 1.4, 1.7, 1.9, 2.2, 2.45, 2.75, 3.0, 3.5, 4.0, 4.25, 4.8, 5.0, 5.5, 6.0, 6.5, 7.0, 7.25, 7.75, 8.0, 8.3, 8.7, 9.0, 9.25, 9.5, 9.8 and all values and ranges there between, for example, from 1% to 5% by weight. The amount of the encapsulating material can depend in part on the amount of the ingredient(s) component that is encapsulated. The amount of the encapsulating material with respect to the weight of the delivery system, is from about 30% to 99%, including 35, 40, 45, 50, 55, 60, 65, 70, 75, 80, 85, 95, 97 and all values and ranges there between, for example, from about 60% to 90% by weight.

In some embodiments, the tensile strength of a delivery system may be selected from relatively high tensile strengths when a relatively slow rate of release for an ingredient in the delivery system is desired and relatively lower tensile strengths when a faster rate of release for an ingredient in the delivery system is desired. Thus, when employing a tensile strength of 50,000 psi for a delivery system, the release rate of the ingredient, will generally be lower than the release rate of the ingredient in a delivery system having a tensile strength of 10,000 psi regardless of the type of encapsulating material (e.g., polyvinyl acetate) chosen.

In some embodiments, the encapsulating material for a delivery system is polyvinyl acetate. A representative example of a polyvinyl acetate product suitable for use as an encapsulating material in the present invention is Vinnapas® B100 sold by Wacker Polymer Systems of Adrian, Mich. A delivery system utilizing polyvinyl acetate may be prepared by melting a sufficient amount of polyvinyl acetate at a temperature of about 65° C. to 120° C. for a short period of time, e.g., five minutes. The melt temperature will depend on the type and tensile strength of the polyvinyl acetate encapsulating material where higher tensile strength materials will generally melt at higher temperatures. Once the encapsulating material is melted, a suitable amount of an ingredient (e.g., high intensity sweetener such as aspartame) is added and blended into the molten mass thoroughly for an additional short period of mixing. The resulting mixture is a semi-solid mass, which is then cooled (e.g., at 0° C.) to obtain a solid, and then ground to a U.S. Standard sieve size of from about 30 to 200 (600 to 75 microns). The tensile strength of the resulting delivery system can readily be tested according to ASTM-D638.

For additional information regarding how tensile strength of a delivery system may be used to create managed release of one or more ingredients, see U.S. patent application Ser. No. 11/083,968 entitled “A Delivery System for Active Components as Part of an Edible Composition Having Preselected Tensile Strength” and filed on Mar. 21, 2005, and U.S. patent application Ser. No. 10/719,298 entitled “A Delivery System for Active Components as Part of an Edible Composition” and filed Nov. 21, 2003, the complete contents of both of which are incorporated herein by reference for all purposes.

### Hydrophobicity

In some embodiments, the release of one or more ingredients from a delivery system may depend on more than tensile strength. For example, the release of the ingredients may be directly related to the tensile strength of the delivery system and the hydrophobicity (i.e., water resistance) of the encapsulating polymer or other material.

As a more specific example, when a delivery system is used in a chewing gum, moisture may be absorbed in the encapsulated ingredient(s) during mastication and chewing of the chewing gum. This may result in softening of the encapsulating material and releasing of the ingredient(s) during the mastication and chewing of the chewing gum. The softening of the encapsulation material depends on the hydrophobicity of the polymer used as the encapsulation material. In general, the higher the hydrophobicity of the polymer, the longer mastication time is needed for softening the polymer.

As one example, higher hydrophobic polymers such as ethylene-vinylacetate (EVA) copolymer can be used to increase or otherwise manage ingredient (e.g., sweetener) release times from encapsulations. The degree of hydrophobicity can be controlled by adjusting the ratio of ethylene and vinylacetate in the copolymer. In general, the higher the ethylene to vinylacetate ratio, the longer time it will take during consumption to soften the encapsulation particles, and the slower or more delayed will be the release rate of the ingredient. The lower the ethylene to vinylacetate ratio, the shorter time it will take during consumption to soften the encapsulation particles, and the faster or earlier will be the release rate of the ingredient.

As illustrated by the discussion above, in some embodiments, release of an ingredient from a delivery system can be managed or otherwise controlled by formulating the delivery system based on the hydrophobicity of the encapsulating material, e.g., the polymer, for the ingredient. Using highly hydrophobic polymers, the release times of the ingredient can be increased or delayed. In a similar manner, using encapsulating material that is less hydrophobic, the ingredient can be released more rapidly or earlier.

The hydrophobicity of a polymer can be quantified by the relative water-absorption measured according to ASTM D570-98. Thus, by selecting encapsulating material(s) for a delivery system with relatively lower water-absorption properties and adding that to a mixer, the release of the ingredient contained in the produced delivery system can be delayed compared to those encapsulating materials having higher water-absorption properties.

In some embodiments, polymers with water absorption of from about 50 to 100% (as measured according to ASTM D570-98) can be used. Moreover, to decrease the relative delivery rate, the encapsulating material can be selected such that the water absorption would be from about 15% to about 50% (as measured according to ASTM D570-98). Still further, in other embodiments, the water absorption properties of the encapsulating material can be selected to be from 0.0% to about 5% or up to about 15% (as measured according to ASTM D570-98). In other embodiments, mixtures of two or more delivery systems formulated with encapsulating material having different water-absorption properties can also be used in subsequent incorporation into a chewing gum composition.

Polymers with suitable hydrophobicity which may be used for delivery systems include homo- and co-polymers of, for example, vinyl acetate, vinyl alcohol, ethylene, acrylic acid, methacrylate, methacrylic acid and others. Suitable hydrophobic copolymers include the following non-limiting examples, vinyl acetate/vinyl alcohol copolymer, ethylene/vinyl alcohol copolymer, ethylene/acrylic acid copolymer, ethylene/methacrylate copolymer, ethylene/methacrylic acid copolymer.

In some examples, the hydrophobic encapsulating material in a delivery system may be present in amounts of from about 0.2% to 10% by weight based on the total weight of a chewing gum composition containing the delivery system, including 0.3, 0.5, 0.7, 0.9, 1.0, 1.25, 1.4, 1.7, 1.9, 2.2, 2.45, 2.75, 3.0, 3.5, 4.0, 4.25, 4.8, 5.0, 5.5, 6.0, 6.5, 7.0, 7.25, 7.75, 8.0, 8.3, 8.7, 9.0, 9.25, 9.5, 9.8 and all values and ranges there between, for example, from 1% to 5% by weight. The amount of the encapsulating material will, of course, depend in part on the amount of the ingredient that is encapsulated. The amount of the encapsulating material with respect to the weight of the delivery system, is from about 30% to 99%, including 35, 40, 45, 50, 55, 60, 65, 70, 75, 80, 85, 95, 97 and all values and ranges there between, for example, from about 60% to 90% by weight.

In formulating the delivery system based on the selection criteria of hydrophobicity of the encapsulating material, the encapsulated ingredient can be entirely encapsulated within the encapsulating material or incompletely encapsulated within the encapsulating material provided the resulting delivery system meets the criteria set forth hereinabove. The incomplete encapsulation can be accomplished by modifying and/or adjusting the manufacturing process to create partial coverage of the ingredient.

For example, if ethylene-vinyl acetate is the encapsulating material for an ingredient, the degree of hydrophobicity can be controlled by adjusting the ratio of ethylene and vinyl acetate in the copolymer. The higher the ethylene to vinylacetate ratio, the slower the release of the ingredient. Using vinylacetate/ethylene copolymer as an example, the ratio of the vinylacetate/ethylene in the copolymer can be from about 1 to about 60%, including ratios of 2.5, 5, 7.5, 9, 12, 18, 23, 25, 28, 30, 35, 42, 47, 52, 55, 58.5% and all values and ranges there between.

In some embodiments, a method of selecting a target delivery system containing an ingredient for a chewing gum composition is based on the hydrophobicity of the encapsulating material for the ingredient in the delivery system. The method generally includes preparing a targeted delivery system containing an ingredient to be encapsulated, an encapsulating material and optional additives, with the encapsulating material having a pre-selected or otherwise desired hydrophobicity. The hydrophobicity of the encapsulating material employed in the targeted delivery system can be selected to provide a desirable release rate of the ingredient. This selection of the encapsulating material is based on the hydrophobicity of sample delivery systems having the same or similar ingredient and known release rates of the ingredient. In a more preferred another embodiment of the invention, the method comprises (a) obtaining a plurality of sample delivery systems comprising at least one ingredient, at least one encapsulating material, and optional additives, wherein each of the delivery systems is prepared with different encapsulating materials having different hydrophobicities; (b) testing the sample delivery systems to determine the respective release rates of the ingredient(s); and (c) formulating a target delivery system containing the same ingredient(s) with a hydrophobic encapsulating material corresponding to a desired release rate of the ingredient(s) based on the obtained sample delivery systems.

The method of selecting at least one delivery system suitable for incorporation into a chewing gum composition preferably can begin by determining a desired release rate for an ingredient (i.e., a first active component). The determination of the desired release rate may be from known literature or technical references or by in vitro or in vivo testing. Once the desired release rate is determined, the desired hydrophobicity of the encapsulating material can be determined (i.e., a first hydrophobic encapsulating material) for a delivery system (i.e., first delivery system) that can release the first active component at the desired release. Once the delivery system is obtained which can deliver the first active component as required it is then selected for eventual inclusion in a chewing gum composition.

The method described above may then be repeated for a second active component and for additional active components as described via the determination and selection of a suitable delivery system.

For additional information regarding the relationship of hydrophobicity of an encapsulating material to the release of an ingredient from a delivery system, see U.S. Patent Application Ser. No. 60/683,634 entitled “Methods and Delivery Systems for Managing Release of One or More Ingredients in an Edible Composition” and filed on May 23, 2005, with the U.S. Patent and Trademark Office, the complete contents of which are incorporated herein by reference for all purposes.

### Ratio of Ingredient to Encapsulating Material for Ingredient in Delivery System

In general, the “loading” of an ingredient in a delivery system can impact the release profile of the ingredient when the ingredient is used in a chewing gum composition. Loading refers to the amount of one or more ingredients contained in the delivery relative to the amount of encapsulating material. More specifically, the ratio of the amount of one or more ingredients in a delivery system to the amount of encapsulating material in the delivery system can impact the release rate of the one or more ingredients. For example, the lower the ratio or loading of the amount of one or more ingredients in a delivery system to the amount of encapsulating material in the delivery system, the longer or more delayed will be the release of the one or more ingredients from the delivery system. The higher the ratio or loading of the amount of one or more ingredients in a delivery system to the amount of encapsulating material in the delivery system, the faster or earlier will be the release of the one or more ingredients from the delivery system. This principle can be further employed to manage the release profiles of the one or more ingredients by using higher loading of ingredients designed to be released early in combination with lower loading of ingredients designed to be released later. In some embodiments, the one or more ingredients can be the same or different.

As a more specific example, three delivery systems including aspartame encapsulated with a polyvinylacetate and a fat were created using a conventional mixing process wherein the polyvinyl acetate first was melted in a mixer. The aspartame and fat then were added and the three ingredients were mixed to create a homogenous mixture. The delivery systems had the following aspartame to polyvinyl to fat ratios: (1) 5:90:5; (2) 15:80:5, (3) 30:65:5. The molten delivery systems were cooled and sized by passing ground powder through a 420 micron screen. Three chewing gums where created, each using a different delivery system. It was determined that the chewing gum using the first ratio of the ingredients had a lower or slower release of aspartame that the chewing gums using the second or third ratios of the ingredients. Similarly, the gum using the second ratio of the ingredients had a lower or slower release of aspartame than the chewing gum using the third ratio of the ingredients.

For additional information regarding the relationship of the ratio of the amount ingredient in a delivery system to the amount of encapsulating material in the delivery system to the release of an ingredient from a delivery system, see U.S. patent application Ser. No. 11/134,371 entitled “A Delivery System For Active Components as Part of and Edible Composition Including a Ratio of Encapsulating Material and Active Component” and filed on May 23, 2005, with the U.S. Patent and Trademark Office, the complete contents of which are incorporated herein by reference for all purposes.

There are many types of ingredients for which managed release of the ingredients from a chewing gum composition may be desired. In addition, there are many groups of two or more ingredients for which managed release of the group of ingredients from a chewing gum composition may be desired.

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors whose release profiles can be managed include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

In some embodiments, other flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, .e., melonal (melon), 2,6-dimethyloctanal (green fruit), and 2-dodecenal (citrus, mandarin), cherry, grape, blueberry, blackberry, strawberry shortcake, and mixtures thereof.

In some embodiments, a flavoring agent may be employed in either liquid form and/or dried form. When employed in the latter form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, the flavoring agents may be used in many distinct physical forms. Without being limited thereto, such physical forms include free forms, such as spray dried, powdered, beaded forms, encapsulated forms, and mixtures thereof.

Illustrations of the encapsulation of flavors as well as other additional components can be found in the examples provided herein. Typically, encapsulation of a component will result in a delay in the release of the predominant amount of the component during consumption of a chewing gum composition that includes the encapsulated component (e.g., as part of a delivery system added as an ingredient to the chewing gum composition). In some embodiments, the release profile of the ingredient (e.g., the flavor, sweetener, etc.) can be managed by managing various characteristics of the ingredient, delivery system containing the ingredient, and/or the chewing gum composition containing the delivery system and/or how the delivery system is made. For example, characteristics might include one or more of the following: tensile strength of the delivery system, water solubility of the ingredient, water solubility of the encapsulating material, water solubility of the delivery system, ratio of ingredient to encapsulating material in the delivery system, average or maximum particle size of ingredient, average or maximum particle size of ground delivery system, the amount of the ingredient or the delivery system in the chewing gum composition, ratio of different polymers used to encapsulate one or more ingredients, hydrophobicity of one or more polymers used to encapsulate one or more ingredients, hydrophobicity of the delivery system, the type or amount of coating on the delivery system, the type or amount of coating on an ingredient prior to the ingredient being encapsulated, etc.

### Sweetening Ingredients

The sweeteners involved may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, steviosides, glycyrrhizin, dihydroflavenol, and sugar alcohols such as sorbitol, mannitol, maltitol, xylitol, erythritol, and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame), N-[N-(3,3-dimethylbutyl)-L-α-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as thaumaoccous danielli (Thaumatin I and II) and talin; and

(f) the sweetener monatin (2-hydroxy-2-(indol-3-ylmethyl)-4-aminoglutaric acid) and its derivatives.

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K).

In some embodiments, the sweetener may be a polyol. Polyols can include, but are not limited to glycerol, sorbitol, maltitol, maltitol syrup, mannitol, isomalt, erythritol, xylitol, hydrogenated starch hydrolysates, polyglycitol syrups, polyglycitol powders, lactitol, and combinations thereof.

The active component (e.g., sweetener), which is part of the delivery system, may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

### Sensate Ingredients

Sensate compounds can include cooling agents, warming agents, tingling agents, effervescent agents, and combinations thereof. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT(® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds can include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation can be provided. One such tingling sensation is provided by adding jambu, oleoresin, or spilanthol to some examples. In some embodiments, alkylamides extracted from materials such as jambu or sanshool can be included. Additionally, in some embodiments, a sensation is created due to effervescence. Such effervescence is created by combining an alkaline material with an acidic material. In some embodiments, an alkaline material can include alkali metal carbonates, alkali metal bicarbonates, alkaline earth metal carbonates, alkaline earth metal bicarbonates and mixtures thereof. In some embodiments, an acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes.

Sensate components may also be referred to as “trigeminal stimulants” such as those disclosed in U.S. Patent Application No. 205/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, methyl succinate, menthone glycerol ketals, bulk sweeteners such as xylitol, erythritol, dextrose, and sorbitol, and combinations thereof. Trigeminal stimulants can also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof.

### Breath Freshening Ingredients

Breath fresheners can include essential oils as well as various aldehydes, alcohols, and similar materials. In some embodiments, essential oils can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, and orange. In some embodiments, aldehydes such as cinnamic aldehyde and salicylaldehyde can be used. Additionally, chemicals such as menthol, carvone, iso-garrigol, and anethole can function as breath fresheners. Of these, the most commonly employed are oils of peppermint, spearmint and chlorophyll.

In addition to essential oils and chemicals derived from them, in some embodiments breath fresheners can include but are not limited to zinc citrate, zinc acetate, zinc fluoride, zinc ammonium sulfate, zinc bromide, zinc iodide, zinc chloride, zinc nitrate, zinc flurosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based materials, carbon-based materials, enzymes such as laccase, and combinations thereof. In some embodiments, the release profiles of probiotics can be managed for a gum including, but not limited to lactic acid producing microorganisms such as Bacillus coagulans, Bacillus subtilis, Bacillus laterosporus, Bacillus laevolacticus, Sporolactobacillus inulinus, Lactobacillus acidophilus, Lactobacillus curvatus, Lactobacillus plantarum, Lactobacillus jenseni, Lactobacillus casei, Lactobacillus fermentum, Lactococcus lactis, Pedioccocus acidilacti, Pedioccocus pentosaceus, Pedioccocus urinae, Leuconostoc mesenteroides, Bacillus coagulans, Bacillus subtilis, Bacillus laterosporus, Bacillus laevolacticus, Sporolactobacillus inulinus and mixtures thereof. Breath fresheners are also known by the following trade names: Retsyn,™ Actizol,™ and Nutrazin.™ Examples of malodor-controlling compositions are also included in U.S. Pat. No. 5,300,305 to Stapler et al. and in U.S. Patent Application Publication Nos. 2003/0215417 and 2004/0081713 which are incorporated in their entirety herein by reference for all purposes.

### Dental Care Ingredients

Dental care ingredients (also known as oral care ingredients) may include but are not limited to tooth whiteners, stain removers, oral cleaning, bleaching agents, desensitizing agents, dental remineralization agents, antibacterial agents, anticaries agents, plaque acid buffering agents, surfactants and anticalculus agents. Non-limiting examples of such ingredients can include, hydrolytic agents including proteolytic enzymes, abrasives such as hydrated silica, calcium carbonate, sodium bicarbonate and alumina, other active stain-removing components such as surface-active agents, including, but not limited to anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. In some embodiments, dental care ingredients can also include tetrasodium pyrophosphate and sodium tri-polyphosphate, sodium bicarbonate, sodium acid pyrophosphate, sodium tripolyphosphate, xylitol, sodium hexametaphosphate.

In some embodiments, peroxides such as carbamide peroxide, calcium peroxide, magnesium peroxide, sodium peroxide, hydrogen peroxide, and peroxydiphospate are included. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Further examples can include surfactants such as sodium stearate, sodium ricinoleate, and sodium lauryl sulfate surfactants for use in some embodiments to achieve increased prophylactic action and to render the dental care ingredients more cosmetically acceptable. Surfactants can preferably be detersive materials which impart to the composition detersive and foaming properties. Suitable examples of surfactants are water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolamine salts of N-lauroyl, N-myristoyl, or N-palmitoyl sarcosine.

In addition to surfactants, dental care ingredients can include antibacterial agents such as, but not limited to, triclosan, chlorhexidine, zinc citrate, silver nitrate, copper, limonene, and cetyl pyridinium chloride. In some embodiments, additional anticaries agents can include fluoride ions or fluorine-providing components such as inorganic fluoride salts. In some embodiments, soluble alkali metal salts, for example, sodium fluoride, potassium fluoride, sodium fluorosilicate, ammonium fluorosilicate, sodium monofluorophosphate, as well as tin fluorides, such as stannous fluoride and stannous chloride can be included. In some embodiments, a fluorine-containing compound having a beneficial effect on the care and hygiene of the oral cavity, e.g., diminution of enamel solubility in acid and protection of the teeth against decay may also be included as an ingredient. Examples thereof include sodium fluoride, stannous fluoride, potassium fluoride, potassium stannous fluoride (SnF.sub.2-KF), sodium hexafluorostannate, stannous chlorofluoride, sodium fluorozirconate, and sodium monofluorophosphate. In some embodiments, urea is included.

Further examples are included in the following U.S. patents and U.S. published patent applications, the contents of all of which are incorporated in their entirety herein by reference for all purposes: U.S. Pat. No. 5,227,154 to Reynolds, U.S. Pat. No. 5,378,131 to Greenberg, U.S. Pat. No. 6,846,500 to Luo et al., U.S. Pat. No. 6,733,818 to Luo et al., U.S. Pat. No. 6,696,044 to Luo et al., U.S. Pat. No. 6,685,916 to Holme et al., U.S. Pat. No. 6,485,739 to Luo et al., U.S. Pat. No. 6,479,071 to Holme et al., U.S. Pat. No. 6,471,945 to Luo et al., U.S. Patent Publication Nos. 20050025721 to Holme et al., 2005008732 to Gebreselassie et al., and 20040136928 to Holme et al.

### Active Ingredients

Actives generally refer to those ingredients that are included in a delivery system and/or chewing gum composition for the desired end benefit they provide to the user. In some embodiments, actives can include medicaments, nutrients, nutraceuticals, herbals, nutritional supplements, pharmaceuticals, drugs, and the like and combinations thereof.

Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra™, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in the present invention can include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin™, ibuprofen, aspirin, acetaminophen, and combinations thereof that may optionally include caffeine.

Other drug active ingredients for use in embodiments can include anti-diarrheals such as Immodium™ AD, anti-histamines, anti-tussives, decongestants, vitamins, and breath fresheners. Also contemplated for use herein are anxiolytics such as Xanax™; anti-psychotics such as Clozaril™ and Haldol™; non-steroidal anti-inflammatories (NSAID's) such as ibuprofen, naproxen sodium, Voltaren™ and Lodine™, anti-histamines such as Claritin™, Hismanal™, Relafen™, and Tavist™; anti-emetics such as Kytril™ and Cesamet™; bronchodilators such as Bentolin™, Proventil™; anti-depressants such as Prozac™, Zoloft™, and Paxil™; anti-migraines such as Imigra™, ACE-inhibitors such as Vasotec™, Capoten™ and Zestril™; anti-Alzheimer's agents, such as Nicergoline™; and CaH-antagonists such as Procardia™, Adalat™, and Calan™.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients can include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of nutritional supplements may also be used as active ingredients including virtually any vitamin or mineral. For example, vitamin A, vitamin C, vitamin D, vitamin E, vitamin K, vitamin B₆, vitamin B₁₂, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, maybe used.

Examples of nutritional supplements that can be used as active ingredients are set forth in U.S. Patent Application Publication Nos. 2003/0157213 A1, 2003/0206993 and 2003/0099741 A1 which are incorporated in their entirety herein by reference for all purposes.

Various herbals may also be used as active ingredients such as those with various medicinal or dietary supplement properties. Herbals are generally aromatic plants or plant parts and or extracts thereof that can be used medicinally or for flavoring. Suitable herbals can be used singly or in various mixtures. Active ingredients derived from herbal or botanical sources are sometimes referred to as phytochemicals. Classes of phytochemicals include, but are not limited to, polyphenols, flavonoids, flavanols, flavonols, flavanones, isoflavanones, anthocyanins, catechins, and flavonones. Commonly used herbs include Echinacea, Goldenseal, Calendula, Rosemary, Thyme, Kava Kava, Aloe, Blood Root, Grapefruit Seed Extract, Black Cohosh, Ginseng, Guarana, Cranberry, Gingko Biloba, St. John's Wort, Evening Primrose Oil, Yohimbe Bark, Green Tea, Ma Huang, Maca, Bilberry, Lutein, and combinations thereof.

### Effervescing System Ingredients

An effervescent system may include one or more edible acids and one or more edible alkaline materials. The edible acid(s) and the edible alkaline material(s) may react together to generate effervescence.

In some embodiments, the alkaline material(s) may be selected from, but is not limited to, alkali metal carbonates, alkali metal bicarbonates, alkaline earth metal carbonates, alkaline earth metal bicarbonates, and combinations thereof. The edible acid(s) may be selected from, but is not limited to, citric acid, phosphoric acid, tartaric acid, malic acid, ascorbic acid, and combinations thereof. In some embodiments, an effervescing system may include one or more other ingredients such as, for example, carbon dioxide, oral care ingredients, flavorants, etc.

For examples of use of an effervescing system in a chewing gum, refer to U.S. Provisional Patent No. 60/618,222 filed Oct. 13, 2004, and entitled “Effervescent Pressed Gum Tablet Compositions,” the contents of which are incorporated herein by reference for all purposes. Other examples can be found in U.S. Pat. No. 6,235,318, the contents of which are incorporated herein by reference for all purposes.

### Appetite Suppressor Ingredients

Appetite suppressors can be ingredients such as fiber and protein that function to depress the desire to consume food. Appetite suppressors can also include benzphetamine, diethylpropion, mazindol, phendimetrazine, phentermine, hoodia (P57), Olibra,™ ephedra, caffeine and combinations thereof. Appetite suppressors are also known by the following trade names: Adipex,™ Adipost,™ Bontril™ PDM, Bontril™ Slow Release, Didrex,™ Fastin,™ Ionamin,™ Mazanor,™ Melfiat,™ Obenix,™ Phendiet,™ Phendiet-105,™ Phentercot,™ Phentride,™ Plegine,™ Prelu-2,™ Pro-Fast,™ PT 105,™ Sanorex,™ Tenuate,™ Sanorex,™ Tenuate,™ Tenuate Dospan,™ Tepanil Ten-Tab,™ Teramine,™ and Zantryl.™ These and other suitable appetite suppressors are further described in the following U.S. patents, all of which are incorporated in their entirety by reference hereto: U.S. Pat. No. 6,838,431 to Portman, U.S. Pat. No. 6,716,815 to Portman, U.S. Pat. No. 6,558,690 to Portman, U.S. Pat. No. 6,468,962 to Portman, U.S. Pat. No. 6,436,899 to Portman.

### Potentiator Ingredients

Potentiators can consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof can be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine(N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine(N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The sensation of warming or cooling effects may also be prolonged with the use of a hydrophobic sweetener as described in U.S. Patent Application Publication 2003/0072842 A1 which is incorporated in its entirety herein by reference. For example, such hydrophobic sweeteners include those of the formulae I-XI as set forth below:

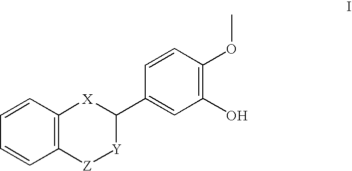

wherein X, Y and Z are selected from the group consisting of CH₂, O and S;

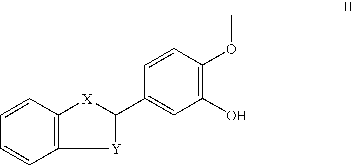

wherein X and Y are selected from the group consisting of S and O;

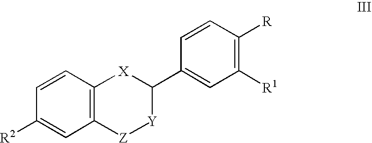

wherein X is S or O; Y is O or CH₂; Z is CH₂, SO₂ or S; R is OCH₃, OH or H; R¹ is SH or OH and R² is H or OH;

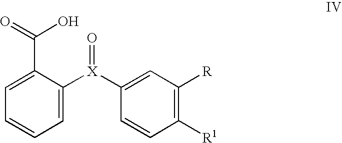

wherein X is C or S; R is OH or H and R¹ is OCH₃ or OH;

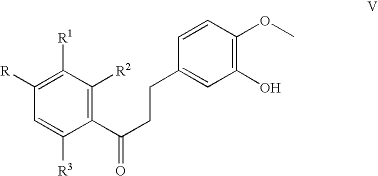

wherein R, R² and R³ are OH or H and R¹ is H or COOH;

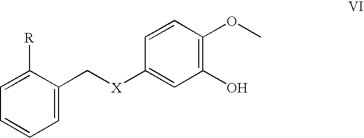

wherein X is O or CH₂ and R is COOH or H;

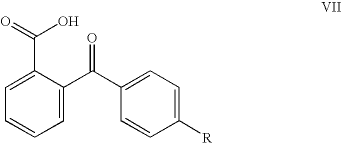

wherein R is CH₃CH₂, OH, N(CH3)₂ or Cl;

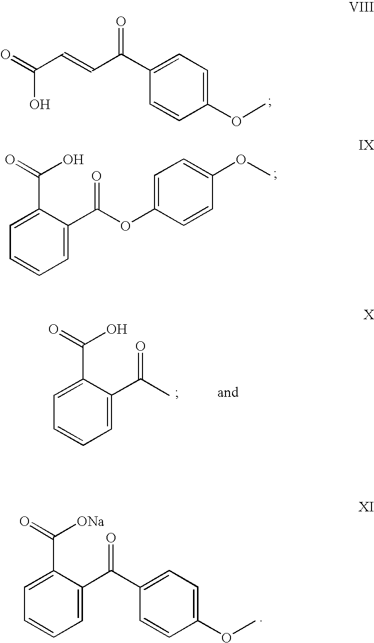

Perillartine may also be added as described in U.S. Pat. No. 6,159,509 also incorporated in its entirety herein by reference.

### Food Acid Ingredients

Acids can include, but are not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

### Micronutrient Ingredients

Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

In some embodiments, vitamins can include fat soluble vitamins such as vitamin A, vitamin D, vitamin E, and vitamin K and combinations thereof. In some embodiments, vitamins can include water soluble vitamins such as vitamin C (ascorbic acid), the B vitamins (thiamine or B₁, riboflavoin or B₂, niacin or B₃, pyridoxine or B₆, folic acid or B₉, cyanocobalimin or B₁₂, pantothenic acid, biotin), and combinations thereof.

In some embodiments minerals can include but are not limited to sodium, magnesium, chromium, iodine, iron, manganese, calcium, copper, fluoride, potassium, phosphorous, molybdenum, selenium, zinc, and combinations thereof.

In some embodiments micronutrients can include but are not limited to L-camitine, choline, coenzyme Q10, alpha-lipoic acid, omega-3-fatty acids, pepsin, phytase, trypsin, lipases, proteases, cellulases, and combinations thereof.

Antioxidants can include materials that scavenge free radicals. In some embodiments, antioxidants can include but are not limited to ascorbic acid, citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof.

In some embodiments phytochemicals can include but are not limited to cartotenoids, chlorophyll, chlorophyllin, fiber, flavanoids, anthocyanins, cyaniding, delphinidin, malvidin, pelargonidin, peonidin, petunidin, flavanols, catechin, epicatechin, epigallocatechin, epigallocatechingallate, theaflavins, thearubigins, proanthocyanins, flavonols, quercetin, kaempferol, myricetin, isorhamnetin, flavononeshesperetin, naringenin, eriodictyol, tangeretin, flavones, apigenin, luteolin, lignans, phytoestrogens, resveratrol, isoflavones, daidzein, genistein, glycitein, soy isoflavones, and combinations thereof.

### Mouth Moistening Ingredients

Mouth moisteners can include, but are not limited to, saliva stimulators such as acids and salts and combinations thereof. In some embodiments, acids can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

Mouth moisteners can also include hydrocolloid materials that hydrate and may adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. In some embodiments, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations can be included. In some embodiments, modified celluloses can be included such as microcrystalline cellulose, carboxymethlcellulose (CMC), methylcellulose (MC), hydroxypropylmethylcellulose (HPCM), and hydroxypropylcellulose (MPC), and combinations thereof.

Similarly, humectants which can provide a perception of mouth hydration can be included. Such humectants can include, but are not limited to glycerol, sorbitol, polyethylene glycol, erythritol, and xylitol. Additionally, in some embodiments, fats can provide a perception of mouth moistening. Such fats can include medium chain triglycerides, vegetable oils, fish oils, mineral oils, and combinations thereof.

### Throat Care Ingredients

Throat soothing ingredients can include analgesics, anesthetics, demulcents, antiseptic, and combinations thereof. In some embodiments, analgesics/anesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof. In some embodiments, antiseptic ingredients can include cetylpyridinium chloride, domiphen bromide, dequalinium chloride, and combinations thereof.

In some embodiments, antitussive ingredients such as chlophedianol hydrochloride, codeine, codeine phosphate, codeine sulfate, dextromethorphan, dextromethorphan hydrobromide, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other. embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In still other embodiments, antitussives can include, but are not limited to, the group consisting of codeine, dextromethorphan, dextrorphan, diphenhydramine, hydrocodone, noscapine, oxycodone, pentoxyverine and combinations thereof. In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxamine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcycsteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine and mixtures thereof. In some embodiments, local anesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof. In some embodiments ingredients that provide a perception of nasal clearing can include but are not limited to menthol, camphor, bomeol, ephedrine, eucalyptus oil, peppermint oil, methyl salicylate, bornyl acetate, lavender oil, wasabi extracts, horseradish extracts, and combinations thereof. In some embodiments, a perception of nasal clearing can be provided by odoriferous essential oils, extracts from woods, gums, flowers and other botanicals, resins, animal secretions, and synthetic aromatic materials.

In some embodiments, one or more colors can be included. As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or combinations thereof. In some embodiments, exempt from certification or natural colors can include, but are not limited to annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof.

In some embodiments, certified colors can include, but are not limited to, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and combinations thereof. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

### Multiple Ingredients

In some embodiments, a delivery system or chewing gum may include two or more ingredients for which managed release from the chewing gum during consumption of the chewing gum is desired. In some embodiments, the ingredients may be encapsulated or otherwise included separately in different delivery systems. Alternatively, in some embodiments the ingredients may be encapsulated or otherwise included in the same delivery system. As another possibility, one or more of the ingredients may be free (e.g., unencapsulated) while one or more other ingredients may be encapsulated.

A chewing gum may include a group of ingredients for which managed release of the group during consumption of the chewing gum is desired. Groups of two or more ingredients for which managed release from a chewing gum during consumption of the chewing gum may be desired include, but are not limited to: color and flavor, multiple flavors, multiple colors, cooling agent and flavor, warming agent and flavor, cooling agent and warming agent, cooling agent and high intensity sweetener, warming agent and high intensity sweetener, multiple cooling agents (e.g., WS-3 and WS-23, WS-3 and menthyl succinate), menthol and one or more cooling agents, menthol and one or more warming agents, multiple warming agents, high intensity sweetener(s) and tooth whitening active(s), high intensity sweetener(s) and breath freshening active(s), an ingredient with some bitterness and a bitterness suppressor for the ingredient, multiple high intensity sweeteners (e.g., ace-k and aspartame), multiple tooth whitening actives (e.g., an abrasive ingredient and an antimicrobial ingredient, a peroxide and a nitrate, a warming agent and a polyol, a cooling agent and a polyol, multiple polyols, a warming agent and micronutrient, a cooling agent and a micronutrient, a warming agent and a mouth moistening agent, a cooling agent and a mouth moistening agent, a warming agent and a throat care agent, a cooling agent and a throat care agent, a warming agent and a food acid, a cooling agent and food acid, a warming agent and an emulsifier/surfactant, a cooling agent and an emulsifier/surfactant, a warming agent and a color, a cooling agent and a color, a warming agent and a flavor potentiator, a cooling agent and a flavor potentiator, a warming agent with sweetness potentiator, a cooling agent with a sweetness potentiator, a warming agent and an appetite suppressant, a cooling agent and an appetite suppressant, a high intensity sweetener and a flavor, a cooling agent and a teeth whitening agent, a warming agent and a teeth whitening agent, a warming agent and breath freshening agent, a cooling agent and a breath freshening agent, a cooling agent and an effervescing system, a warming agent and an effervescing system, a warming agent and an antimicrobial agent, a cooling agent and an antimicrobial agent, multiple anticalculus ingredients, multiple remineralization ingredients, multiple surfactants, remineralization ingredients with demineralization ingredients, acidic ingredients with acid buffering ingredients, anticalculus ingredients with antibacterial ingredients, remineralization ingredients with anticalculus ingredients, anticalculus ingredients with remineralization ingredients with antibacterial ingredients, surfactant ingredients with anticalculus ingredients, surfactant ingredients with antibacterial ingredients, surfactant ingredients with remineralization ingredients, surfactants with anticalculus ingredients with antibacterial ingredients, multiple types of vitamins or minerals, multiple micronutrients, multiple acids, multiple antimicrobial ingredients, multiple breath freshening ingredients, breath freshening ingredients and antimicrobial ingredients, multiple appetite suppressors, acids and bases that react to effervesce, a bitter compound with a high intensity sweetener, a cooling agent and an appetite suppressant, a warming agent and an appetite suppressant, a high intensity sweetener and an appetite suppressant, a high intensity sweetener with an acid, a probiotic ingredient and a prebiotic ingredient, a vitamin and a mineral, a metabolic enhancement ingredient with a macronutrient, a metabolic enhancement ingredient with a micronutrient, an enzyme with a substrate, a high intensity sweetener with a sweetness potentiator, a cooling compound with a cooling potentiator, a flavor with a flavor potentiator, a warming compound with a warming potentiator, a flavor with salt, a high intensity sweetener with salt, an acid with salt, a cooling compound with salt, a warming compound with salt, a flavor with a surfactant, an astringent compound with an ingredient to provide a sensation of hydration, etc. In some embodiments, the multiple ingredients may be part of the same delivery system or may be part of different delivery systems. Different delivery systems may use the same or different encapsulating materials.

Typically, encapsulation of the multiple ingredients will result in a delay in the release of the predominant amount of the multiple ingredients during consumption of a chewing gum that includes the encapsulated multiple ingredients (e.g., as part of a delivery system added as an ingredient to the chewing gum). This may be particularly helpful in situations wherein separate encapsulation of the ingredients may cause them to release with different release profiles. For example, different high intensity sweeteners may have different release profiles because they have different water solubilities or differences in other characteristics. Encapsulating them together may cause them to release more simultaneously.

In some embodiments, the release profile of the multiple ingredients can be managed for a gum by managing various characteristics of the multiple ingredients, the delivery system containing the multiple ingredients, and/or the chewing gum containing the delivery system and/or how the delivery system is made in a manner as previously discussed above.

The features and advantages of the present invention are more fully shown by the following examples which are provided for purposes of illustration, and are not to be construed as limiting the invention in any way.

### EXAMPLES

### Examples 1-78

The following examples 1-78 include a variety of modified release components, which may be selected for use in creating the dualities discussed herein. These components may be used in any region of the center-fill gum compositions. For instance, Example 2 provides encapsulated xylitol. The encapsulated sweetener xylitol of Example 2 could be added to one region of a center-fill gum and a sour agent, such as an acid, could be added to another region of the gum to create a flavor duality based on distinct tastants. The encapsulated adipic acid of Example 4 could also be employed.

Moreover, any of the encapsulated components provided in Examples 1-78 could be selected and combined with an encapsulated and/or unencapsulated component that is distinct from, complementary to or different in intensity from the exemplary component. For example, the encapsulated WS-3 (cooling agent) of Example 12 could be added to one region of a center-fill gum and an encapsulated and/or unencapsulated tingling agent could be added to another region of the gum to create a duality based on distinct sensates. Alternatively, the encapsulated WS-3 of Example 12 could be added to one region of a center-fill gum and encapsulated and/or unencapsulated menthol (another cooling agent) could be added to another region to create a duality based on complementary components. In another embodiment, a first portion of the encapsulated WS-3 of Example 12 could be added to one region of a center-fill gum and another portion of WS-3, which is different in intensity could be added to another region of the gum. The second portion of WS-3 could be encapsulated and/or unencapsulated.

A variety of other combinations using the modified release components set forth in Examples 1-78 may be employed, such as other distinct dualities, complementary dualities or dualities between different intensities of the same encapsulated component.

To exemplify the use of the modified release components of Examples 1-78 in multi-modality gum compositions, Examples 79-95 incorporate a number of these components into different regions of a center-fill gum in combination with other components that create dual perceptions. More specifically, Examples 79-92 provide center-fill gum compositions having solid center regions. The center-fill gum compositions incorporate a number of the encapsulated components of Examples 1-78 to provide different dualities. Examples 93-96 provide center-fill gum compositions having liquid center regions. These gum compositions also incorporate a number of the encapsulated components of Examples 1-78 to provide different dualities.

### Ingredient Examples

### Ingredient Examples of Single Ingredients in a Delivery System.

EXAMPLE 1
Encapsulation of Glycyrrhizin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Glycyrrhizin | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Glycyrrhizin is then added to the resulting mixture and mixed under high shear to completely disperse the ingredients. The resulting filled polymer melt is cooled and ground to produce a powdered material with a particle size of less than 420 microns. The encapsulated Glycyrrhizin matrix is stored in air tight containers with low humidity below 35° C.

EXAMPLE 2
Encapsulation of Xylitol - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Xylitol | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Xylitol is then added to the resulting mixture and mixed under high shear to completely disperse the ingredients. The resulting filled polymer melt is cooled and ground to produce a powdered material with a particle size of less than 420 microns. The encapsulated xylitol matrix is stored in air tight containers with low humidity below 35° C.

EXAMPLE 3
Encapsulation of Erythritol

| Composition: | |
|---|---|
| Ingredient | Weight percent |
| Polyvinyl Acetate | 55.00% |
| Hydrogenated Oil | 3.75% |
| Glycerol Monostearate | 1.25% |
| Erythritol | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Erythritol are then added to the resulting mixture and mixed under high shear to completely disperse the ingredients. The resulting filled polymer melt is cooled and ground to produce a powdered material with a particle size of less than 420 microns. The erythritol encapsulation matrix is stored in air tight containers with low humidity below 35° C.

EXAMPLE 4
Encapsulation of Adipic acid - Polyvinyl acetate matrix

| Composition: | |
|---|---|
| Ingredient | Weight percent |
| Polyvinyl Acetate | 60.00% |
| Hydrogenated Oil | 3.75% |
| Glycerol Monostearate | 1.25% |
| Adipic acid | 35.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Adipic acid is then added to the resulting mixture and mixed under high shear to completely disperse the ingredients. The resulting filled polymer melt is cooled and ground to produce a powdered material with a particle size of less than 420 microns. The encapsulated adipic acid matrix is stored in air tight containers with low humidity below 35° C.

EXAMPLE 5
Encapsulation of Citric Acid - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Citric Acid | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Citric acid is then added to the resulting mixture and mixed under high shear to completely disperse the ingredients. The resulting filled polymer melt is cooled and ground to produce a powdered material with a particle size of less than 420 microns. The encapsulated citric acid matrix is stored in air tight containers with low humidity below 35° C.

EXAMPLE 6
Encapsulation of Malic acid - Polyvinyl acetate.

| Composition: | |
|---|---|
| Ingredient | Weight percent |
| Polyvinyl Acetate | 55.00% |
| Hydrogenated Oil | 3.75% |
| Glycerol Monostearate | 1.25% |
| Malic acid | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Malic acid are then added to the resulting mixture and mixed under high shear to completely disperse the ingredients. The resulting filled polymer melt is cooled and ground to produce a powdered material with a particle size of less than 420 microns. The malic acid encapsulation matrix is stored in air tight containers with low humidity below 35° C.

EXAMPLE 7
Encapsulation of Spray dried peppermint flavor - Polyvinyl acetate

| Composition: | |
|---|---|
| Ingredient | Weight percent |
| Polyvinyl Acetate | 75.00% |
| Hydrogenated Oil | 3.75% |
| Glycerol Monostearate | 1.25% |
| Spray dried peppermint flavor | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Spray dried peppermint flavor is then added to the resulting mixture and mixed under high shear to completely disperse the ingredients. The resulting filled polymer melt is cooled and ground to produce a powdered material with a particle size of less than 420 microns. The encapsulated peppermint flavor in Polyvinyl acetate matrix is stored in air tight containers with low humidity below 35° C.

EXAMPLE 8
Encapsulation of Spray dried strawberry flavor - Polyvinyl acetate

| Composition: | |
|---|---|
| Ingredient | Weight percent |
| Polyvinyl Acetate | 55.00% |
| Hydrogenated Oil | 3.75% |
| Glycerol Monostearate | 1.25% |
| Spray dried strawberry flavor | 40.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Spray dried strawberry flavor is then added to the resulting mixture and mixed under high shear to completely disperse the ingredients. The resulting filled polymer melt is cooled and ground to produce a powdered material with a particle size of less than 420 microns. The encapsulated strawberry flavor is stored in air tight containers with low humidity below 35° C.

EXAMPLE 9
Encapsulation of Monosodium Glutamate

| Composition: | |
|---|---|
| Ingredient | Weight percent |
| Polyvinyl Acetate | 55.00% |
| Hydrogenated Oil | 3.75% |
| Glycerol Monostearate | 1.25% |
| Monosodium glutamate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Monosodium glutamate is then added to the resulting mixture and mixed under high shear to completely disperse the ingredients. The resulting filled polymer melt is cooled and ground to produce a powdered material with a particle size of less than 420 microns. The encapsulation matrix is stored in air tight containers with low humidity below 35° C.

EXAMPLE 10
Encapsulation of Salt - Polyvinyl acetate matrix

| Composition: | |
|---|---|
| Ingredient | Weight percent |
| Polyvinyl Acetate | 60.00% |
| Hydrogenated Oil | 3.75% |
| Glycerol Monostearate | 1.25% |
| Sodium chloride | 35.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium chloride is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 11
Encapsulation of Sodium acid sulfate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium acid sulfate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium acid sulfate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 12
Encapsulation of WS-3 in Polyvinyl acetate.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-3 | 30.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. WS-3 is then added to the resulting mixture and mixed under high shear to completely disperse the ingredients. The resulting encapsulation is cooled and ground to produce a powdered material with a particle size of less than 420 microns. The malic acid encapsulation matrix is stored in air tight containers with low humidity below 35° C.

EXAMPLE 13
Encapsulation of WS-23 - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-23 | 30.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. WS-23 is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 14
Encapsulation of menthol - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Menthol | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Menthol crystals is then added to the resulting mixture and mixed under high shear to completely disperse the ingredients. The resulting polymer melt is cooled and ground to produce a powdered material with a particle size of less than 420 microns. The encapsulated menthol matrix is stored in air tight containers with low humidity below 35° C.

EXAMPLE 15
Encapsulation of Caffeine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Caffeine | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Caffeine is then added to the resulting mixture and mixed under high shear to completely disperse the ingredients. The resulting polymer melt is cooled and ground to produce a powdered material with a particle size of less than 420 microns. The encapsulated caffeine matrix is stored in air tight containers with low humidity below 35° C.

EXAMPLE 16
Encapsulation of Ascorbic Acid - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Ascorbic Acid | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Ascorbic Acid is then added to the resulting mixture and mixed under high shear to completely disperse the ingredients. The resulting polymer melt is cooled and ground to produce a powdered material with a particle size of less than 420 microns. The encapsulated Ascorbic Acid matrix is stored in air tight containers with low humidity below 35° C.

EXAMPLE 17
Encapsulation of Calcium Lactate - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Calcium Lactate | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Calcium Lactate is then added to the resulting mixture and mixed under high shear to completely disperse the ingredients. The resulting polymer melt is cooled and ground to produce a powdered material with a particle size of less than 420 microns. The encapsulated Calcium Lactate matrix is stored in air tight containers with low humidity below 35° C.

EXAMPLE 18
Encapsulation of Zinc Citrate - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Zinc Citrate | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Zinc Citrate is then added to the resulting mixture and mixed under high shear to completely disperse the ingredients. The resulting polymer melt is cooled and ground to produce a powdered material with a particle size of less than 420 microns. The encapsulated Zinc Citrate matrix is stored in air tight containers with low humidity below 35° C.

EXAMPLE 19
Encapsulation of Niacin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Niacin | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Niacin is then added to the resulting mixture and mixed under high shear to completely disperse the ingredients. The resulting polymer melt is cooled and ground to produce a powdered material with a particle size of less than 420 microns. The encapsulated Niacin matrix is stored in air tight containers with low humidity below 35° C.

EXAMPLE 20
Encapsulation of Pyridoxine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Pyridoxine | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Pyridoxine is then added to the resulting mixture and mixed under high shear to completely disperse the ingredients. The resulting polymer melt is cooled and ground to produce a powdered material with a particle size of less than 420 microns. The encapsulated Pyridoxine matrix is stored in air tight containers with low humidity below 35° C.

EXAMPLE 21
Encapsulation of Thiamine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Thiamine | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Thiamine is then added to the resulting mixture and mixed under high shear to completely disperse the ingredients. The resulting polymer melt is cooled and ground to produce a powdered material with a particle size of less than 420 microns. The encapsulated Thiamine matrix is stored in air tight containers with low humidity below 35° C.

EXAMPLE 22
Encapsulation of Riboflavin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Riboflavin | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Riboflavin is then added to the resulting mixture and mixed under high shear to completely disperse the ingredients. The resulting polymer melt is cooled and ground to produce a powdered material with a particle size of less than 420 microns. The encapsulated Riboflavin matrix is stored in air tight containers with low humidity below 35° C.

EXAMPLE 23
Encapsulation of Sucralose - Polyvinyl acetate matrix (Sucralose 20%).

| Composition: | |
|---|---|
| Ingredient | Weight percent |
| Polyvinyl Acetate | 77.00% |
| Hydrogenated Oil | 3.00% |
| Sucralose | 20.00% |
| Total | 100.00% |

Procedure: Polyvinyl acetate is melted at a temperature of about 85° C. in a high shear mixer such as extruder (single or twin screw) or sigma or Banbury mixer. The hydrogenated oil is added to the molten polyvinyl acetate. Sucralose is then added to the resulting mixture and mixed under high shear to completely disperse the ingredients. The resulting filled polymer melt is cooled and ground to produce a powdered material with a particle size of less than 590 microns. The encapsulated sucralose matrix is stored in air tight containers with low humidity below 35° C.

EXAMPLE 24
Multiple encapsulation of sucralose/polyvinyl acetate matrix
(from example 23).

| Composition: | |
|---|---|
| Ingredient | Grams |
| Center Cores | |
| Sucralose/Polymer Matrix (from Example 23) | 700.0 |
| Coating Solution | |
| Purified Water | 1168.0 |
| Gum Arabic | 293.0 |
| Total Coating solution | 1461.0 |

Procedure: Wurster process is used to encapsulate Sucralose/Polymer Matrix. Coating solution using the above mentioned recipe is prepared by stirring water and gum at 35° C. for 2 hrs. 700 gms of Sucralose//Polymer Matrix are suspended in a fluidizing air stream which provide generally cyclic flow in front of a spray nozzle. The spray nozzle sprays an atomized flow of 1461 gms of the coating solution for 115 minutes. The coated particles are then dried in the fluidized chamber for 50 minutes and stored below 35° C. under dry conditions.

EXAMPLE 25 A
High Tensile strength encapsulation of Aspartame - Polyvinyl acetate
matrix (Aspartame 30%). Particle size less than 420 microns.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting high tensile strength/low fat content encapsulation is cooled and ground to produce a powdered material with a particle size of less than 420 microns.

EXAMPLE 25 B
Low Tensile Strength encapsulation of Aspartame - Polyvinyl acetate
matrix (Aspartame 30%)

| Composition: | |
|---|---|
| Ingredient | Weight percent |
| Polyvinyl Acetate | 50.00% |
| Hydrogenated Oil | 10.00% |
| Glycerol Monostearate | 10.00% |
| Aspartame | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting low Tensile Strength encapsulation is cooled and ground to produce a powdered material with a particle size of less than 420 microns.

EXAMPLE 25 C
High Tensile strength encapsulation of Aspartame - Polyvinyl acetate
matrix (Aspartame 30%). Particle size less than 177 microns.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting high tensile strength/low fat content encapsulation is cooled and ground to produce a powdered material with a particle size of less than 177 microns.

EXAMPLE 26
Encapsulation of AceK - Polyvinyl acetate matrix (AceK 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| AceK | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. AceK is then added to the resulting mixture and mixed under high shear to completely disperse the ingredients. The resulting filled polymer melt is cooled and ground to produce a powdered material with a particle size of less than 420 microns. The encapsulated AceK matrix is stored in air tight containers with low humidity below 35° C.

EXAMPLE 27
Encapsulation of Neotame - Polyvinyl acetate matrix (Neotame 10%)

| Composition: | |
|---|---|
| Ingredient | Weight percent |
| Polyvinyl Acetate | 75.00% |
| Hydrogenated Oil | 10.00% |
| Glycerol Monostearate | 5.00% |
| Neotame | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Neotame is then added to the resulting mixture and mixed under high shear to completely disperse the ingredients. The resulting filled polymer melt is cooled and ground to produce a powdered material with a particle size of less than 420 microns. The encapsulated Neotame polymer encapsulation particles are stored in air tight containers with low humidity below 35° C.

EXAMPLE 28
Encapsulation of Pectin in Polyvinyl acetate matrix (Pectin 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Pectin | 30.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Pectin is then added to the resulting mixture and mixed under high shear to completely disperse the ingredients. The resulting filled polymer melt is cooled and ground to produce a powdered material with a particle size of less than 420 microns. The encapsulated pectin polymer encapsulation particles are stored in air tight containers with low humidity below 35° C.

### Ingredient Examples of Multiple Ingredients in a Delivery System.

EXAMPLE 29
Encapsulation of Aspartame, Ace-K, and Sucralose

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| AceK | 10.00% |
| Sucralose | 10.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame, Ace-K, and Sucralose are then added to the resulting mixture and mixed under high shear to completely disperse the ingredients. The resulting filled polymer melt is cooled and ground to produce a powdered material with a particle size of less than 420 microns. The encapsulated sweeteners are stored in air tight containers with low humidity below 35° C.

EXAMPLE 30
Encapsulation of Aspartame, Ace-K, and Glycyrrhizin

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Ace-K | 10.00% |
| Glycyrrhizin | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Glycyrrhizin are then added to the resulting mixture and mixed under high shear to completely disperse the ingredients. The resulting filled polymer melt is cooled and ground to produce a powdered material with a particle size of less than 420 microns. The encapsulated sweeteners are stored in air tight containers with low humidity below 35° C.

EXAMPLE 31
Encapsulation of Aspartame, Ace-K, and Menthol

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Ace-K | 10.00% |
| Menthol | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Menthol are then added to the resulting mixture and mixed under high shear to completely disperse the ingredients. The resulting filled polymer melt is cooled and ground to produce a powdered material with a particle size of less than 420 microns. The encapsulated sweeteners are stored in air tight containers with low humidity below 35° C.

EXAMPLE 32
Encapsulation of Aspartame, Ace-K, and Adipic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 10.00% |
| Ace-K | 5.00% |
| Adipic acid | 25.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Adipic Acid are then added to the resulting mixture and mixed under high shear to completely disperse the ingredients. The resulting filled polymer melt is cooled and ground to produce a powdered material with a particle size of less than 420 microns. The encapsulated sweeteners are stored in air tight containers with low humidity below 35° C.

EXAMPLE 33
Encapsulation of Adipic, Citric, and Malic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Adipic Acid | 10.00% |
| Citric Acid | 20.00% |
| Malic Acid | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Adipic, Citric, and Malic Acid are then added to the resulting mixture and mixed under high shear to completely disperse the ingredients. The resulting filled polymer melt is cooled and ground to produce a powdered material with a particle size of less than 420 microns. The encapsulated acids are stored in air tight containers with low humidity below 35° C.

EXAMPLE 34
Encapsulation of Sucralose, and Citric Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sucralose | 10.00% |
| Citric Acid | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and Citric Acid are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 35
Encapsulation of Sucralose and Adipic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sucralose | 10.00% |
| Adipic Acid | 30.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Adipic Acid are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 36
Encapsulation of Aspartame and Salt

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Salt | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Salt are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 37
Encapsulation of Aspartame with WS-3

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 20.00% |
| WS-3 | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame and WS-3 are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 38
Encapsulation of Sucralose with WS-23

| Composition: | |
|---|---|
| Ingredient | Weight percent |
| Polyvinyl Acetate | 75.00% |
| Hydrogenated Oil | 3.75% |
| Glycerol Monostearate | 1.25% |
| Sucralose | 10.00% |
| WS-23 | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and WS-23 are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 39
Encapsulation of Sucralose and Menthol

| Composition: | |
|---|---|
| Ingredient | Weight percent |
| Polyvinyl Acetate | 70.00% |
| Hydrogenated Oil | 3.75% |
| Glycerol Monostearate | 1.25% |
| Sucralose | 10.00% |
| Menthol | 15.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and Menthol are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 40
Encapsulation of Aspartame and Neotame

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 30.00% |
| Neotame | 5.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and Neotame are then added to the resulting mixture and mixed under high shear to completely disperse the ingredients. The resulting encapsulation is cooled and ground to produce a powdered material with a particle size of less than 420 microns. The encapsulation matrix is stored in air tight containers with low humidity below 35° C.

EXAMPLE 41
Encapsulation of Aspartame and Adenosine monophosphate (bitterness
inhibitor)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 20.00% |
| Adenosine monophosphate (AMP) | 10.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and AMP are then added to the resulting mixture and mixed under high shear to completely disperse the ingredients. The resulting filled polymer melt is cooled and ground to produce a powdered material with a particle size of less than 420 microns. The encapsulation is stored in air tight containers with low humidity below 35° C.

EXAMPLE 42
Encapsulation of Aspartame and Caffeine

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Caffeine | 15.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Caffeine are then added to the resulting mixture and mixed under high shear to completely disperse the ingredients. The resulting polymer melt is cooled and ground to produce a powdered material with a particle size of less than 420 microns. The encapsulation is stored in air tight containers with low humidity below 35° C.

EXAMPLE 43
Encapsulation of sucralose and Calcium Lactate

| Composition: | |
|---|---|
| Ingredient | Weight percent |
| Polyvinyl Acetate | 55.00% |
| Hydrogenated Oil | 3.75% |
| Glycerol Monostearate | 1.25% |
| sucralose | 10.00% |
| Calcium Lactate | 30.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Calcium Lactate are then added to the resulting mixture and mixed under high shear to completely disperse the ingredients. The resulting polymer melt is cooled and ground to produce a powdered material with a particle size of less than 420 microns. The encapsulation is stored in air tight containers with low humidity below 35° C.

EXAMPLE 44
Encapsulation of Sucralose and Vitamin C

| Composition: | |
|---|---|
| Ingredient | Weight percent |
| Polyvinyl Acetate | 65.00% |
| Hydrogenated Oil | 3.75% |
| Glycerol Monostearate | 1.25% |
| Sucralose | 10.00% |
| Ascorbic Acid (Vitamin C) | 20.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Ascorbic Acid is then added to the resulting mixture and mixed under high shear to completely disperse the ingredients. The resulting polymer melt is cooled and ground to produce a powdered material with a particle size of less than 420 microns. The encapsulation is stored in air tight containers with low humidity below 35° C.

EXAMPLE 45
Encapsulation of Aspartame and Niacin

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 15.00% |
| Niacin | 15.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Niacin are then added to the resulting mixture and mixed under high shear to completely disperse the ingredients. The resulting polymer melt is cooled and ground to produce a powdered material with a particle size of less than 420 microns. The encapsulation is stored in air tight containers with low humidity below 35° C.

EXAMPLE 46
Encapsulation of sucralose and Folic Acid

| Composition: | |
|---|---|
| Ingredient | Weight percent |
| Polyvinyl Acetate | 75.00% |
| Hydrogenated Oil | 3.75% |
| Glycerol Monostearate | 1.25% |
| Sucralose | 10.00% |
| Folic Acid | 10.00% |
| Total | 100.00% |

Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Folic Acid are then added to the resulting mixture and mixed under high shear to completely disperse the ingredients. The resulting polymer melt is cooled and ground to produce a powdered material with a particle size of less than 420 microns. The encapsulation is stored in air tight containers with low humidity below 35° C.

EXAMPLE 47
Encapsulation of mixed Aspartame and AceK - Polyvinyl
acetate matrix (Actives = 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 21.00% |
| AceK | 9.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame and AceK (60/40) are then added to the resulting mixture and mixed under high shear to completely disperse the ingredients. The resulting filled polymer melt is cooled and ground to produce a powdered material with a particle size of less than 420 microns. The mixed Aspartame and AceK encapsulation matrix is stored in air tight containers with low humidity below 35° C.

EXAMPLE 48
Encapsulation of mixed WS-3 and WS-23 - Polyvinyl acetate matrix.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-3 | 15.00% |
| Cooling sensate WS-23 | 15.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. WS-3 and WS-23 are then added to the resulting mixture and mixed under high shear to completely disperse the ingredients. The resulting filled polymer melt is cooled and ground to produce a powdered material with a particle size of less than 420 microns. The mixed WS-3 and WS-23 encapsulation matrix is stored in air tight containers with low humidity below 35° C.

EXAMPLE 49
Encapsulation of mixed Aspartame and Calciumcarbonate -
Polyvinyl acetate matrix.

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Calciumcarbonate | 15.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and calcium carbonate are then added to the resulting mixture and mixed under high shear to completely disperse the ingredients. The resulting filled polymer melt is cooled and ground to produce a powdered material with a particle size of less than 420 microns. The mixed aspartame and calcium carbonate encapsulation matrix is stored in air tight containers with low humidity below 35° C.

EXAMPLE 50
Encapsulation of mixed Aspartame and Talc - Polyvinyl
acetate matrix.

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Talc | 15.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and talc are then added to the resulting mixture and mixed under high shear to completely disperse the ingredients. The resulting filled polymer melt is cooled and ground to produce a powdered material with a particle size of less than 420 microns. The mixed aspartame and talc encapsulation matrix is stored in air tight containers with low humidity below 35° C.

### Ingredient Examples of Single Oral Care Ingredients in a Delivery System.

EXAMPLE 51
Encapsulation of Sodium tripolyphosphate (Sodiumtripolyphosphate) -
Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodiumtripolyphosphate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumtripolyphosphate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 52
Encapsulation of Sodium Fluoride (NaF) - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Sodium Fluoride | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. NaF is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 53
Encapsulation of Calcium peroxide - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Calcium Peroxide | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Calcium peroxide is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 54
Encapsulation of Zinc Chloride - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Zinc Chloride | 30.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. zinc chloride is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 55
Encapsulation of Carbamide peroxide - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Carbamide Peroxide | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Carbamide peroxide is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 56
Encapsulation of Potassium Nitrate (KNO3) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Potassium Nitrate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. KNO3 is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 57
Encapsulation of Chlorhexidine - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Chlorhexidine | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Chlorhexidine is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 58
Encapsulation of sodium stearate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium stearate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium stearate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 59
Encapsulation of Sodium Bicarbonate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Bicarbonate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. NaHCO3 is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 60
Encapsulation of Cetylpridinium chloride (CPC) -
Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Cetylpridinium chloride | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. CPC is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 61
Encapsulation of Calcium Casein Peptone-Calcium Phosphate
CCP-CP (Recaldent) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Recaldent | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Recaldent is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 62
Encapsulation of sodium Ricinoleate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Ricinoleate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium ricinoleate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 63
Encapsulation of sodium hexametaphosphate
(Sodiumhexamataphosphate) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Hexametaphosphate | 40.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumhexamataphosphate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 64
Encapsulation of Urea - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Urea | 40.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Urea is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

### Ingredient Examples of Multiple Oral Care Ingredients in a Delivery System.

EXAMPLE 65
Encapsulation of Sodiumtripolyphosphate (STP) and sodium
stearate - Polyvinyl acetate matrix.

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodiumtripolyphosphate | 20.00% |
| Sodium stearate | 10.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 66
Encapsulation of Sodium Fluoride and
Sodiumtripolyphosphate - Polyvinyl acetate matrix

| Composition: | Weight |
|---|---|
| Ingredient | percent |
| Polyvinyl Acetate | 57.00% |
| Hydrogenated Oil | 3.75% |
| Glycerol Monostearate | 1.25% |
| Sodiumtripolyphosphate | 25.00% |
| Sodium Fluoride | 3.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 67
Encapsulation of Calcium peroxide and
Sodiumhexamataphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Calcium Peroxide | 7.00% |
| Sodiumhexamataphosphate | 23.00% |
| Sucralose | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 68
Encapsulation of Zinc Chloride and Sodiumtripolyphosphate -
Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Zinc Chloride | 4.00% |
| Sodiumtripolyphosphate | 26.00% |
| Aspartame | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 69
Encapsulation of Carbamide peroxide and
Sodiumtripolyphosphate in Polyvinylacetate encapsulation.

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodiumtripolyphosphate | 20.00% |
| Carbamide Peroxide | 10.00% |
| Sucralose | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 70
Encapsulation of Potassium Nitrate (KNO3) and
Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Potassium Nitrate | 10.00% |
| Sodiumtripolyphosphate | 20.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 71
Encapsulation of Chlorhexidine, Sodiumtripolyphosphate
and Sodium Fluoride - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Chlorhexidine | 4.00% |
| Sodiumtripolyphosphate | 23.00% |
| Sodium Fluoride | 3.00% |
| Aspartame | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 72
Encapsulation of sodium stearate, Sodiumtripolyphosphate
and Menthol-Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium stearate | 4.00% |
| Sodiumtripolyphosphate | 19.00% |
| Menthol | 7.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 73
Encapsulation of Sodium Bicarbonate, Sodiumtripolyphosphate and
Sodium stearate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium stearate | 4.00% |
| Sodiumtripolyphosphate | 19.00% |
| Sodium bicarbonate | 7.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 74
Encapsulation of Cetylpridinium chloride (CPC), Sodium Fluoride
and Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Cetylpridinium chloride | 4.00% |
| Sodiumtripolyphosphate | 23.00% |
| Sodium Fluoride | 3.00% |
| Sucralose | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 75
Encapsulation of Calcium Casein Peptone-Calcium Phosphate CCP-CP
(Recaldent) and Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Recaldent | 10.00% |
| Sodiumtripolyphosphate | 20.00% |
| Sucralose | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 76
Encapsulation of sodium Ricinoleate and Sodiumtripolyphosphate-
Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium Ricinoleate | 4.00% |
| Sodiumtripolyphosphate | 26.00% |
| Aspartame | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 77
Encapsulation of sodium hexametaphosphate (SHMP) and
Sodium Stearate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium Hexametaphosphate | 26.00% |
| Sodium stearate | 4.00% |
| Sucralose | 10.00% |
| Total | 100.00% |

Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumhexamataphosphate is then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

EXAMPLE 78
Encapsulation of Urea and Sodiumtripolyphosphate -
Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Urea | 10.00% |
| Sodiumtripolyphosphate | 20.00% |
| Sucralose | 10.00% |
| Total | 100.00% |

Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a particle size of less than 420 microns. The encapsulated matrix is stored in air tight containers with low humidity below 35° C.

### Examples 79-92

As mentioned above, Examples 79-92 provide multi-modality gum compositions, which are center-fill gums having solid center regions. Different types of dualities are exemplified in these solid center-fill gum compositions. The multi-modality gum compositions of Examples 79-92 incorporate a number of the encapsulated components from Examples 1-78 to provide different dualities in the compositions.

### Examples of Multi-Modality Gums with Solid Center-Fills

### Cooling in Gum Portion and Warming in Gelatin Bead Center

EXAMPLE 79

| | |
|---|---|
| Ingredient | Weight percent |

Chewing gum composition containing Encapsulated Menthol

| | |
|---|---|
| Gum Base | 39.00 |
| Sorbitol | 43.18 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Menthol (from Example 14) | 3.00 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Gelatin bead center fill composition with warming

| | |
|---|---|
| Capsule Film Material: | |
| Gelatin | 15.00 |
| Water | 80.00 |
| Glycerin | 5.00 |
| Total | 100.00 |
| Capsule Filler Material: | |
| Flavor | 35.00 |
| Vegetable Oil | 35.00 |
| Sugar | 29.95 |
| Capsaicin | 0.05 |
| Total | 100.00 |

Procedure: As described in U.S. Pat. No. 4,426,337, gelatin beads can be
prepared by mixing the capsule-film solution in one tank and mixing the
capsule filler material in a second tank. Using equipment with
concentrically aligned coaxial conduits, the capsule-film material is fed
through an outer conduit while the capsule filler material is fed through the
center conduit and both conduits feed the materials into a cooling liquid
where the final capsules are formed. The conduit flow rates are configured
to create a finished capsule with 80% filler material and 20% capsule
film material.
The gelatin beads are introduced into the center region of the chewing gum
by feeding them through the innermost nozzle of a multiple extruder. The
beads are metered through the nozzle to provide a finished product with
20% center fill material.

### Warming in Gum Portion and Cooling in Gelatin Bead Center

EXAMPLE 80

| | |
|---|---|
| Ingredient | Weight percent |

Chewing gum composition containing Capsaicin

| | |
|---|---|
| Gum Base | 39.00 |
| Sorbitol | 46.08 |
| Mannitol | 9.00 |
| Flavor | 3.67 |
| Glycerin | 1.50 |
| Lecithin | 0.20 |
| Aspartame | 0.30 |
| AceK | 0.15 |
| Capsaicin | 0.10 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Gelatin bead center fill composition with menthol

| | |
|---|---|
| Capsule Film Material: | |
| Gelatin | 15.00 |
| Water | 80.00 |
| Glycerin | 5.00 |
| Total | 100.00 |
| Capsule Filler Material: | |
| Flavor | 35.00 |
| Vegetable Oil | 35.00 |
| Sugar | 29.40 |
| Menthol | 0.60 |
| Total | 100.00 |

Procedure: As described in U.S. Pat. No. 4,426,337, gelatin beads can
be prepared by mixing the capsule-film solution in one tank and mixing
the capsule filler material in a second tank. Using equipment with
concentrically aligned coaxial conduits, the capsule-film material is fed
through an outer conduit while the capsule filler material is fed through
the center conduit and both conduits feed the materials into a cooling
liquid where the final capsules are formed. The conduit flow rates are
configured to create a finished capsule with 80% filler material and
20% capsule film material.
The gelatin beads are introduced into the center region of the chewing gum
by feeding them through the innermost nozzle of a multiple extruder. The
beads are metered through the nozzle to provide a finished product with
20% center fill material.

### Spice Flavor in Chewing Gum Portion and Indulgent Flavor in Milk Chocolate Center

EXAMPLE 81

| | |
|---|---|
| Composition: | |
| Ingredient | Weight percent |

Cinnamon Chewing gum composition containing multiple
encapsulated Sucralose/polyvinyl acetate matrix (from
example 24). (Slowest release sucralose gum).

| | |
|---|---|
| Gum Base | 36.00 |
| Sorbitol | 58.10 |
| Glycerin | 1.00 |
| Cinnamon Flavor | 1.90 |
| Sucralose | 0.15 |
| Sucralose/polyvinyl acetate matrix | 2.85 |
| (from example 24) | |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Milk Chocolate center

| | |
|---|---|
| Milk Crumb: | |
| Cocoa liquor | 13.50 |
| Sugar | 53.50 |
| Milk solids | 32.00 |

The milk solids and sugar are kneaded together with the cocoa liquor such
that controlled crystallization can occur. The crumb is then dried to the
desired final moisture content. Drying can involve vacuum drying alone or
drying can occur in combination with drum driers.

| | |
|---|---|
| Milk Chocolate: | |
| Milk crumb | 84.40 |
| Cocoa butter | 15.00 |
| Lecithin | 0.50 |
| Carmel Flavor | 0.10 |

The ingredients are mixed in either a continuous or batch system until
thoroughly blended and then refined until a desired consistency and
particle size are reached. Refiners can include a series of rollers that
use shear forces to break up the sugar and cocoa particles. The refined
mass is then further agitated in a conch. Lastly, the milk chocolate is
tempered, molded and cooled.
The milk chocolate is introduced into the center region of the chewing
gum by feeding the milk chocolate through the innermost nozzle of a
multiple extruder. The milk chocolate is metered through the nozzle to
provide a finished product with 5% center fill material.

### Citrus Fruit Flavor in Chewing Gum Portion and Indulgent Flavor in Milk Chocolate Center

EXAMPLE 82

| | |
|---|---|
| Composition: | |
| Ingredient | Weight percent |

Citrus Fruit Chewing gum composition containing multiple
encapsulated Sucralose/polyvinyl acetate matrix
(from example 24). (Slowest release sucralose gum).

| | |
|---|---|
| Gum Base | 36.00 |
| Sorbitol | 58.10 |
| Glycerin | 1.00 |
| Orange Flavor | 1.90 |
| Sucralose | 0.15 |
| Sucralose/polyvinyl acetate matrix | 2.85 |
| (from example 24) | |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Milk Chocolate center

| | |
|---|---|
| Milk Crumb: | |
| Cocoa liquor | 13.50 |
| Sugar | 53.50 |
| Milk solids | 32.00 |

The milk solids and sugar are kneaded together with the cocoa liquor such
that controlled crystallization can occur. The crumb is then dried to the
desired final moisture content. Drying can involve vacuum drying alone or
drying can occur in combination with drum driers.

| | |
|---|---|
| Milk Chocolate: | |
| Milk crumb | 84.40 |
| Cocoa butter | 15.00 |
| Lecithin | 0.50 |
| Carmel Flavor | 0.10 |

The ingredients are mixed in either a continuous or batch system until
thoroughly blended and then refined until a desired consistency and
particle size are reached. Refiners can include a series of rollers that
use shear forces to break up the sugar and cocoa particles. The refined
mass is then further agitated in a conch. Lastly, the milk chocolate is
tempered, molded and cooled.
The milk chocolate is introduced into the center region of the chewing
gum by feeding the milk chocolate through the innermost nozzle of a
multiple extruder. The milk chocolate is metered through the nozzle to
provide a finished product with 5% center fill material.

### Fruit Flavor in Chewing Gum Portion and Fruit Flavor Potentiator in Starch Jelly Center

EXAMPLE 83

| | |
|---|---|
| Ingredient | Weight percent |

Chewing gum composition containing Encapsulated
Citric Acid - Polyvinyl acetate Matrix

| | |
|---|---|
| Gum Base | 39.00 |
| Sorbitol | 42.18 |
| Mannitol | 9.00 |
| Raspberry Flavor | 3.67 |
| Glycerin | 1.50 |
| Lecithin | 0.20 |
| Aspartame | 0.30 |
| AceK | 0.15 |
| Encapsulated Citric Acid (from Example 5) | 4.00 |
| Total | 100.00 |

Procedure: Gum is prepared in the following manner: The gum base is
melted in a mixer. The remaining ingredients are added to the molten
gum base. The melted gum base with ingredients are mixed to completely
disperse the ingredients. The thoroughly mixed gum is then introduced
into a feeder for a nozzle other than the innermost nozzle of a multiple
nozzle extruder.

Starch Jelly Center with Inosine Monophosphate (IMP)

| | |
|---|---|
| Sugar | 18.84 |
| Glucose syrup | 23.34 |
| Invert syrup | 4.50 |
| Water | 23.63 |
| Thin boiling starch | 6.04 |
| Water | 23.17 |
| Citric acid | 0.02 |
| IMP | 0.46 |
| Total | 100.00 |

The sugar is dissolved in the first quantity of water and mixed together
with the glucose syrup and invert sugar and brought to a boil. In a
separate vessel, a starch slurry is prepared by mixing the starch with
the second quantity of water (cold). The starch slurry is added to the
boiling sugar solution in a thin stream with mixing. The mixture is
cooked until it reaches 76-78% solids.
The starch jelly is introduced into the center of the chewing gum by
feeding the mass through the inner most nozzle of a multiple nozzle
extruder. Alternatively, the starch jelly mass can be cast into starch
and allowed to set up prior to introducing into the chewing gum via the
inner most nozzle of a multiple nozzle extruder. The starch jelly is
metered through the inner most nozzle to provide a finished product
with 8% center.

### First Fruit Flavor in Chewing Gum Portion and Second Complementary Fruit Flavor in Chewy Nougat Center

EXAMPLE 84

| | |
|---|---|
| Ingredient | Weight percent |

Chewing gum composition containing Encapsulated
Citric Acid - Polyvinyl acetate Matrix

| | |
|---|---|
| Gum Base | 39.00 |
| Sorbitol | 42.18 |
| Mannitol | 9.00 |
| Strawberry Flavor | 3.67 |
| Glycerin | 1.50 |
| Lecithin | 0.20 |
| Aspartame | 0.30 |
| AceK | 0.15 |
| Encapsulated Citric Acid (from Example 5) | 4.00 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Chewy Nougat with Kiwi Flavor

| | |
|---|---|
| Egg albumen | 0.37 |
| Water | 3.13 |
| Sugar | 6.59 |
| Water | 2.00 |
| Sugar | 35.73 |
| Glucose syrup | 35.73 |
| Water | 14.65 |
| Kiwi Flavor | 1.80 |
| Total | 100.00 |

The egg albumen is dissolved in the first quantity of water while the first
quantity of sugar is dissolved in the second quantity of water. The egg
albumen and sugar solution are mixed together and aerated. In a separate
vessel, the second quantity of sugar is dissolved in the third quantity of
water and the glucose syrup is added with mixing. This sugar solution is
then boiled to 141° C. The boiled sugar solution is then added to the
whipped egg albumen/sugar solution in a thin stream.
The chewy nougat is introduced into the center of the chewing gum by
feeding the mass through the inner most nozzle of a multiple nozzle
extruder. Alternatively, the chewy nougat mass can be poured onto a
cooling table and cut prior to introducing into the chewing gum via the
inner most nozzle of a multiple nozzle extruder. The chewy nougat is
metered through the inner most nozzle to provide a finished product
with 25% center.

### First Mint Flavor in Chewing Gum Portion and Second Mint Flavor of a Different Variety in Dark Chocolate Center

EXAMPLE 85
Chewing gum composition containing Encapsulated Spray Dried
Peppermint Flavor

| Ingredient | Weight percent |
|---|---|
| Gum Base | 39.00 |
| Sorbitol | 40.18 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Spray Dried Peppermint | 6.00 |
| Flavor (from Example 7) | |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Dark Chocolate center

| Ingredient | Weight percentage |
|---|---|
| Sucrose | 43.25 |
| Cocoa mass | 43.25 |
| Cocoa butter | 12.30 |
| Lecithin | 0.50 |
| Eucalyptus flavor | 0.70 |

The ingredients are mixed in either a continuous or batch system until
thoroughly blended and then refined until a desired consistency and
particle size are reached. Refiners can include a series of rollers that use
shear forces to break up the sugar and cocoa particles. The refined mass
is then further agitated in a conch. Lastly, the dark chocolate is tempered,
molded and cooled.
The dark chocolate is introduced into the center region of the chewing
gum by feeding the dark chocolate through the innermost nozzle of a
multiple extruder. The dark chocolate is metered through the nozzle to
provide a finished product with 5% center fill material.

### First Mint Flavor in Chewing Gum Portion and Second Mint Flavor of the Same Variety in Dark Chocolate Center

EXAMPLE 86

| | |
|---|---|
| Ingredient | Weight percent |

Chewing gum composition containing Encapsulated Spray Dried
Peppermint Flavor

| | |
|---|---|
| Gum Base | 39.00 |
| Sorbitol | 40.18 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Spray Dried Arvensis | 6.00 |
| Peppermint Flavor (as in Example 7 when | |
| Arvensis peppermint flavor is used) | |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Dark Chocolate center

| | |
|---|---|
| Sucrose | 43.25 |
| Cocoa mass | 43.25 |
| Cocoa butter | 12.30 |
| Lecithin | 0.50 |
| Crystal white peppermint flavor | 0.70 |

The ingredients are mixed in either a continuous or batch system until
thoroughly blended and then refined until a desired consistency and
particle size are reached. Refiners can include a series of rollers that use
shear forces to break up the sugar and cocoa particles. The refined mass
is then further agitated in a conch. Lastly, the dark chocolate is tempered,
molded and cooled.
The dark chocolate is introduced into the center region of the chewing
gum by feeding the dark chocolate through the innermost nozzle of a
multiple extruder. The dark chocolate is metered through the nozzle to
provide a finished product with 5% center fill material.

### Sweet Taste in Chewing Gum Portion and Sour Taste in Fondant Center

EXAMPLE 87

| | |
|---|---|
| Ingredient | Weight percent |

Chewing gum composition containing Encapsulated Glycyrrhizin

| | |
|---|---|
| Gum Base | 39.00 |
| Sorbitol | 45.08 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Glycyrrhizin (from Example 1) | 1.10 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Fondant Center with Sour Taste

| | |
|---|---|
| Sugar | 58.81 |
| Glucose syrup | 14.49 |
| Water | 25.00 |
| Encapsulated acid blend (from Example 33) | 1.20 |
| Citric Acid | 0.50 |
| Total | 100.00 |

The sugar and glucose syrup are added to water and dissolved. The
solution is boiled until it reaches 117° C. or about 88% solids.
The evaporated syrup is then agitated while cooling to induce rapid
crystallization. The encapsulated acid blend and the citric acid are
adding near the end of the crystallization process.
The fondant is introduced into the center region of the chewing
gum by feeding the fondant through the innermost nozzle of a multiple
extruder. The fondant is metered through the nozzle to provide a finished
product with 12% center fill material.

### Bitter Taste in Chewing Gum Portion and Astringent Taste in White Chocolate Center

EXAMPLE 88

| | |
|---|---|
| Ingredient | Weight percent |

Chewing gum composition containing 15% Naringin (Bitter Taste)
Grapefruit Flavor

| | |
|---|---|
| Gum Base | 39.00 |
| Sugar | 45.00 |
| Corn Syrup | 10.63 |
| Grapefruit Flavor with 15% naringin | 3.67 |
| Glycerin | 1.50 |
| Lecithin | 0.20 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

White Chocolate center with Quinine (Astringent Taste)

| | |
|---|---|
| Cocoa butter equivalent | 26.45 |
| Whole milk powder | 25.00 |
| Sugar | 48.00 |
| Lecithin | 0.50 |
| Quinine | 0.05 |

The ingredients are mixed in either a continuous or batch system until
thoroughly blended and then refined until a desired consistency and
particle size are reached. Refiners can include a series of rollers that
use shear forces to break up the sugar and cocoa particles. The refined
mass is then further agitated in a conch. Lastly, the dark chocolate is
tempered, molded and cooled.
The white chocolate is introduced into the center region of the chewing
gum by feeding the white chocolate through the innermost nozzle of a
multiple extruder. The white chocolate is metered through the nozzle to
provide a finished product with 5% center fill material.

### Breath Freshening in the Chewing Gum Portion and Whitening in the Gasified Candy Center

EXAMPLE 89

| | |
|---|---|
| Ingredient | Weight percent |

Chewing gum composition containing Encapsulated Zinc Citrate

| | |
|---|---|
| Gum Base | 39.00 |
| Sorbitol | 42.18 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Zinc Citrate (from Example 18) | 4.00 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Gasified Candy with Sodium Stearate

| | |
|---|---|
| Isomalt | 57.50 |
| Sorbitol solution | 37.50 |
| Sodium stearate | 5.00 |
| Flavor and color | to taste |

As described in U.S. Pat. No. 4,289,794, the isomalt and sorbitol solution
are mixed together and cooked to a temperature of about 280° F.
Additives including sodium stearate, flavor, and color are then added.
The cooked candy is gasified by introducing carbon dioxide gas at
superatmospheric temperature into a closed vessel containing the
cooked candy at 500-700 psi of pressure. The mixture is stirred for two
to six minutes to incorporate the gas. The gasified candy is then allowed
to solidify in a cooling tube. Once solid, the pressure is released
causing the candy to fracture. The fractured, gasified candy can then be
sized and fed into the inner most nozzle of a multiple nozzle extruder.
The gasified candy is introduced into the center region of the chewing
gum by feeding the gasified candy through the innermost nozzle of a
multiple extruder. The gasified candy is metered through the nozzle to
provide a finished product with 10% center fill material.

### Metabolism Modulation in Chewing Gum Portion and Stress Relief in Sugar Free Chocolate Center

EXAMPLE 90

| | |
|---|---|
| Ingredient | Weight percent |

Chewing gum composition containing Epigallocatechin Gallate (EGCG)

| | |
|---|---|
| Gum Base | 39.50 |
| Sorbitol | 45.58 |
| Mannitol | 9.00 |
| Flavor | 3.67 |
| Glycerin | 1.50 |
| Lecithin | 0.20 |
| Aspartame | 0.30 |
| AceK | 0.15 |
| EGCG | 0.10 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Sugar Free Chocolate Center with Theanine

| | |
|---|---|
| Crystalline maltitol | 41.60 |
| Cocoa mass | 41.60 |
| Cocoa butter | 12.30 |
| Theanine | 4.00 |
| Lecithin | 0.50 |
| Total | 100.00 |

The ingredients are mixed in either a continuous or batch system until
thoroughly blended and then refined until a desired consistency and
particle size are reached. Refiners can include a series of rollers that
use shear forces to break up the sugar and cocoa particles. The refined
mass is then further agitated in a conch. Lastly, the sugar free chocolate
is tempered, molded and cooled.
The sugar free chocolate is introduced into the center region of the
chewing gum by feeding the sugar free chocolate through the innermost
nozzle of a multiple extruder. The sugar free chocolate is metered
through the nozzle to provide a finished product with 5% center fill
material.

### Breath Freshening in the Chewing Gum Portion and Remineralization in a Powdered Center with an Amorphous Isomalt Shell

EXAMPLE 91

| | |
|---|---|
| Ingredient | Weight percent |

Chewing gum composition containing Chlorophyll

| | |
|---|---|
| Gum Base | 39.00 |
| Sorbitol | QS |
| Mannitol | 9.00 |
| Flavor | 3.67 |
| Glycerin | 1.50 |
| Lecithin | 0.20 |
| Aspartame | 0.30 |
| AceK | 0.15 |
| Chlorophyll | 0.50 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Powdered Center with casein phosphopeptide-amorphous
calcium phosphate (CPP-ACP)

| | |
|---|---|
| Erythritol | 70.00 |
| Xylitol | 20.00 |
| CPP-ACP | 10.00 |

The powders are dry blended using any suitable means that creates a
uniform mixture.
The powder blend is introduced into the center region of the chewing
gum by feeding the powder blend through the innermost nozzle of a
multiple extruder. The powder blend is metered through the nozzle to
provide a finished product with 5% center fill material.

Amorphous Isomalt Shell

| | |
|---|---|
| Isomalt | 90.00 |
| Water | 10.00 |

The isomalt is melted by heating to a temperature of 60-90° C. and
held until 3% or less moisture remains. The cooked isomalt is then fed
into the outermost nozzle of multiple extruder. The cooked isomalt is
metered through the nozzle to provide a finished product with 60% shell.

### Tingling Center Comprising Two Solids with Complementary Flavors in Gum Portion and Exterior Coating

EXAMPLE 92
Kiwi Chewing gum composition containing multiple encapsulated
Sucralose/polyvinyl acetate matrix (from example 24).
(Slowest release sucralose gum).

| Composition: | |
|---|---|
| Ingredient | Weight percent |
| Gum Base | 36.00 |
| Sorbitol | 58.10 |
| Glycerin | 1.00 |
| Kiwi Flavor | 1.90 |
| Sucralose | 0.15 |
| Sucralose/polyvinyl acetate matrix (from example 24) | 2.85 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients. The thoroughly mixed gum is then introduced
into a feeder for a nozzle other than the innermost nozzle of a multiple
nozzle extruder.

Milk Chocolate with Gasified Hard Candy center

| Ingredient | Weight percentage |
|---|---|
| Milk Crumb: | |
| Cocoa liquor | 13.50 |
| Sugar | 53.50 |
| Milk solids | 32.00 |

The milk solids and sugar are kneaded together with the cocoa liquor
such that controlled crystallization can occur. The crumb is then dried to
the desired final moisture content. Drying can involve vacuum drying
alone or drying can occur in combination with drum driers.

| | |
|---|---|
| Milk chocolate: | |
| Milk crumb | 84.40 |
| Cocoa butter | 15.00 |
| Lecithin | 0.50 |
| Carmel Flavor | 0.10 |

The ingredients are mixed in either a continuous or batch system until
thoroughly blended and then refined until a desired consistency and
particle size are reached. Refiners can include a series of rollers that use
shear forces to break up the sugar and cocoa particles. The refined mass
is then further agitated in a conch. Lastly, the milk chocolate is tempered,
molded and cooled.

Gasified Candy with Tingling (Jambu Extract)

| Ingredient | Weight Percent |
|---|---|
| Isomalt | 59.99 |
| Sorbitol Solution | 40.00 |
| Jambu extract | 0.01 |

As described in U.S. Pat. No. 4,289,794, the isomalt and sorbitol solution
are mixed together and cooked to a temperature of about 280° F.
Additives including the jambu extract are then added. The cooked candy
is gasified by introducing carbon dioxide gas at superatmospheric
temperature into a closed vessel containing the cooked candy at 500-700
psi of pressure. The mixture is stirred for two to six minutes to incorporate
the gas. The gasified candy is then allowed to solidify in a cooling tube.
Once solid, the pressure is released causing the candy to fracture. The
fractured, gasified candy can then be sized and fed into the inner most
nozzle of a multiple nozzle extruder along with the milk chocolate.
Alternatively, the fractured and sized gasified candy be fed into a nozzle
adjacent to the inner most nozzle as the chocolate is fed into the inner
most nozzle. This can minimize disruption to the gasified candy.
The inner most nozzle and the nozzle adjacent to the inner most nozzle can
be configured to created a center fill comprising two solids where the
center makes up 5% of the product.

Complementary Flavored Outer Coating
Coating Composition with Complementary Strawberry Flavor

| Component | Weight Percent |
|---|---|
| Maltitol | 95.10 |
| Bleached gum Arabic | 3.32 |
| Titanium dioxide | 0.36 |
| Strawberry flavor | 1.07 |
| Intense sweetener | 0.08 |
| Color | 0 |
| Candelilla wax | 0.08 |

Once the center comprising milk chocolate and gasified hard candy and
the gum region are formed into individual pieces by the multi nozzle
extruder and sizing with cutting apparatus, the pieces can be loaded into
any conventional, batch or continuous coating apparatus. The coating can
then be applied in multiple layers until the coating forms 30% of the
finished product weight.

### Examples 93-96

As mentioned above, Examples 93-96 provide multi-modality gum compositions, which are center-fill gums having liquid center regions. Different types of dualities are exemplified in these liquid-fill gum compositions. In some examples, more than one duality is present in the composition.

Additionally, several of the multi-modality gum compositions provided in Examples 93-96 incorporate encapsulated components from Examples 1-78 as one of the dual components in the compositions. In particular, Example 93. includes encapsulated WS-23 from Example 13. Example 96 includes encapsulated malic acid from Example 6.

### Examples of Multi-Modality Gums with Liquid Center-Fills

### Cooling and Mint in Chewing Gum and Coating Portions and Tingling and Spice in a Liquid Center

EXAMPLE 93
Gum Region Composition

| Component | Weight % |
|---|---|
| Gum base* | 28-42 |
| Lecithin | 0.1-0.25 |
| Maltitol | 52-55 |
| Sorbitol | 0 |
| Lycasin ™ | 0 |
| Mint flavor | 2.50-3 |
| Encapsulated WS-23 (from Example 13) | 0.08-0.1 |
| Acidulants | 1.2-1.7 |
| Intense sweetener | 3.4-3.9 |

*gum base may include 3% to 11% by weight of a filler such as, for example, talc, dicalcium phosphate, and calcium carbonate (the amount of filler in the gum base is based on the weight percent of the gum region composition, for example, if a gum region composition includes 5% filler, the amount of gum base will be 5% less than the range recited in the table, i.e., from 23-37%)

EXAMPLE 93
Liquid-Fill Composition

| Component | Weight % |
|---|---|
| Glycerin | 63.00 |
| Lycasin ™ | 29.26 |
| Sorbitol solution | 3.25 |
| Sodium carboxymethyl cellulose | 0.08 |
| Color | 0.004 |
| Cinnamon flavor | 1.30 |
| Jambu oleoresin | 0.06 |
| Citric acid | 3.00 |
| Intense sweetener | 0.05 |

EXAMPLE 93
Coating Composition

| Component | Weight % |
|---|---|
| Maltitol | 95.02 |
| Bleached gum Arabic | 3.32 |
| Titanium dioxide | 0.36 |
| Mint flavor | 1.07 |
| Unencapsulated WS-23 | 0.08 |
| Intense sweetener | 0.08 |
| Color | 0 |
| Candelilla wax | 0.08 |

A center-fill gum including three regions: liquid fill, gum region and coating is prepared according to the compositions in the Example 93 tables above. The gum region and coating compositions both include WS-23, a cooling agent, whereas the liquid-fill composition includes jambu oleoresin, a tingling agent. A duality based on two distinct sensations therefore is present in the center-fill gum. In addition, the gum region and coating compositions both include mint flavor, whereas the liquid-fill composition includes cinnamon flavor. A second duality based on the mint-spice flavor distinction also is present in the center-fill gum. Moreover, the WS-23 is present in both its encapsulated and unencapsulated forms.

The composition for the gum region is prepared by first combining talc, where present, with the gum base under heat at about 85° C. This combination is then mixed with the maltitol, lecithin and other polyols for six minutes. The flavor blends which include a pre-mix of the flavors and WS-23 are added and mixed for 1 minute. Finally, the acids and intense sweeteners are added and mixed for 5 minutes.

The liquid fill composition is then prepared by first preparing a pre-mix of the sodium carboxymethyl cellulose, glycerine, and polyols. This pre-mix is then combined with the colors, flavors, jambu oleoresin, acids and intense sweeteners and mixed.

The gum region and liquid-fill compositions are then extruded together and formed into tablets by the process described above at paragraphs [0104] to [0108]. The gum pieces each have a total weight of approximately 2.2 g. In the final gum pieces, the gum region is about 62% by weight, the liquid-fill is about 8% by weight, and the coating is about 30% by weight.

Gum pieces that are prepared by Example 93 demonstrate no noticeable loss of liquidity of the liquid-fill after accelerated aging at 37° C. for a three week period.

### Indulgent Flavor in the Chewing Gum and Fruit Flavor in a Liquid Center

EXAMPLE 94
Gum Region Composition

| Component | Weight % |
|---|---|
| Gum base* | 28-42 |
| Lecithin | 0.05-0.1 |
| Maltitol | 46-50 |
| Sorbitol | 5-10 |
| Lycasin ™ | 0.25-0.5 |
| Caramel flavor | 2-2.26 |
| Intense sweetener | 3.4-3.9 |

*gum base may include 3% to 11% by weight of a filler such as, for example, talc, dicalcium phosphate, and calcium carbonate (the amount of filler in the gum base is based on the weight percent of the gum region composition, for example, if a gum region composition includes 5% filler, the amount of gum base will be 5% less than the range recited in the table, i.e., from 23-37%)

EXAMPLE 94
Liquid-Fill Composition

| Component | Weight % |
|---|---|
| Glycerin | 63.00 |
| Lycasin ™ | 29.49 |
| Sorbitol solution | 3.28 |
| Sodium carboxymethyl cellulose | 0.15 |
| Color | 0.0004 |
| Apple flavor | 4.00 |
| Intense sweetener | 0.02 |

EXAMPLE 94
Coating Composition

| Component | Weight % |
|---|---|
| Maltitol | 95.36 |
| Bleached gum Arabic | 3.32 |
| Titanium dioxide | 0.36 |
| Caramel flavor | 0.51 |
| Warming agent | 0.15 |
| Intense sweetener | 0.23 |
| Candelilla wax | 0.08 |

A center-fill gum including three regions: liquid fill, gum region and coating is prepared according to the compositions in the Example 94 tables above. The gum region and coating compositions both include caramel flavor, which is an indulgent flavor. The liquid-fill composition includes apple, which is a fruit flavor. A duality based on two distinct flavors in different regions therefore is present in the center-fill gum.

The center-fill gum is prepared by the same method set forth for Example 93 above.

### Warming in the Chewing Gum and Complementary Warming in a Liquid Center

EXAMPLE 95
Gum Region Composition

| Component | Weight % |
|---|---|
| Gum base* | 28-42 |
| Lecithin | 0.05-0.1 |
| Maltitol | 45-55 |
| Sorbitol | 5-10 |
| Lycasin ™ | 0.1-0.25 |
| Cinnamon oil | 2-2.50 |
| Vanilla alcohol n-butyl ether | 0.08-0.1 |
| Intense sweetener | 2.9-3.4 |

*gum base may include 3% to 11% by weight of a filler such as, for example, talc, dicalcium phosphate, and calcium carbonate (the amount of filler in the gum base is based on the weight percent of the gum region composition, for example, if a gum region composition includes 5% filler, the amount of gum base will be 5% less than the range recited in the table, i.e., from 23-37%)

EXAMPLE 95
Liquid-Fill Composition

| Component | Weight % |
|---|---|
| Glycerin | 63.00 |
| Lycasin ™ | 29.17 |
| Sorbitol solution | 3.24 |
| Sodium carboxymethyl cellulose | 0.20 |
| Color | 0.004 |
| Cinnamon oil | 0.30 |
| Cinnamic aldehyde | 0.06 |
| Intense sweetener | 0.02 |

EXAMPLE 95
Coating Composition

| Component | Weight % |
|---|---|
| Maltitol | 95.02 |
| Bleached gum Arabic | 3.32 |
| Titanium dioxide | 0.36 |
| Cinnamon oil | 1.07 |
| Intense sweetener | 0.08 |
| Color | 0 |
| Candelilla wax | 0.08 |

A center-fill gum including three regions: liquid fill, gum region and coating is prepared according to the compositions in the Example 95 tables above. The gum region composition includes vanilla alcohol n-butyl ether, which is a warming agent. The liquid-fill composition includes cinnamic aldehyde, which is another warming agent. A duality based on two complementary warming sensations therefore is present in the center-fill gum.

The center-fill gum is prepared by the same method set forth for Example 93 above.

### Sour Taste in Chewing Gum and Coating Portions and Sweet Taste in a Liquid Center

EXAMPLE 96
Gum Region Composition

| Component | Weight % |
|---|---|
| Gum base* | 28-42 |
| Lecithin | 0.05-0.1 |
| Maltitol | 50-55 |
| Sorbitol | 0-5 |
| Lycasin ™ | 0.1-0.25 |
| Flavors | 2-2.50 |
| Encapsualted malic acid (from Example 6) | 0.7-1.2 |
| Intense sweetener | 3.4-3.9 |

*gum base may include 3% to 11% by weight of a filler such as, for example, talc, dicalcium phosphate, and calcium carbonate (the amount of filler in the gum base is based on the weight percent of the gum region composition, for example, if a gum region composition includes 5% filler, the amount of gum base will be 5% less than the range recited in the table, i.e., from 23-37%)

EXAMPLE 96
Liquid-Fill Composition

| Component | Weight % |
|---|---|
| Glycerin | 63.00 |
| Lycasin ™ | 29.49 |
| Sorbitol solution | 3.28 |
| Sodium carboxymethyl cellulose | 0.15 |
| Color | 0.0004 |
| Flavors | 4.00 |
| Sucralose | 0.02 |

EXAMPLE 96
Coating Composition

| Component | Weight % |
|---|---|
| Maltitol | 95.02 |
| Bleached gum Arabic | 3.32 |
| Titanium dioxide | 0.36 |
| Flavors | 1.07 |
| Unencapsulated malic acid | 0.08 |
| Intense sweetener | 0.08 |
| Candelilla wax | 0.08 |

A center-fill gum including three regions: liquid fill, gum region and coating is prepared according to the compositions in the Example 96 tables above. The gum region and coating compositions both include malic acid, which has a sour taste, whereas the liquid-fill composition includes sucralose and a sorbitol solution, which both have a sweet taste. A duality based on two distinct tastes therefore is present in the center-fill gum. In addition, the malic acid is used in a greater amount in the gum region than in the coating composition, thereby providing a second duality based on different intensities of the sour taste.

The center-fill gum is prepared by the same method set forth for Example 93 above.

### Sweet and Sour Tastes in Gum Portion and in Chewy Candy Center

EXAMPLE 97

| | |
|---|---|
| Ingredient | Weight percent |

Chewing gum composition containing sweeteners and acids

| | |
|---|---|
| Gum Base | 28.875 |
| Lecithin | 0.20 |
| Polyols | 57.7498 |
| Plasticizer | 1.50 |
| Flavor | 5.7 |
| Intense sweeteners | 1.9302 |
| Food-grade acids | 2.045 |
| Encapsulated food-grade acid | 2.00 |
| Total | 100.00 |

Procedure: Gum is prepared in the following manner: The gum base is
melted in a mixer. The remaining ingredients are added to the molten gum
base. The melted gum base with ingredients are mixed to completely
disperse the ingredients.

Chewy candy center-fill composition with sweeteners and acids

| | |
|---|---|
| Polydextrose | 28.07 |
| Maltitol | 33.05 |
| Water | 8.13 |
| Dextrin | 7.43 |
| Lecithin | 0.74 |
| Fat | 5.57 |
| Gelatin solution | 3.34 |
| Food-grade acids | 13.00 |
| Flavor | 0.63 |
| Intense sweetener | 0.04 |
| Total | 100.00 |

Procedure: The polydextrose, maltitol and water are boiled to 120° C. until
dissolved. The lecithin and fat are added to the mixture under high-speed
mixing. The mixture is cooked to 94.5% solids and then cooled down to
80-90° C. The gelatin solution is then slowly mixed in and the mixture is
then cooled to 50° C. The flavor, color, and acids then are added.
A center-fill slab is prepared by first rolling the gum composition to
1.4 mm and rolling the candy composition to 0.7 mm. A layer of gum
is laid down. A layer of candy is added to the gum layer and then another
layer of gum is placed on top of the candy layer. The mass is microwaved
for 10 seconds and then fed through rollers multiple times and scored
into center-fill pieces in the form of a slab.
A center-fill pillow is prepared by first rolling a portion of the gum
composition to 1.35 mm and punching it on a gum press to form the
bottom cavity of the center-fill gum. 0.4 g of the chewy candy
composition is added to the bottom cavity. Another portion of the gum
composition is rolled to 0.6 mm to form the top of the gum piece. The
gum is punched on the gum press to form the entire center-fill gum piece.
The total weight of the center-fill gum piece is 2.4 g.
A center-fill pellet is prepared by first rolling the gum composition to
1.4 mm and rolling the candy composition to 0.7 mm. A layer of gum is
laid down. A layer of candy is added to the gum layer and then another
layer of gum is placed on top of the candy layer. The mass is put through
a scoring device for pellets to form individual center-fill pellet gum pieces.

1. A packaged gum product, comprising:
a plurality of individual pieces of gum, wherein each piece of gum includes:
a center-fill region;
a gum region surrounding said center-fill region, said gum region comprising a gum base;
optionally a third region surrounding at least a portion of said gum region, wherein one of said regions comprises at least one first sensate and at least a second of said regions comprises at least one second sensate which is distinct from said at least one first sensate; and
a package assembly that contains said plurality of individual pieces of gum, said package assembly having indicia placed on an outer surface, said indicia being indicative of said first sensate and said second sensate.

2. The packaged gum product of claim 1, wherein said center-fill region comprises said first sensate and said gum region comprises said second sensate.

3. The packaged gum product of claim 1, wherein said center-fill region comprises said first sensate and said third region comprises said second sensate.

4. The packaged gum product of claim 1, wherein said gum region comprises said first sensate and said third region comprises said second sensate.

5. The packaged gum product of claim 1, wherein said center-fill region comprises said first sensate, said gum region comprises said second sensate and said third region comprises a third sensate.

6. The packaged gum product of claim 1, wherein at least one of said sensates is encapsulated.

7-9. (canceled)

10. The packaged gum product of claim 1, wherein said first sensate comprises a cooling agent and said second sensate comprises a warming agent.

11. The packaged gum product of claim 1, wherein said first sensate comprises a cooling agent and said second sensate comprises a tingling agent.

12. The packaged gum product of claim 1, wherein said first sensate comprises a warming agent and said second sensate comprises a tingling agent.

13. The packaged gum product of claim 1, wherein said center-fill region is selected from the group consisting of: liquid; gel; powder; solid; gas; and combinations thereof.

14. The packaged gum product of claim 1, wherein said third region comprises a coating.

15-28. (canceled)

29. A method of marketing a gum product to a consumer, comprising:
providing a plurality of individual pieces of gum, wherein each piece of gum includes:
a center-fill region;
a gum region surrounding the center-fill region, the gum region comprising a gum base;
optionally a third region surrounding at least a portion of the gum region,
wherein one of the regions comprises at least one first sensate and at least a second of the regions comprises at least one second sensate which is distinct from the at least one first sensate; and
providing a package assembly that contains said plurality of individual pieces of gum, said package assembly having indicia placed on an outer surface thereof to inform a consumer of said first sensate and said second sensate.

30. The method of claim 29, further comprising providing a web page, said web page including at least a portion of said indicia.

31. The method of claim 29, further comprising providing an advertisement including at least a portion of said indicia.

32. The method of claim 29, further comprising providing a display device configured to hold said package and including at least a portion of said indicia.

33. The method of claim 29, further comprising providing an audio message representative of said first sensate and said second sensate.

34. The method of claim 29, further comprising providing a visual image including at least a portion of said indicia.

35. The method of claim 29, further comprising preparing a commercial indicative of said gum product.

36-40. (canceled)

41. A packaged gum product, comprising:
a plurality of individual pieces of gum, wherein each piece of gum includes:
a center-fill region;
a gum region surrounding said center-fill region, said gum region comprising a gum base;
optionally a third region surrounding at least a portion of said gum region, wherein one of said regions comprises at least one first sensate and at least a second of said regions comprises at least one second sensate which is distinct from said at least one first sensate; and
a package assembly comprising a plurality of wrappers for each of the plurality of individual pieces of gum, at least one of the plurality of wrappers having indicia being indicative of said first sensate and said second sensate.

42-43. (canceled)

44. The packaged gum product of claim 1, wherein said package assembly comprises an overwrap portion that contains said plurality of individual pieces of gum, said overwrap portion comprising said indicia being indicative of said first sensate and said second sensate.
